(19) United States
(12) Patent Application Publication
(10) Pub. No.: US 2004/0220791 A1
(43) Pub. Date: Nov. 4, 2004

(54) Personalization services for entities from multiple sources

(75) Inventors: Allan B. Lamkin, San Diego, CA (US); Gregory I. Gewickey, Fountain Hills, AZ (US); Todd R. Collart, Los Altos, CA (US)

Correspondence Address: FITCH EVEN TABIN AND FLANNERY, 120 SOUTH LA SALLE STREET, SUITE 1600, CHICAGO, IL, 60603-3406, US

(73) Assignee: InterActual Technologies, Inc. a California Corpor, San Jose, CA

(21) Appl. No.: 10/860,350

(22) Filed: Jun. 2, 2004

Related U.S. Application Data
(63) Continuation-in-part of application No. 10/190,307, filed on Jul. 2, 2002.
(63) Continuation-in-part of application No. 10/010,078, filed on Nov. 2, 2001.
(63) Continuation-in-part of application No. 09/488,345, filed on Jan. 20, 2000.
(63) Continuation-in-part of application No. 09/488,337, filed on Jan. 20, 2000.
(63) Continuation-in-part of application No. 09/488,613, filed on Jan. 20, 2000, now Pat. No. 6,769,130.
(63) Continuation-in-part of application No. 09/488,155, filed on Jan. 20, 2000.
(63) Continuation-in-part of application No. 09/489,600, filed on Jan. 20, 2000.
(63) Continuation-in-part of application No. 09/935,756, filed on Aug. 21, 2001.
(63) Continuation-in-part of application No. 09/488,614, filed on Jan. 20, 2000.
(63) Continuation-in-part of application No. 09/489,601, filed on Jan. 20, 2000.
(63) Continuation-in-part of application No. 09/489,597, filed on Jan. 20, 2000.
(63) Continuation-in-part of application No. 09/489,596, filed on Jan. 20, 2000.
(63) Continuation-in-part of application No. 09/898,479, filed on Jul. 2, 2001.
(63) Continuation-in-part of application No. 09/649,215, filed on Aug. 28, 2000.
(63) Continuation-in-part of application No. 09/476,190, filed on Jan. 3, 2000.
(60) Provisional application No. 60/531,565, filed on Dec. 19, 2003.
(60) Provisional application No. 60/302,778, filed on Jul. 2, 2001.
(60) Provisional application No. 60/246,652, filed on Nov. 7, 2000.
(60) Provisional application No. 60/216,822, filed on Jul. 7, 2000.

(51) Int. Cl. G06G 7/48

(52) U.S. Cl. 703/11

(57) ABSTRACT

A system comprising a plurality of devices connected via a network; a plurality of entities located on at least one of the plurality of devices; and a content management system located on at least one of the plurality of devices for creating a collection using at least two of the plurality of entities. A method of modifying a collection comprising analyzing metadata associated with the collection; and removing at least one entity from the collection based upon a set of presentation rules.

This application claims the benefit of U.S. Provisional Application No. 60/531,565, filed Dec. 19, 2003, entitled PERSONALIZATION SERVICES FOR ENTITIES FROM MULTIPLE SOURCES, Attorney Docket No. 81682/7236, the entirety of which is incorporated herein by reference.

This application is related to U.S. application Ser. No. ______, filed concurrently herewith, entitled PERSONALIZATION SERVICES FOR ENTITIES FROM MULTIPLE SOURCES, Attorney Docket No. ______/7236, the entirety of which is incorporated herein by reference.

This application is a Continuation in Part of U.S. patent application Ser. No. 09/935,756, filed Aug. 21, 2001, entitled PRESENTATION OF MEDIA CONTENT FROM MULTIPLE MEDIA SOURCES, which claims the benefit of U.S. Provisional Application Ser. No. 60/226,758, filed Aug. 21, 2000, entitled SYSTEM, METHOD AND ARTICLE OF MANUFACTURE FOR A COMMON CROSS PLATFORM FRAMEWORK FOR DEVELOPMENT OF DVD-VIDEO CONTENT INTEGRATED WITH ROM CONTENT.

This application is a Continuation in Part of U.S. patent application Ser. No. 09/898,479, filed Jul. 2, 2001, entitled SYSTEM, METHOD AND ARTICLE OF MANUFACTURE FOR A COMMON CROSS PLATFORM FRAMEWORK FOR DEVELOPMENT OF DVD-VIDEO CONTENT INTEGRATED WITH ROM CONTENT, which claims the benefit of U.S. Provisional Application Ser. No. 60/216,822, filed Jul. 7, 2000, entitled SYSTEM, METHOD AND ARTICLE OF MANUFACTURE FOR A COMMON CROSS PLATFORM FRAMEWORK FOR DEVELOPMENT OF DVD-VIDEO CONTENT INTEGRATED WITH ROM CONTENT.

This application is a Continuation in Part of U.S. patent application Ser. No. 09/649,215, filed Aug. 28, 2000, entitled SOFTWARE ENGINE FOR COMBINING VIDEO OR AUDIO CONTENT WITH PROGRAMMATIC CONTENT, which is a Continuation in Part of U.S. patent application Ser. No. 09/644,669, filed Aug. 24, 2000, entitled SOFTWARE ENGINE FOR COMBINING VIDEO OR AUDIO CONTENT WITH PROGRAMMATIC CONTENT.

This application is a Continuation in Part of U.S. patent application Ser. No. 09/476,190, filed Jan. 3, 2000, entitled SYSTEM, METHOD AND ARTICLE OF MANUFACTURE FOR UPDATING CONTENT STORED ON A PORTABLE STORAGE MEDIUM.

This application is a Continuation in Part of U.S. patent application Ser. No. 10/346,726, filed Jan. 16, 2003, entitled SYSTEM, METHOD AND ARTICLE OF MANUFACTURE FOR REMOTE CONTROL AND NAVIGATION OF LOCAL CONTENT, which is a Continuation of U.S. patent application Ser. No. 09/499,247, filed Feb. 7, 2000, entitled SYSTEM, METHOD AND ARTICLE OF MANUFACTURE FOR REMOTE UNLOCKING OF LOCAL CONTENT LOCATED ON A CLIENT DEVICE, now issued U.S. Pat. No. 6,529,949.

This application is a Continuation in Part of U.S. patent application Ser. No. 10/190,307, filed Jul. 2, 2002, entitled METHOD AND APPARATUS FOR PROVIDING CONTENT-OWNER CONTROL IN A NETWORKED DEVICE, which claims the benefit of U.S. Provisional Application Ser. No. 60/302,778, filed Jul. 2, 2001, entitled A SYSTEM FOR PROVIDING CONTENT-OWNER CONTROL OF PLAYBACK IN A NETWORKED DEVICE.

This application is a Continuation in Part of U.S. patent application Ser. No. 10/010,078, filed Nov. 2, 2001, entitled SYSTEM, METHOD AND ARTICLE OF MANUFACTURE FOR REMOTE CONTROL AND NAVIGATION OF LOCAL CONTENT, which claims the benefit of U.S. Provisional Application Ser. No. 60/246,652, filed Nov. 7, 2000, entitled SYSTEM, METHOD AND ARTICLE OF MANUFACTURE FOR TRACKING USAGE OF A LASER-CENTRIC MEDIUM.

This application is a Continuation in Part of U.S. patent application Ser. No. 09/488,345, filed Jan. 20, 2000, entitled SYSTEM, METHOD AND ARTICLE OF MANUFACTURE FOR EXECUTING A MULTIMEDIA EVENT ON A PLURALITY OF CLIENT COMPUTERS USING A SYNCHRONIZATION HOST ENGINE.

This application is a Continuation in Part of U.S. patent application Ser. No. 09/488,337, filed Jan. 20, 2000, entitled SYSTEM, METHOD AND ARTICLE OF MANUFACTURE FOR STORING SYNCHRONIZATION HISTORY OF THE EXECUTION OF A MULTIMEDIA EVENT ON A PLURALITY OF CLIENT COMPUTERS.

This application is a Continuation in Part of U.S. patent application Ser. No. 09/488,613, filed Jan. 20, 2000, entitled SYSTEM, METHOD AND ARTICLE OF MANUFACTURE FOR LATE SYNCHRONIZATION DURING THE EXECUTION OF A MULTIMEDIA EVENT ON A PLURALITY OF CLIENT COMPUTERS.

This application is a Continuation in Part of U.S. patent application Ser. No. 09/488,155, filed Jan. 20, 2000, entitled SYSTEM, METHOD AND ARTICLE OF MANUFACTURE FOR JAVA/JAVASCRIPT COMPONENT IN A MULTIMEDIA SYNCHRONIZATION FRAMEWORK.

This application is a Continuation in Part of U.S. patent application Ser. No. 09/489,600, filed Jan. 20, 2000, entitled SYSTEM, METHOD AND ARTICLE OF MANUFACTURE FOR A SYNCHRONIZER COMPONENT IN A MULTIMEDIA SYNCHRONIZATION FRAMEWORK.

This application is a Continuation in Part of U.S. patent application Ser. No. 09/488,614, filed Jan. 20, 2000, entitled SYSTEM, METHOD AND ARTICLE OF MANUFACTURE FOR A SCHEDULER COMPONENT IN A MULTIMEDIA SYNCHRONIZATION FRAMEWORK.

This application is a Continuation in Part of U.S. patent application Ser. No. 09/489,601, filed Jan. 20, 2000, entitled SYSTEM, METHOD AND ARTICLE OF MANUFACTURE FOR A BUSINESS LAYER COMPONENT IN A MULTIMEDIA SYNCHRONIZATION FRAMEWORK.

This application is a-Continuation in Part of U.S. patent application Ser. No. 09/489,597, filed Jan. 20, 2000, entitled SYSTEM, METHOD AND ARTICLE OF MANUFACTURE FOR A CONFIGURATION MANAGER COMPONENT IN A MULTIMEDIA SYNCHRONIZATION FRAMEWORK.

This application is a Continuation in Part of U.S. patent application Ser. No. 09/489,596, filed Jan. 20, 2000, entitled SYSTEM, METHOD AND ARTICLE OF MANUFACTURE FOR EMBEDDED KEYWORDS IN VIDEO.

Provisional application serial No. 60/531,565, filed Dec. 19, 2003, entitled PERSONALIZATION SERVICES FOR ENTITIES FROM MULTIPLE SOURCES, Attorney Docket No. 81682/7236; Provisional Application serial No. 60/226,758, filed Aug. 21, 2000; Provisional application serial No. 60/246,652, filed Nov. 7, 2000; Provisional application serial No. 60/251,965, filed Dec. 5, 2000; Provisional application Serial No. 60/259,075, filed Dec. 29, 2000; Provisional application serial No. 60/302,778, filed Jul. 2, 2001; Provisional application serial No. 60/220,397, filed Jul. 24, 2000; U.S. application Ser. No. 09/644,669, filed Aug. 24, 2000; U.S. application Ser. No. 09/649,215, filed Aug. 28, 2000; U.S. application Ser. No. 09/644,669, filed Aug. 24, 2000; U.S. application Ser. No. 09/295,856, filed Apr. 21, 1999; U.S. application Ser. No. 09/296,202, filed Apr. 21, 1999; U.S. application Ser. No. 09/296,098, filed Apr. 21, 1999; U.S. application Ser. No. 09/09/295,688, filed Apr. 21, 1999; U.S. application Ser. No. 09/295,964, filed Apr. 21, 1999; U.S. application Ser. No. 09/295,689, filed Apr. 21, 1999; U.S. application Ser. No. 09/295,826, filed Apr. 21, 1999; U.S. application Ser. No. 09/476,190, filed Jan. 3, 2000; U.S. application Ser. No. 09/488,345, filed Jan. 20, 2000; U.S. application Ser. No. 09/488,337, filed Jan. 20, 2000; U.S. application Ser. No. 09/488,143, filed Jan. 20, 2000; U.S. application Ser. No. 09/488,613, filed Jan. 20, 2000; U.S. application Ser. No. 09/488,155, filed Jan. 20, 2000; U.S. application Ser. No. 09/489,600, filed Jan. 20, 2000; U.S. application Ser. No. 09/488,614, filed Jan. 20, 2000; U.S. application Ser. No. 09/489,601, filed Jan. 20, 2000; U.S. application Ser. No. 09/489,597, filed Jan. 20, 2000; U.S. application Ser. No. 09/489,596, filed Jan. 20, 2000; U.S. application Ser. No. 09/499,247, filed Feb. 7, 2000; U.S. application Ser. No. 09/898,479, filed Jul. 2, 2001; Provisional patent application serial No. 60/216,822, filed Jul. 7, 2000; U.S. application Ser. No. 09/912,079, filed Jul. 24, 2001; Provisional patent application serial No. 60/220,400, filed Jul. 24, 2000; U.S. application Ser. No. 10/190,307, filed Jul., 2, 2002, entitled A SYSTEM FOR PROVIDING CONTENT-OWNER CONTROL OF PLAYBACK IN A NETWORKED DEVICE; and U.S. application Ser. No. 09/935,756, filed Aug. 21, 2001, entitled PRESENTATION OF MEDIA CONTENT FROM MULTIPLE MEDIA SOURCES, are all incorporated herein by reference in their entirety. All of the previously mentioned documents are incorporated herein by reference in their entirety.

### FIELD OF THE INVENTION

The present invention relates to the presentation of multimedia entities, and more particularly to the presentation of locally stored media entities and/or with remotely obtained network media entities, that is modified according to a viewer's preferences or entities owner's criteria. In addition it relates to the process of acquiring new multimedia entities for playback.

### BACKGROUND OF THE INVENTION

In marketing, many things have been long recognized as aiding success, such as increasing customer satisfaction through such devices as providing personalized service, fast service, access to related or updated information, etc. Traditional marketing has made use of such things as notice of promotional offers for related products such as providing coupons, for related products etc. Additionally, some studies have shown that simple repeated brand exposure, such as by advertisement, increases recognition and sales.

One of the largest marketing industries today is the entertainment industry and related industries. Digital versatile disks (DVDs) are poised to dominate as the delivery media of choice for the consumer sales market of the home entertainment industry, business computer industry, home computer industry, and the business information industry with a single digital format, eventually replacing audio CDs, videotapes, laserdiscs, CD-ROMs, and video game cartridges. To this end, DVD has widespread support from all major electronics companies, all major computer hardware companies, and all major movie and music studios. In addition, new computer readable medium formats and disc formats such as High Definition DVD (HD-DVD), Advanced Optical Discs (AOD), and Blu-Ray Disc (BD), as well as new mediums such as Personal Video Recorders (PVR) and Digital Video Recorders (DVR) are just some of the future mediums under development. The integration of computers, the release of new operating systems including the Microsoft Media Center Edition of Windows XP, the upcoming release of the next Microsoft operating system due in 2005 and codenamed “Longhorn” and many other computer platforms that interface with entertainment systems are also entering into this market as well.

Currently, the fastest growing marketing and informational access avenue is the Internet. The share of households with Internet access in the U.S. soared by 58% in two years, rising from 26.2% in December 1998 to 41.5% in August 2000 (Source: Falling Through the Net: Toward Digital Inclusion by the National Telecommunications and Information Administration, October 2000).

However, in the DVD-video arena, little has been done to utilize the vast power for up-to-date, new, and promotional information accessibility to further the aims of improving marketability and customer satisfaction

Additionally, content is generally developed for use on a particular type of system. If a person wishes to view the content but does not have the correct system, the content may be displayed poorly or may not be able to be displayed at all. Accordingly, improvements are needed in a way that content is stored, located, distributed, presented and categorized.

### SUMMARY OF THE INVENTION

One present embodiment advantageously addresses the needs mentioned previously as well as other needs by providing services that facilitates the access and use of related or updated content to provide augmented or improved content with playback of content. Another embodiment additionally provides for the access and use of entities for the creation, modification and playback of collections.

One embodiment can include a method comprising receiving a request for content; searching for a plurality of entities in response to the received request, the plurality of entities each having entity metadata associated therewith; and creating a collection, the collection comprising the plurality of entities and collection metadata. Alternatively, the method can further include locating the plurality of entities; analyzing the entity metadata associated with each of the plurality of entities; and downloading only the entities that meet a set of criteria.

An alternative embodiment can include a data structure embodied on a computer readable medium comprising a plurality of entities; entity metadata associated with each of the plurality of entities; and a collection containing each of the plurality of entities, the collection comprising collection metadata for playback of the plurality of entities.

Yet another embodiment can include a method comprising receiving a request for content; creating a collection comprising a plurality of entities meant for display with a first system and at least one entity meant for display on a second system; and outputting the collection comprising the plurality of entities meant for display on the first system and the at least one entity meant for display on the second system to the first system.

Another alternative embodiment can include a method comprising receiving a request for content; searching for a plurality of entities in response to the received request, the plurality of entities each having entity metadata associated therewith; and creating a collection comprising the plurality of entities, the collection having collection metadata.

Still another embodiment can include a method for searching for content comprising the steps of receiving at least one search parameter; translating the search parameter into a media identifier; and locating the content associated with the media identifier. Optionally, the content is a collection comprising a plurality of entities, the method further comprising determining one of the plurality of entities can not be viewed; and locating an entity for replacing the one of the plurality of entities that can not be viewed.

One optional embodiment includes a system for locating content comprising a playback runtime engine for constructing a request from a set of search parameters; a collection name service for translating the request into a collection identifier; and a content search engine for searching for content associated with the collection identifier.

Another embodiment can be characterized as a method comprising receiving a request for content; searching for a plurality of entities in response to the received request, the plurality of entities each having entity metadata associated therewith; creating a first group of entities that meet the received request, each entity within the first group of entities having entity metadata associated therewith; comparing the first group of entities that meet the received request or the associated entity metadata to a user profile; and creating a collection comprising at least one entity from the first group of entities.

Yet another embodiment can be characterized as a system comprising a plurality of devices connected via a network; a plurality of shared entities located on at least one of-the plurality of devices; and a content management system located on at least one of the plurality of devices for creating a collection using at least two of the plurality of shared entities.

Still another embodiment can be characterized as a method of modifying a collection comprising analyzing metadata associated with the collection; and adding at least one new entity to the collection based upon a set of presentation rules.

Another preferred embodiment can be characterized as a method of displaying content comprising providing a request to a content manager, the request including a set of criteria; searching for a collection that at least partially fulfills the request, the collection including a plurality of entities; determining which of the plurality of entities within the collection do not meet the set of criteria; and searching for a replacement entity to replace one of the plurality of entities within the collection that do not meet the set of criteria.

Another embodiment includes a method of modifying an entity, the entity having entity metadata associated therewith, comprising the steps of comparing the entity or the entity metadata with a set of presentation rules; determining a portion of the entity that does not meet the set of presentation rules; and removing the portion of the entity that does not meet the set of presentation rules.

Yet another embodiment can be characterized as a collection embodied on a computer readable medium comprising a digital video file entity; an audio entity, for providing an associated audio for the digital video file; a menu entity, for providing chapter points within the digital video file; and collection metadata for defining the playback of the digital video file entity, the audio entity, and the menu entity.

Still another embodiment can be characterized as a method of downloading streaming content comprising downloading a first portion of the streaming content; downloading a second portion of the steaming content while the first portion of the streaming content is also downloading; outputting the first portion of the steaming content for display on a presentation device; and outputting the second portion of the steaming content for display on a presentation device after outputting the first portion of the steaming content; wherein a third portion of the steaming content originally positioned in between the first portion of the steaming content and the second portion of the steaming content is not output for display on a presentation device.

In one embodiment, the invention can be characterized as an integrated system for combining web or network content and disk content comprising a display; a computing device operably coupled to a removable media, a network and the display, the computing device at least once accessing data on the network, the computing device comprising: a storage device, a browser having a presentation engine displaying content on the display, an application programming interface residing in the storage device, a decoder at least occasionally processing content received from the removable media and producing media content substantially suitable for display on the display, and a navigator coupled to the decoder and the application programming interface, the navigator facilitating user or network-originated control of the playback of the removable media, the computing device receiving network content from the network and combining the network content with the media content, the presentation engine displaying the combined network content and media content on the display.

In one exemplary embodiment, the network content may be transferred over a network that supports Universal Plug and Play (UPnP). The UPnP standard brings the PC peripheral Plug and Play concept to the home network. Devices that are plugged into the network are automatically detected and configured. In this way new devices such as an Internet gateway or media server containing content can be added to the network and provide additional access to content to the system. The UPnp architecture is based on standards such as TCP/IP, HTTP, and XML. UPnP can also run over different networks such as IP stack based networks, phone lines, power lines, Ethernet, Wireless (RF), and IEEE 1394 Firewire. UPnP devices may also be used as the presentation device as well. Given this technology and others such as Bluetooth, Wifi 802.11a/b/g etc. the various blocks in the systems do not need to be contained in one device, but are optionally spread out across a network of various devices each performing a specific function.

In another embodiment, using REBOL and IOS creates a distributed network where systems can share media. REBOL is not a traditional computer language like C, BASIC, or Java. Instead, REBOL was designed to solve one of the fundamental problems in computing: the exchange and interpretation of information between distributed computer systems. REBOL accomplishes this through the concept of relative expressions (which is how REBOL got its name as the Relative Expression-Based Object Language). Relative expressions, also called “dialects”, provide greater efficiency for representing code as well as data, and they are REBOL's greatest strength. The ultimate goal of REBOL is to provide a new architecture for how information is stored, exchanged, and processed between all devices connected over the Internet. IOS provides a better approach to group communications. It goes beyond email, the web, and Instant Messaging (IM) to provide real-time electronic interaction, collaboration, and sharing. It opens a private, noise-free channel to other nodes on the network.

In another embodiment, the invention can be characterized as a method comprising: a) receiving a removable media; b) checking if said removable media supports media source integration; c) checking if said removable media source is a DVD responsive to said removable media supporting source integration; d) checking whether said device is in a movie mode or a system mode responsive to said removable media being a DVD; e) launching standard playback and thereafter returning to said step (a) responsive to said device being in said movie mode; f) checking if said device has a default player mode of source integration when said device is in said system mode; g) launching standard playback and thereafter returning to said step (a) responsive to said device not having a default player mode of source integration; h) checking if said removable media contains a device-specific executable program when said device having a default player mode of source integration; i) executing said device-specific executable program when said device has said device-specific executable program and thereafter returning to said step (a); j) checking whether said device has a connection to a remote media source; k) launching a default file from said removable media when said device does not have a remote media source connection and thereafter returning to said step (a); l) checking whether said remote media source has content relevant to said removable media; m) displaying said relevant content when said relevant content exists and thereafter returning to said step (a); n) otherwise launching a default file from said removable media and thereafter returning to said step (a); o) returning to said step (f).

One embodiment of the present invention can be characterized as a method comprising receiving a request for content; searching for a plurality of entities in response to the received request, the plurality of entities each having entity metadata associated therewith; and creating a collection, the collection comprising the plurality of entities and collection metadata. These requests can be to local devices, to peripherals to the device, or to devices on a local/remote network, or the Internet. In addition, metadata can be optionally encrypted requiring specific decryption keys to unlock them for use.

Another embodiment of the present invention can be characterized as a data structure embodied on a computer readable medium comprising a plurality of entities; entity metadata describing each of the plurality of entities; a collection containing each of the plurality of entities; and collection metadata describing the collection.

Yet another embodiment of present invention can be characterized as a system comprising receiving a request for content; creating a collection comprising a plurality of entities meant for display on a first type of presentation device; adding at least one entity meant for display on a second type of presentation device to the collection; and outputting the collection comprising the plurality of entities meant for display on the first type of presentation device and the at least one entity meant for display on the second type of presentation device to the first type of presentation device.

An alternative embodiment of the present invention can be characterized as a method comprising receiving a request for content; searching for a plurality of entities in response to the received request; creating a collection comprising the plurality of entities, the collection having collection metadata; and generating presentation rules for the entities base at least upon the collection metadata. This embodiment can further comprise outputting the collection to a presentation device based upon the generated presentation rules.

Yet another alternative embodiment of the present invention can include a method comprising receiving a request for content; searching for a plurality of entities in response to the received request, the plurality of entities each having entity metadata; comparing a user profile to the entity metadata for each of the plurality of entities; and creating a collection comprising the plurality of entities base at least upon the comparison of the user profile to the entity metadata.

In an alternative embodiment the present invention includes a system comprising a plurality of computers connected via a network; a plurality of shared entities located on at least one of the plurality of computers; and a content management system located on at least one of the plurality of computers for creating a collection using at least two of the plurality of shared entities.

Another alternative embodiment of the present invention includes a method of modifying an existing collection comprising analyzing metadata associated with the existing collection; and adding at least one new entity to the existing collection based upon a system profile. In another embodiment, the method can further comprise removing at least one entity from the existing collection, wherein the added entity takes the place of the removed entity.

Yet another embodiment includes a method of displaying a context sensitive menu comprising the steps of outputting content to a display device; receiving a request to display a menu; deriving the context sensitive menu from the current content being output; and outputting the context sensitive menu to the display device.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a hardware platform including a playback subsystem, presentation engine, entity decoders, and a content services module;

FIG. 2 is a diagram illustrating a general overview of a media player connected to the Internet according to one embodiment;

FIG. 3 is a block diagram illustrating a plurality of components interfacing with a content management system in accordance with one embodiment of the present invention;

FIG. 4 is a block diagram illustrating a system diagram of a collection and entity publishing and distribution system connected to the content management system of FIG. 3;

FIG. 5 is a diagram illustrating a media player according to one embodiment;

FIG. 6 is a diagram illustrating a media player according to another embodiment;

FIG. 7 is a diagram illustrating an application programming system in accordance with one embodiment;

FIG. 8 is a conceptual diagram illustrating the relationship between entities, collections, and their associated metadata;

FIG. 9 is a conceptual diagram illustrating one example of metadata fields for one of the various entities;

FIG. 10 is a conceptual diagram illustrating one embodiment of a collection;

FIG. 11 is a diagram illustrating an exemplary collection in relation to a master timeline;

FIG. 12 is a block diagram illustrating a virtual DVD construct in accordance with one embodiment of the present invention;

FIG. 13 is a diagram illustrating a comparison of a DVD construct as compared to the virtual DVD construct described with reference to FIG. 12;

FIG. 14 is a block diagram illustrating a content management system locating a pre-define collection in accordance with an embodiment of the present invention;

FIG. 15 is a block diagram illustrating a search process of the content management system of FIG. 14 for locating a pre-defined collection in accordance with one embodiment of the present invention;

FIG. 16 is a block diagram illustrating a content management system creating a new collection in accordance with an embodiment of the present invention;

FIG. 17 is a block diagram illustrating a search process of the content management system of FIG. 16 for locating at least one entity in accordance with one embodiment of the present invention;

FIG. 18 is a block diagram illustrating a content management system publishing a new collection in accordance with an embodiment of the present invention;

FIG. 19 is a block diagram illustrating a content management system locating and modifying a pre-define collection in accordance with an embodiment of the present invention;

FIG. 20 is a block diagram illustrating a search process of the content management system of FIG. 19 for locating a pre-defined collection in accordance with one embodiment of the present invention;

FIG. 21 is a block diagram illustrating an example of a display device receiving content from local and offsite sources according to one embodiment of the present invention;

FIG. 22 is a block diagram illustrating an example of a computer receiving content from local and offsite sources according to one embodiment of the present invention;

FIG. 23 is a block diagram illustrating an example of a television set-top box receiving content from local and offsite sources and according to one embodiment of the present invention;

FIG. 24 is a block diagram illustrating media and content integration according to one embodiment of the present invention;

FIG. 25 is a block diagram illustrating media and content integration according to another embodiment of the present invention;

FIG. 26 is a block diagram illustrating media and content integration according to yet another embodiment of the present invention;

FIG. 27 is a block diagram illustrating one example of a client content request and the multiple levels of trust for acquiring the content in accordance with an embodiment of the present invention;

FIG. 28 shows a general exemplary diagram of synchronous viewing of content according to one embodiment;

FIG. 29 is a block diagram illustrating a user with a smart card accessing content in accordance with an embodiment of the present invention; and

FIG. 30 is a diagram illustrating an exemplary remote control according to an embodiment of the present invention.

### DETAILED DESCRIPTION OF THE DRAWINGS

The following description is not to be taken in a limiting sense, but is made merely for the purpose of describing the general principles of the invention. The scope of the invention should be determined with reference to the claims.

A system and method for metadata distribution to customize media content playback is described in U.S. Publication No. 20030122966 which is incorporated herein by reference in its entirety. “DVD Video (Book 3) Specification 1.0” is incorporated herein by reference in its entirety. This reference is for DVD-Video (read-only) discs.

DVD Specifications for Read-Only Disc—DVD Book, Version 1.0, August 1996, published by Hitachi, Ltd, Matsushita Electric Industrial Co., Ltd, Philips Electronics N.V., Pioneer Electronic Corporation, Sony Corporation, THOMSON Multimedia, Time Warner Inc., Toshiba Corporation, and Victor Company of Japan, Limited, is incorporated herein in its entirety.

The following non-patent documents are hereby incorporated by reference as if set forth in their entirety: InterActual API Design Guidelines for Consumer Electronics Manufacturers; InterActual application programming interface (API) Specification (also called InterActual API Specification), DVD specification, InterActual Architecture System Design Guidelines v0.9x—Greg Gewickey, Aug. 30, 2001, and InterActual application Programming Interface Specification v1.04—Greg Gewickey, Aug., 20 2002.

Metadata generally refers to data about data. A good example is a library catalog card, which contains data about the nature and location of the data in the book referred to by the card. There are several organizations defining metadata for media. These include Publishing Requirements for Industry Standard Metadata (PRISM http://www.prismstandard.org/), the Dublin CORE initiative (http://dublincore.org/), MPEG-7 and others.

Metadata can be important on the web because of the need to find useful information from the mass of information available. Manually-created metadata (or metadata created by a software tool where the user defines the points in the timeline of the audio and video and specifies the metadata terms and keywords) adds value because it ensures consistency. In one embodiment, metadata can be generated by the system described herein. For example, when a webpage about a topic contains a word or phrase, then all web pages about that topic generally contain the same word. Metadata can also ensure variety, so that if one topic has two names, each of these names will be used. For example, an article about sports utility vehicles would also be given the metadata keywords ‘4 wheel drives’, ‘4WDs’ and ‘four wheel drives’, as this is what they are known as in Australia.

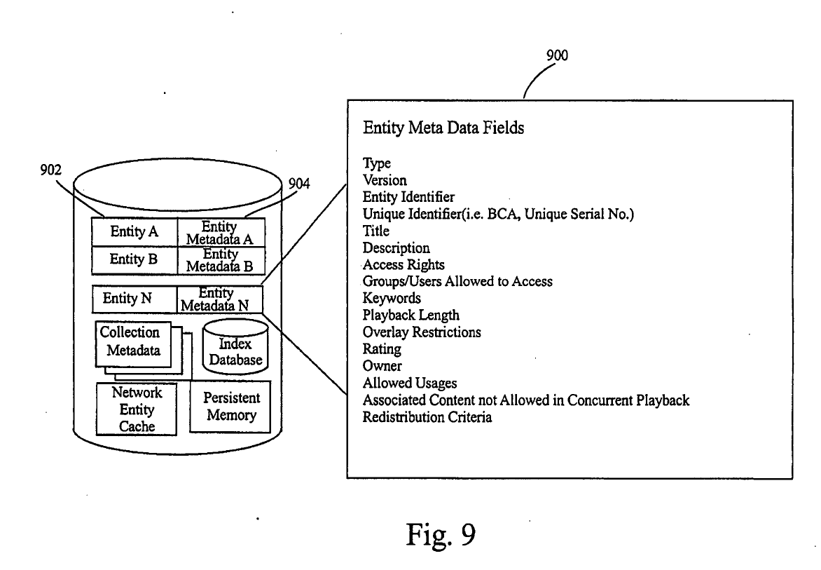

As referred to herein, an entity is a piece of data that can be stored on a computer readable medium. For example, an entity can include audio data, video data, graphical data, textual data, or other sensory information. An entity can be stored in any media format, including, multimedia formats, file based formats, or any other format that can contain information whether graphical, textual, audio, or other sensory information. Entities are available on any disk based media, for example, digital versatile disks (DVDs), audio CDs, videotapes, laser-disks, CD-ROMs, or video game cartridges. Furthermore, entities are available on any computer readable medium, for example, a hard drive, a memory of a server computer, RAM, ROM, etc. In some embodiments, an entity will have entity metadata associated herewith. Examples of entity metadata will be further described herein at least with reference to FIG. 9.

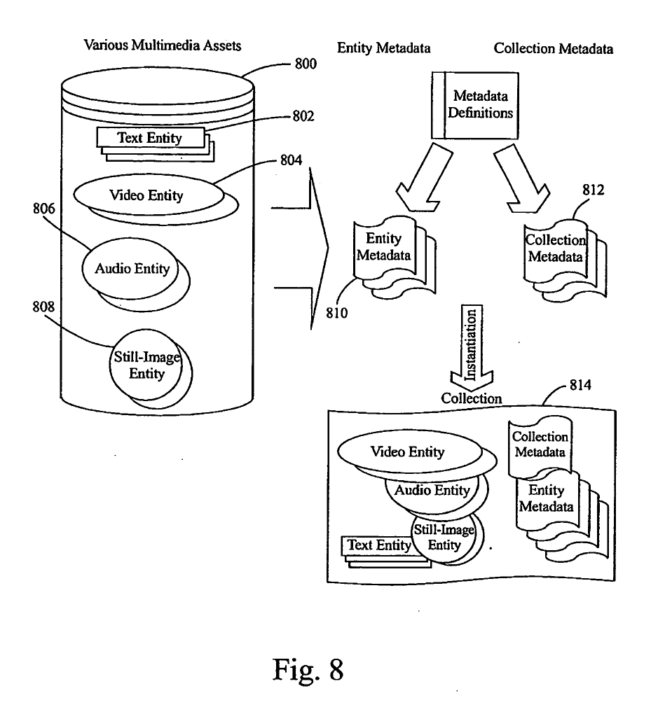

As referred to herein, a collection includes a plurality of entities and collection metadata. The collection metadata defines the properties of the collection and how the plurality of entities are related within the collection. Collection metadata will be further defined herein at least with reference to FIGS. 8-10.

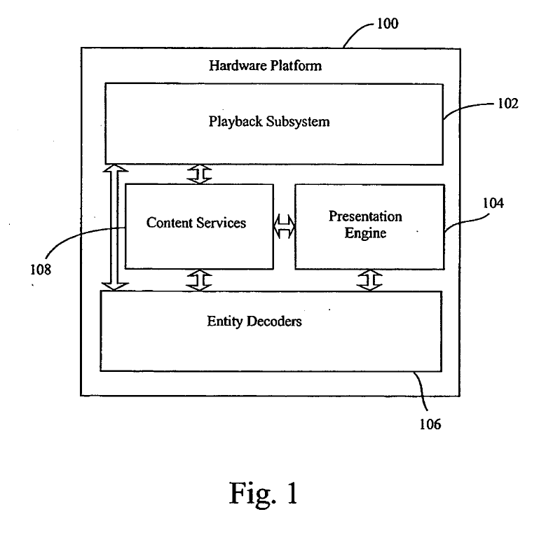

In accordance with one embodiment of the present invention a user of a content management system can create and modify existing collections. Different embodiments of the content management system will be described herein at least with reference to FIGS. 1-4 and 6-7. Advantageously, the user of the content management system is able to create new collections from entities that are stored on a local computer readable medium. Alternatively, the user may also be able to retrieve entities over the Internet or other network to substitute for entities that are not locally stored.

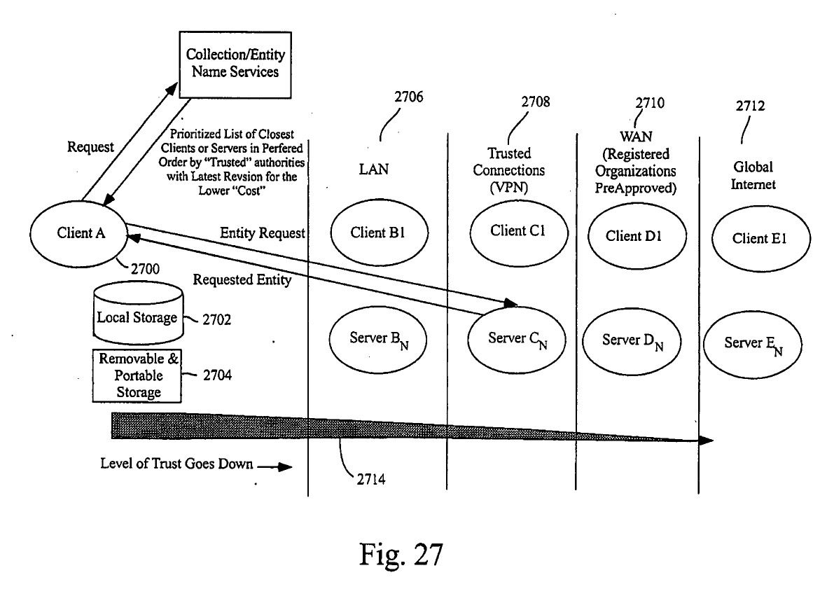

In accordance with another embodiment of the present invention a search engine is provided that searches for entities and collections located within different trust levels. Trust levels will be further described herein with reference to FIG. 27. In one embodiment, the results of a search are based upon at least upon the trust level where the entity is stored. In another embodiment, the results of the search are based upon metadata associated with an entity. In yet another embodiment, the search results can be based upon a user profile or a specified request.

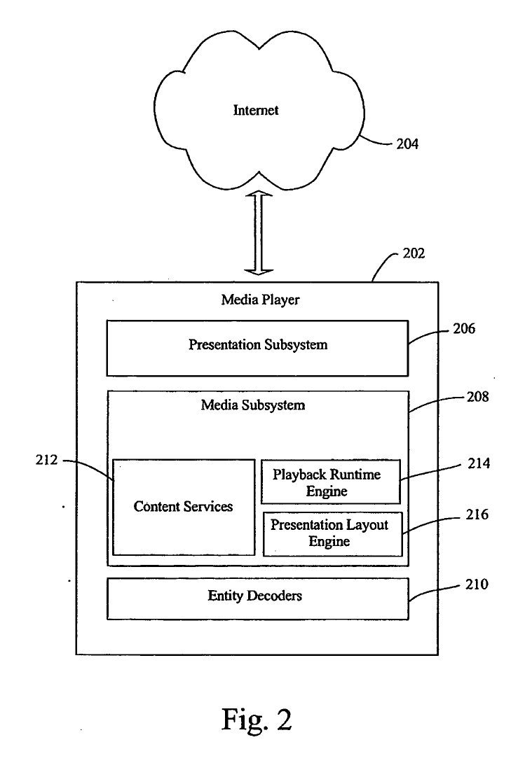

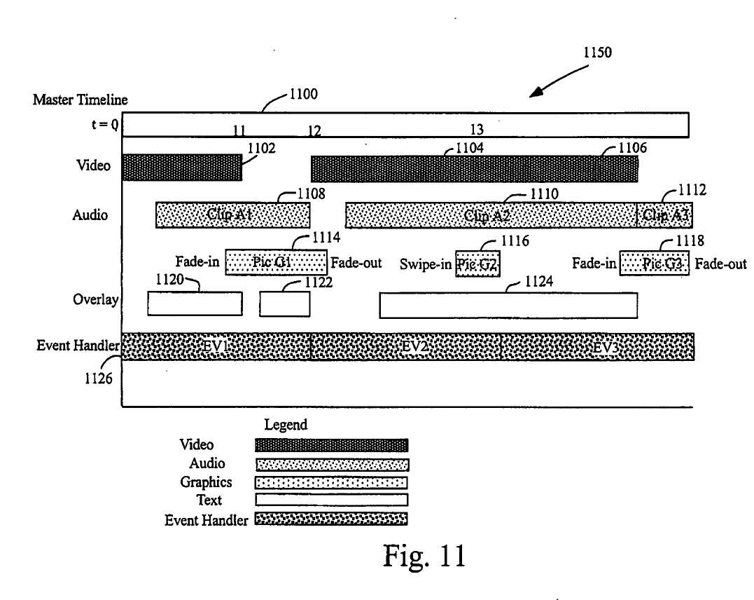

An application programming interface (API) can be used in one embodiment based on a scripting model, leveraging, e.g., industry standard HTML and JavaScript standards for integrating locally stored media content and remote interactively-obtained network media content, e.g., video content on a web page. The application programming interface (API) enables embedding, e.g., video content in web pages, and can display the video in full screen or sub window format. Commands can be executed to control the playback, search, and overall navigation through the embedded content. The application programming interface will be described in greater detail at least with reference to FIGS. 2 and 5-7. In addition behavioral metadata is used by the application programming interface in some embodiments to provide rules for presentation of entities and collections. Behavioral metadata, which one type of collection metadata, will be described in greater detail herein at least with reference to FIG. 11.

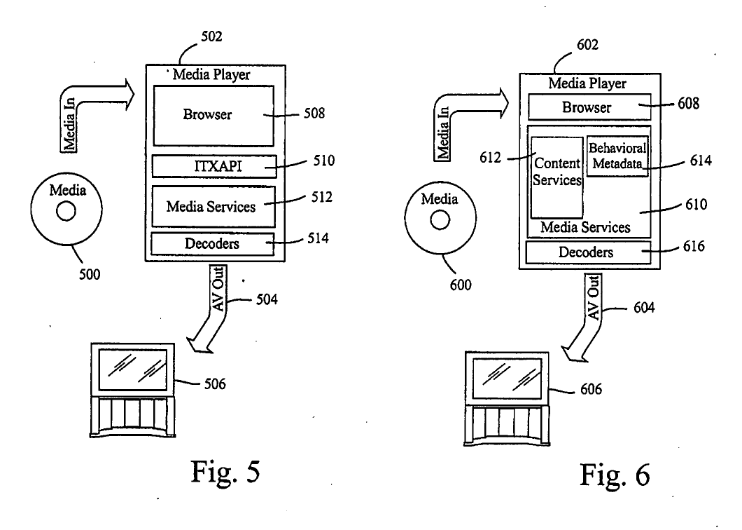

The application programming interface can be queried and/or set using properties. Effects may be applied to playback. Audio Video (AV) sequences have an associated time element during playback, and events are triggered to provide notification of various playback conditions, such as time changes, title changes, and user operation (UOP) changes. Events can be used for use in scripting and synchronizing audio and/or video-based content (AV content) with other media types, such HTML or read only memory (ROM)-based content, external to the AV content. This will be described in greater detail herein with reference to FIGS. 5-7.

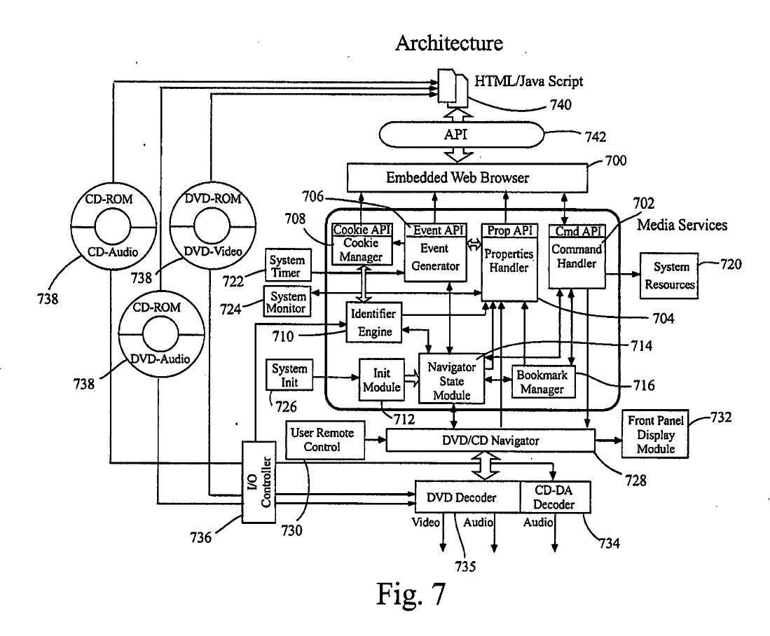

In one embodiment the application programming interface (API) enables content developers to create products that seamlessly combine, e.g., content from the Internet with content from other digital versatile disk-read only memory (DVD-ROM), digital versatile disk-audio (DVD-Audio), compact disc-audio (CD-Audio), compact disc-digital audio (CD-DA). There are several ways to seamlessly navigate from the AV Video content to the HTML (ROM) content and back. In one example, the AV content is authored as to have internal triggers that cause an event that can be received by external media types. Alternatively, the AV content is authored as to have portions of the AV content that can be associated with triggering an event that can be received by external media types. For example, in DVD-video entry and exit points can be devised using dummy titles and title traps. A dummy title is an actual title within the DVD, however, in one example, there is no corresponding video content associated with the title. For example, the dummy title can have period, e.g., 2 seconds, of black space associated with it. The dummy title is used to trigger an event, thus is referred to as a title trap. During the DVD-Video authoring, the dummy titles are created that, when invoked, display n seconds (where n is any period of time) of a black screen, then return. Additionally, the middleware software layer informs the user interface that a certain title has been called and the user interface can traps on this (in HTML, using a DOM event and JavaScript event handler) and display an alternate user interface instead of the normal AV content. FIG. 7 depicts how these devices have been employed to integrate HTML as the user interface and DVD-Video content as the AV content.

In this example, the introductory AV content usually has user operation control functions, such as UOPs in DVD-Video, for prohibiting forwarding through a FBI warning and the like. As many type of AV content have, there is a scene selection on a main menu. However, in one embodiment, when the middleware layer traps on title number 4 when played on an device such as depicted in FIGS. 1-4, a unique HTML Enhanced Scene Selection menu (web page) is presented. The enhancement can be as simple as showing the scene in an embedded window so the consumer can decide if this is the desired scene before leaving the selection page. After using this enhanced menu, a hyperlink is provided which returns to the Main menu by playing title number 2, which is a dummy title (entry point) back into the main DVD-Video menu. Additionally, the JavaScript can load an Internet server page instead of the ROM page upon invocation thereby updating the ROM content with fresher, newer server content. The updating of content is described, for example, in U.S. patent application Ser. No. 09/476,190, entitled A SYSTEM, METHOD AND ARTICLE OF MANUFACTURE FOR UPDATING CONTENT STORED ON A PORTABLE STORAGE MEDIUM, which is incorporated herein by reference in its entirety.

Hereinafter, by the use of DVD-Video, it is to be understood that all of these disk/disc media are included. The combination of the Internet with DVD-Video creates a richer, more interactive, and personalized entertainment experience for users.

Further, the application programming interface (API) provides a common programming interface allowing playback of this combined content on multiple playback platforms simultaneously. While the application programming interface (API) allows customized content and functions tailored for specific platforms, the primary benefit of the application programming interface (API) is that content developers can create content once for multi-platform playback, without the need of becoming an expert programmer on specific platforms, such as Windows, Macintosh, and other platforms. As described above, this is accomplished through the use of the events.

Internet connectivity is not a requirement for the use of the application programming interface (API). In addition, compact disc-digital audio (CD-DA) can also be enhanced by use of the application programming interface (API). This is also described in the document InterActual Usage Guide for Developers (hereby incorporated by reference).

Personal video recorders (PVRs), such as the TiVo, RePlay, and digital versatile disk-recordable (DVD-R) devices, allow users to purchase video or audio products (entities or collections) by downloading video or audio products from a satellite, a cable television distribution network, the Internet, another network or other high-bandwidth systems. When so downloaded, the video or audio can be stored to a local disk system or burned onto a DVD-R. In one embodiment of the present invention, the content stored on the PVR or DVD-R can be supplemented with additional content, e.g., from a LAN, the Internet and/or another network and displayed or played on a presentation device, such as a computer screen, a television, and/or an audio and/or video playback device. The combination of the content with the additional content can be burned together onto a DVD-R, or stored together on, for example a PVR, computer hard drive, or other storage medium.

Referring now to FIG. 1, a diagram is shown illustrating the interaction between a playback subsystem 102, a presentation engine 104, entity decoders 106 and a content services module 108 according to an embodiment. The system shown in FIG. 1 can be utilized in many embodiments of the present invention.

Shown are a hardware platform 100, the playback subsystem 102, the content services module 108, the presentation engine 104, and the entity decoders 106. The hardware platform includes the playback subsystem 102, the content services module 108, the presentation engine 104 and the entity decoders 106.

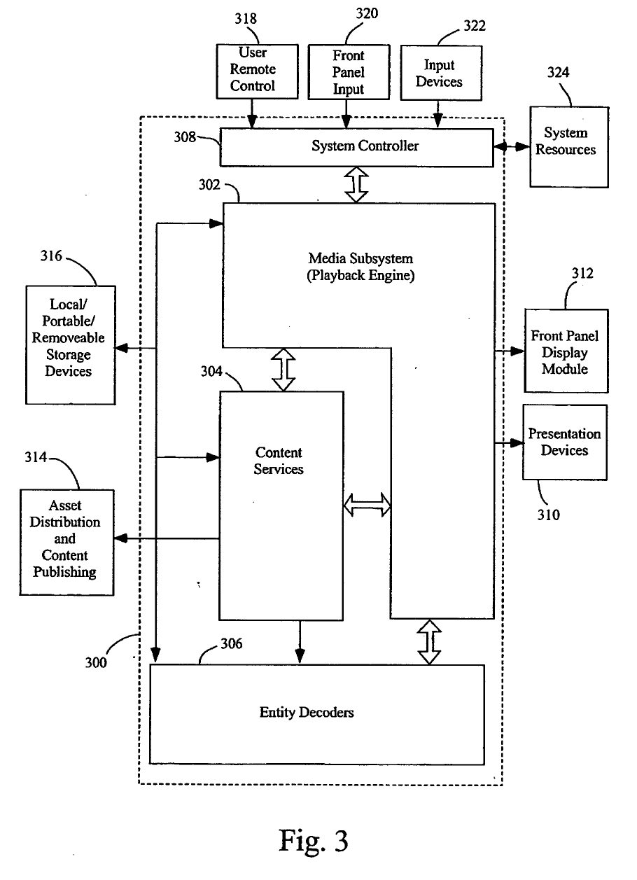

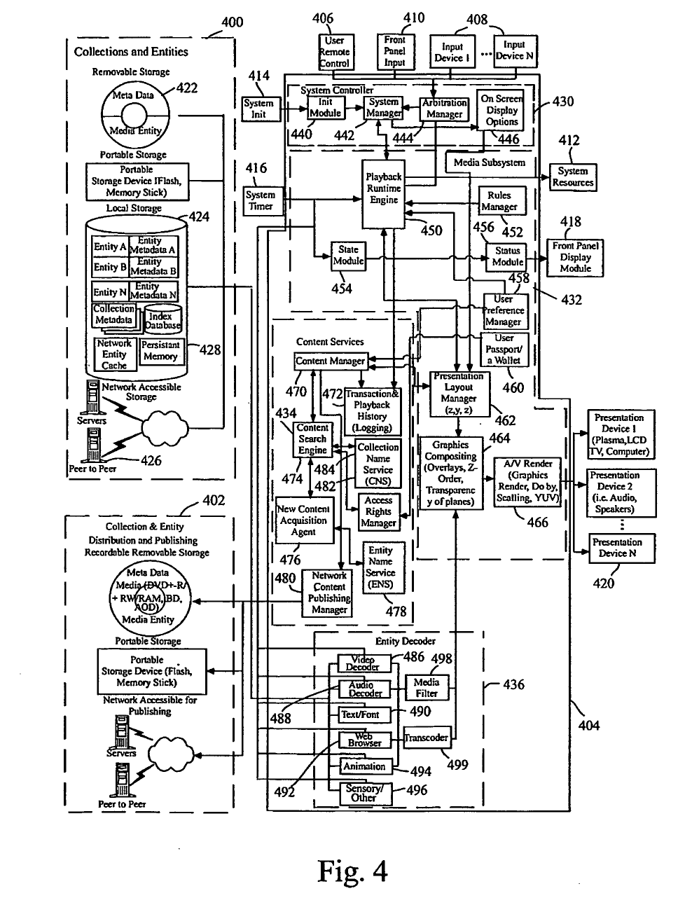

The content services module gathers 108, searches, and publishes entities and collections in accordance with the present invention. The content services module 108 additionally manages the access rights for entities and collections as well as logging the history of access to the entities and collections. These features are described in greater detail herein at least with reference to FIGS. 3 and 4.

The presentation engine 104 determines how and where the entities will be displayed on a presentation device (not shown). The presentation engine utilizes the metadata associated with the entities and presentation rules to determine where and when the entities will be displayed. Again, this will be further described herein at least with reference to FIGS. 3 and 4.

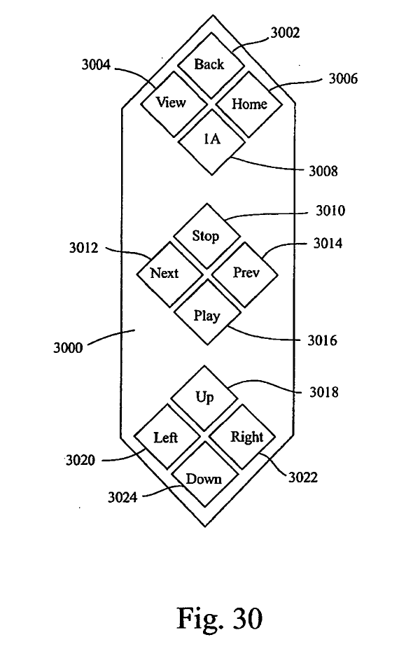

The playback subsystem 102 maintains the synchronization, timing, ordering and transitions of the various entities. This is done in ITX through the event model (described in greater detail below with reference to FIG. 7) triggering a script event handler. In this system, behavioral metadata will specify what actions will take place based upon a time code or media event during playback and the playback subsystem 102 will start the actions at the correct time in playback. The playback subsystem 102 also processes any scripts of the collections and has the overall control of the entities determining when an entity is presented or decoded based upon event synchronization or actions specified in the behavioral metadata. The playback subsystem 102 accepts user input to provide the various playback functions including but not limited to, play, fast-forward, rewind, pause, stop, slow, skip forward, skip backward, and eject. The user inputs can come from, for example, the remote control depicted in FIG. 30. The playback subsystem 102 receives signals from the remote control and executes a corresponding command such as one of the commands listed above. In one embodiment, the synchronization is done using Events. An event is generally the result of a change of state or a change in data. Thus, the playback subsystem monitors events and uses the events to trigger an action (e.g., the display of an entity). See, e.g., the event section of FIG. 7 for a DVD-Video example of that uses events.

In one embodiment, the entity decoder 106 allows entities to be displayed on a presentation device. The entity decoder, as will be described in greater detail with reference to FIGS. 3 and 4, is one or more decoders that read different types of data. For example, the entity decoders can include a video decoder, an audio decoder, and a web browser. The video decoder reads video files and prepares the data within the files for display on a presentation device. The audio decoder will read audio files and prepare the audio for output from the presentation device. There are numerous markup languages that optionally are used in the content management system and that can be interpreted by the web browser. The web browser optionally supports various markup languages including, but not limited to, HTML, XHTML, MSHTML, MHP, etc. While HTML is referenced throughout this document virtually any markup language or alternative meta-language or script language can be used.

In one embodiment, the presentation device is a presentation rendering engine that supports virtual machines, scripts, or executable code. Suitable virtual machines, scripts and executable code include, for example, Java, Java Virtual Machine (JVM), MHP, PHP, or some other equivalent engine.

All of the features of the system in FIG. 1 will be described in greater detail at least with reference to the following description of FIGS. 3 and 4.

Referring to FIG. 2 a diagram is shown illustrating a general overview of a media player connected to the Internet according to one embodiment.

Shown are a media player 202, a media subsystem 208, a presentation subsystem 206, a content services module 212, a playback runtime engine 214, a presentation layout engine 214, entity decoders 210, and an Internet 204.

In a preferred embodiment, the media player 202 is connected to the Internet 204, for example, though a cable modem, T1 line, DSL or dial-up modem. The media player 202 includes the presentation subsystem 206, the media subsystem 608 and the entity decoders 210. The media subsystem 208 further includes the content services module 212, the playback runtime engine 214 and the presentation layout engine 216. While FIG. 2 shows the content service module 212 as part of the media subsystem 208, alternatively, as shown in FIGS. 3 and 4, the content services module is not part of the media subsystem 208.

The playback runtime engine 214 is coupled to the content services module 212 and provides the content services module 212 with a request for a collection. The request can include, e.g., a word search, metatag search, or an entity or a collection ID. The playback runtime engine 214 also provides the content services module 212 with a playback environment description. The playback environment description includes information about the system capabilities, e.g., the display device, Internet connection speed, number of speakers, etc.

One example of the playback request described in XML can be as follows:

```
<?xml version=“1.0” encoding=“UTF-8”?>
<Metadata xmlns:xsi=“http://www.w3.org/2001/XMLSchema-instance”
xsi:noNamespaceSchemaLocation=“REQ.xsd”>
  <Module>
    <collectionList>
      <id>123456789</id>
      <id>223456789</id>
      <id>323456789</id>
    </collectionList>
    <requestedPlayback>
      <videoDisplay>
        <videoDisplaytype>01</videoDisplaytype>
      </videoDisplay>
      <videoResolutions>
        <resolution>
          <videoXResolution>1024</videoXResolution>
          <videoYResolution>768</videoYResolution>
        </resolution>
      </videoResolutions>
      <navigationDevices>
        <device>03</device>
      </navigationDevices>
      <textInputDeviceReqd>01</textInputDeviceReqd>
    </requestedPlayback>
  </Module>
</Metadata>
```

One-example of the playback environment description described in XML can be as follows:

```
<?xml version=“1.0” encoding=“UTF-8”?>
<Metadata xmlns:xsi=“http://www.w3.org/2001/XMLSchema-instance”
xsi:noNamespaceSchemaLocation=“CAP.xsd”>
  <Module>
    <Capabilities>
      <platforms>
        <platform>01</platform>
        <platform>02</platform>
      </platforms>
      <products>
        <productID>01</productID>
        <productID>02</productID>
      </products>
      <videoDisplays>
        <videoDisplaytype>01</videoDisplaytype>
        <videoDisplaytype>02</videoDisplaytype>
      </videoDisplays>
      <videoResolutions>
        <resolution>
          <videoXResolution>1024</videoXResolution>
          <videoYResolution>768</videoYResolution>
        </resolution>
        <resolution>
          <videoXResolution>800</videoXResolution>
          <videoYResolution>600</videoYResolution>
        </resolution>
      </videoResolutions>
      <navigationDevices>
        <device>02</device>
        <device>03</device>
      </navigationDevices>
      <textInputDeviceReqd>01</textInputDeviceReqd>
      <viewingDistances>
        <view>01</view>
        <view>02</view>
      </viewingDistances>
    </Capabilities>
  </Module>
</Metadata>
```

The presentation layout engine 216 determines where on the presentation device different entities within a collection will be displayed by reading collection metadata and/or entity metadata. As described below, at least with reference to FIGS. 8-10, metadata can be stored, e.g., in an XML file. The presentation layout engine 216 also optionally uses the playback environment description (e.g., the XML example shown above) to determine where on the presentation device the entities will be displayed. The presentation layout engine also reads the playback environment description to determine the type of display device that will be used for displaying the entities or the collection.

In one example, multiple entities within a collection will be displayed at the same time (See FIG. 11, for example). The presentation layout engine 216 determines where on the display device each of the entities will be displayed by reading the collection metadata and the presentation environment description.

The entity decoders 210 include at least an audio and video decoder. Preferably, the entity decoders 210 include a decoder for still images, text and any other type of media that can be displayed upon a presentation device. The entity decoders 210 allow for the many different types of content (entities) that can be included in a collection to be decoded and displayed.

The media player 202 can operate with or without a connection to the Internet 204. When the media player 202 is connected to the Internet 204, entities and collections not locally stored on the media player 202 are available for display. The content services module, as is shown in FIG. 4, includes a content search engine. The content search engine searches the Internet for entities and collections. The entities and collections can be downloaded and stored locally and then displayed on a display device. Alternatively, the entities and collections are streamed to the media player 202 and directly displayed on the presentation device. The searching features and locating features will be described in greater detail herein at least with reference to FIGS. 3, 4, and 27.

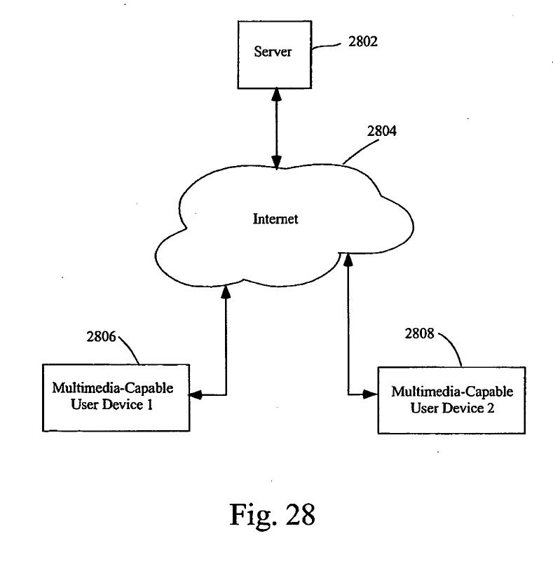

The Internet 204 is shown as a specific example of the offsite content source 106 shown in FIGS. 28-30.

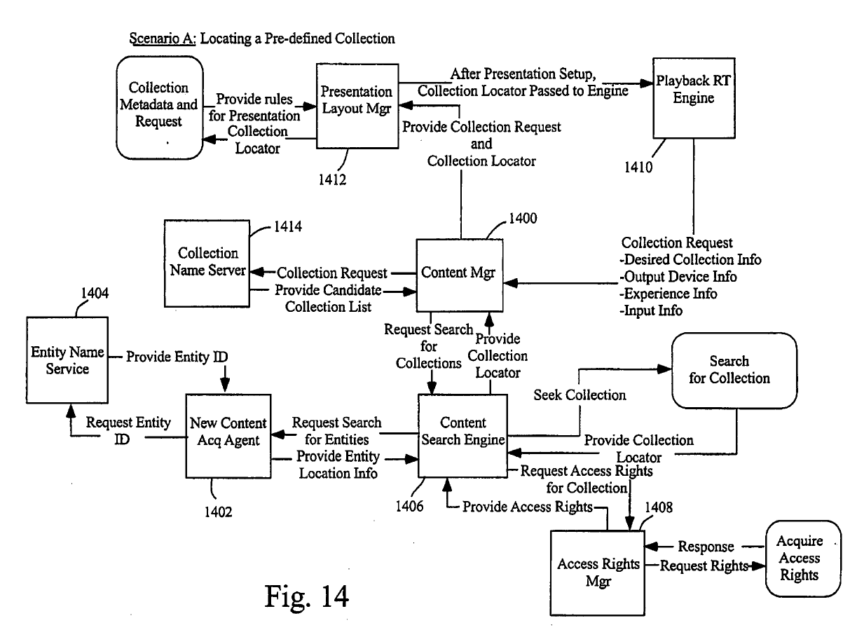

Thus, in a preferred embodiment, the media subsystem 208 is capable of retrieving, creating, searching for, publishing and modifying collections in accordance with one embodiment. The media subsystem 208 retrieves and searches for entities and collections through the content search engine and new content acquisition agent (both described in greater detail herein at least with reference to FIGS. 4, 14, and 15). The media subsystem publishes entities and collections through the use of an entity name service and collection name service, respectively. The entity name service, the collection name service, and publishing of collections are all described in greater detail at least with reference to FIGS. 4 and 14. The modification of entities and collections will also be described here in greater detail at least with reference to FIGS. 4, 19 and 20. Additionally, the creation on an entity or collection will be described herein in greater detail with reference to FIGS. 4, 16, and 17.

The content services module 212 manages the collections and entities. A content search engine within the content services module 212 acquires new collections and entities. The content services module 212 additionally publishes collections and entities for other media players to acquire. Additionally, the content services module 212 is responsible for managing the access rights to the collections and entities.

Referring to FIG. 3, a high level diagram is shown of the components that are interfaced with in the various parts of a content management system. Shown are a content management system 300, a media subsystem 302, a content services module 304, an entity decoder module 306, a system controller 308, a presentation device 310, a front panel display module 312, an asset distribution and content publishing module 304, a plurality of storage devices 306, a user remote control 308, a front panel input 320, other input devices 322, and system resources 324.

The content management system 300 includes the media subsystem 302 (also referred to as the playback engine), the content services module 304, the entity decoder module 306 and the system controller 308. Within the content management system 300 the system controller 308 is coupled to the media subsystem 302. The media subsystem 302 is coupled to the content services module 304 and the entity decoder module 306 entity decoder module 306 is coupled to the media subsystem 302 the content services module 304.

The content management system 300 is coupled to the asset distribution and content publishing module 314, the plurality of storage devices 316, the user remote control 318, the front panel input 320, the other input devices 322, and the system resources 324.

The user remote control 318 and the other input devices 320, e.g., a mouse, a keyboard, voice recognition, touch screen, etc., are collectively referred to herein as the input devices.

The system controller 308 manages the input devices. In some embodiments, multiple input devices exist in the system and the system controller uses a set of rules based on the content type whether an input device can be used and/or which input devices are preferred. For example, content that only has on-screen links and no edit boxes, for example, has a rule for the system controller to ignore keyboard input. The system controller 308 optionally has a mapping table that maps input signals from input devices and generate events or simulates other input devices. For example, the arrow keys on a keyboard map to a tab between fields or the up/down/left/right cursor movement. Optionally, Remote controls use a mapping table to provide different functionality for the buttons on the remote. Various processes subscribe to input events such as remote control events and receive notification when buttons change state. The input devices are, for example, remote controls, keyboards, mice, trackballs, pen (tablet/palm pilot), T9 or numeric keypad input, body sensors, voice recognition, video or digital cameras doing object movement recognition, and an other known or later to be developed mechanism for inputting commands into a computer system, e.g., the content management system 300 of the-present invention. Furthermore, an input device, are, in some embodiments, the presentation devices 310 as well. For example, on-screen controls or a touch screen can change based on the presentation of the content. The system controller 308 arbitrates the various input devices and helps determine the functionality of the input devices.

Additionally, in one embodiment, arbitration occurs between the operations for playback, the behavioral metadata an entity or collection allows, and the specific immediate request of the user. For example, a user may be inputting a play command and the current entity being acted upon is a still picture; The system controller 300 interprets the command and decides what action to take.

The media subsystem 302, also referred to herein as the playback engine, in one embodiment is a state machine for personalized playback of entities through the decoders in the decoder module 306. The media subsystem 302 can be a virtual machine such as a Java Virtual Machine or exist with a browser on the device. Alternatively, the media subsystem 302 can be multiple state machines. Furthermore, the media subsystem can be run on the same processor or with different processors to maintain the one or more state machines.

Following is a hierarchy:

HTML/JavaScript layer

Java VM layer (implementing the Content & Media Services)

DVD Navigator

DVD-Video decoder

The hierarchy demonstrates how different application layers can have their own state machine and that the layer above will take action having knowledge of the state of the layer below it. When a JavaScript command is issued to change the playback state of the DVD Navigator, it has to ensure the command will be allowed. The level of arbitration of these state machines can be demonstrated in this manner.

The playback engine 302 interacts with the content services module 304 to provide scripts and entities for playback on the presentation device 310. The content services module 304 utilizes the plurality of storage devices 1416 as well as network accessible entities to provide the input to the playback engine 302. A presentation layout manager, shown in FIG. 4, exists within the playback engine 302 and controls the display of the content on the presentation device 310.

The presentation device 310 comes in various formats or forms. In some cases displays can be in wide screen 16:9 and full screen 4:3 formats. Optionally, the displays types are of various technologies including, TFT, Plasma, LCD, Rear or Front Projection, DLP, Tube (Flat or Curved) with different content safe areas, resolutions, pixel sizing, physical sizes, colors, font support, NTSC vs. PAL, and different distances from the user.

In one embodiment, the media subsystem 302 controls the display of content based upon the presentation device 310 available. For example, a user in front of a computer as compared to a user that is 10 feet way from a TV screen needs different text sizing to make something readable. Additionally, the outside environment the presentation device is being viewed in, such as outside in direct sun or in an industrial warehouse, can also effect how the media subsystem will display content on the presentation device. In this example, the contrast or brightness of the presentation device will be adjusted to compensate for the outside light.

Multiple presentation devices can be available for displaying different content. For example, the presentation device can be a speaker or headset in the case of audio playback, or can be some other sensory transmitter. Additionally, the presentation device can display a status for the content management system.

The entity decoder module 306 decodes any of the different entities available to a user. The entity decoder module 1406 sends the decoded entities to the media subsystem, which as described above controls the output of the entities to the presentation devices. For example, for HTML/Javascript/Flash content a browser is used to decode the content and for a DVD Disc a DVD Navigator/Decoder can used to decode the video stream. The presentation device also has different ways of displaying the entity decoder output. For example, if the source material is 4:3 and the presentation device is 16:9, the content will displayed with black bars on the right side and left side at 4:3, stretched to 16:9, or be displayed in a panoramic view where a logarithmic scaling of the content is used from center to the sides. In one embodiment, the metadata for the-entity will prioritize which of these settings works best for the current entity. As described above, this is accomplished in one embodiment by having a preference defined in an XML file.

In one embodiment a user makes a request for content. The playback runtime engine constructs the request and provides a user request to the content manager. A user request is a description of the collection or list of collections requested and can include the specific components of the media playback system desired by the consumer for playback (e.g. “display B” if there are multiple displays available). The user request can be described in the form of metadata which the Content Manager can interpret.

In one embodiment, the user request will additionally include a user profile that is used to tailor or interpret the request. A user profile is a description of a specific consumer's preferences which can be embodied in the user request. Optionally, the preferences are compiled by the new content acquisition agent over time and usage by the consumer.

Preferably, the request also includes a system profile (also referred to herein as system information). The system profile is a description of the capabilities of the media playback system including a complete characterization of the input, output and signal processing components of the playback system. In one embodiment, the system profile is described in the form of metadata which the Content Manager interprets. The content manager will then search for entities that will be preferred for the given system and also that will be compatible within the playback system. In one embodiment, the content manager uses the user request, the user profile and the system profile in order to search for entities or collections.

In one embodiment, the metadata associated with an entity is manually entered by the owner of the entity. Optionally, the manually entered metadata is automatically processed by the content management system that adds additional related metadata to the entity metadata. For example, the metadata of “4WD” is expanded to include ‘four wheel drive’, or further associated with ‘sport utility vehicle’ or ‘SUV’ which are similar terms for 4WD vehicles. This process is done while the metadata is created or done during the search process where search keywords are expanded to similar words as in this example. Alternatively, the content management system is utilized to create the metadata for the entity. Users are able to achieve real-time completely automated meta-tagging, indexing, handling and management of any audio and video entities. In one embodiment, this is done by creating dynamic indexes. The dynamically created index consists of a time-ordered set of time-coded statements, describing attributes of the source content. Because the statements are time-ordered and have millisecond-accurate time-codes, they are used to manipulate the source material trans-modally, i.e., allowing the editing of the video, by synchronistically manipulating the text, video and audio components. With this indexing a user is able to jump to particular words, edit a clip by selecting text, speaker or image, jump to next speaker, jump to next instance of current speaker, search for named speaker, search on accent or language, view key-frame of shot, extract pans, fades etc, or to find visually similar material.

In real-time multimedia production, the system optionally automates the association of hyperlinked documents with real-time multimedia entities, instant cross-referencing of live material with archived material, triggering of events by attribute (e.g. show name when speaker X is talking). For entity archives, the system provides automatic categorization of live material, automatically re-categorizes multiple archives, makes archives searchable from any production system, enables advanced concept-based retrieval as well as traditional keyword or Boolean methods, automatically aggregates multiple archives, automatically extracts and appends metadata.

One technology that is optionally used is high-precision speech recognition and video analysis to actually understand the content of the broadcast stream and locate a specific segment without searching, logging, time coding or creating metadata.

Yet another approach directly addresses the problems associated with manual meta-tagging by adding a layer of intelligence and automation to the management of XML by understanding the content and context of either the tags themselves or the associated information. In effect, this removes the need for meta-tags or explicit metadata. Metadata is implicitly (covertly) inferred through the installed layer of intelligence. However, if metadata is required, intuitive user interfaces may be provided to add reassurance and additional information. In situations where there are already large amounts of existing metadata and/or established taxonomies, more intelligent solutions are used to automatically add new content to these schemes and append the appropriate tags. Another option is to automatically integrate disparate metadata schemes and provide a single, unified view of the content with no manual overhead. In a DVD example, the metadata is optionally the subtitles or close caption text that goes along with the video being played back. Using both the video stream and the textual stream an even greater inference of metadata can be derived from the multimedia data. Thus using audio, video, and text simultaneously can improve the overall context and intelligence of the metadata.

Video analysis technology can automatically and seamlessly identify the scene changes within a video stream. These scene changes are ordered by time code and using similar pattern matching technology as described above all clips can be “understood”. The detected scene changes can also be used as ‘chapter points’ if the video stream is to be converted to more of a virtual DVD structure for use with time indexes. In addition by using advanced color and shape analysis algorithms it becomes possible to search the asset database for similar video clips, without relying on either metadata or human intervention. These outputs are completely synchronized with all other outputs to the millisecond on a frame-accurate basis. This means that the images are synchronized with the relevant sentences within an automatically generated transcript, the words spoken are synchronized with the relevant speaker, the audio transcript is synchronized with the appropriate scene changes etc. This unsurpassed level of synchronization enables users to simultaneously and inter-changeably navigate through large amounts of audio visual content by image, word, scene, speaker, offset etc., with no manual integration required to facilitate this. In accordance with an embodiment, the system can gather entities and without using metadata assemble a collection including video, audio and text entities.

Audio analysis technology can automatically and seamlessly identifies the changes in speakers along with the speech to text translations of the spoken words. The audio recognition may be speaker dependent or speaker independent technology. The audio analysis technology may also utilize the context of the previous words to improve the translations.

Referring now to FIG. 4, a block diagram is shown illustrating a system diagram of a collection and entity publishing and distribution system connected to the content management system of FIG. 3. Shown are a plurality of storage devices 400, a content distribution and publishing module 402, a content management system 404, a remote control 406, a plurality of input devices 408, a front panel input 410, system resources 412, a system init 414, a system timer 416, a front panel display module 418, and a plurality of presentation devices 420.

In the embodiment shown, the plurality of storage devices 400 includes a portable storage medium 422, local storage medium 424, network accessible storage 426 and a persistent memory 428. The portable storage medium 422 can include, for example, DVD's, CD's, floppy discs, zip drives, HD-DVD's, AOD's, Blu-Ray Discs, flash memory, memory sticks, digital cameras and video recorders. The local storage medium 424 can be any storage medium, for example, the local storage medium 424 can be a hard drive in a computer, a hard drive in a set-top box, RAM, ROM, and any other storage medium located at a display device. The network accessible storage 426 is any type of storage medium that is accessible over a network, such as, for example, a peer-to-peer network, the Internet, a LAN, a wireless LAN, a personal area network (PAN), or Universal Plug and Play (UPnP). All of these storage mediums are in the group of computer readable medium.

The persistent memory 428 is a non-volatile storage device used for storing user data, state information, access rights keys, etc. and in one embodiment does not store entities or collections. The user data can be on a per user basis if the system permits a differentiation of users or can group the information for all users together. In one embodiment the information may be high game scores, saved games, current game states or other attributes to be saved from one game session to another. In another embodiment with video or DVD playback entities the information may be bookmarks of where in the current video the user was last playing the content, what audio stream was selected, what layout or format the entity was being played along with. The storage information may also include any entity licenses, decryption keys, passwords, or other information required to access the collections or entities.

The persistent memory stores may include, but not limited to, Bookmarks, Game Scores, DRM & Keys, User preferences and settings, viewing history, and Experience Memory in Non-Volatile Ram (NVRam), which can be stored locally or on a server that can be accessed by the user or device.

The local storage can also act as a cache for networked content as well as archives currently saved by the user.

The content distribution and publishers module 402 determines what entities and collections are available and who they are available to. For example, the establishment (e.g., the owner) that supplies the content (e.g., entities and collections) may only let people who have paid for the content have access to it. The content management system 404 controls all of the content that is available and has access to all of the local and network accessible storage along with any portable or removable devices currently inserted, however, the content distribution and publishing module 402 will determine if the proper rights exist to actually allow this content to be used or read by others. In another example, on a peer-to-peer network only files that are in a shared folder will be available to people. In another embodiment a database or XML file contains the list of entities, collections, or content available for distributing or publishing along with the associated access rights for each entity, collection, or content. The content distribution publishing module 402 can also control what other people have access to depending upon the version (e.g., a “G” rating for a Child who wants information).

The content distribution and publishing module 402 enables people to share entities and collections. One example of entity sharing to create a new collection is for a group of parents whose children are on the same soccer team to be able to share content. All of the parents can be on a trusted peer-to-peer network. In this case the parents can set access rights on their files for other parents to use the entities (i.e. digital pictures, videos, games schedules, etc). With this model others can view a collection of the soccer season and automatically go out and get everyone else's entities and view them as a combined collection. Even though different parents may have different display equipment and may not be able to playback all of someone else's entities, the content manager can intelligently select and gracefully degrade the experience as needed to be displayed on the local presentation equipment.

The content management system 404 includes a system controller 430, a media subsystem 432, a content services module 434, and an entity decoder module 436. The system controller 430 includes a initiation module 440, a system manager 442, an arbitration manager 444 and an on screen display option module 446.

The media subsystem 432 includes a playback runtime engine 450, a rules manager 452, a state module 454, a status module 456, a user preference manager 458, a user passport module 460, a presentation layout manager 462, a graphics compositing module 464, and an audio/video render module 466.

The content services module 434 includes a content manager 470, a transaction and playback module 472, a content search engine 474, a content acquisition agent 476, an entity name service module 478, a network content publishing manager 480, an access rights manager 482, and a collection name service module 484.

The entity decoder module 436 includes a video decoder 486, an audio decoder 488, a text decoder 490, a web browser 492, an animation 494, a sensory module 496, a media filter 498, and a transcoder 499.

In one embodiment the content services module 434 can run in a Java-Virtual Machine (Java-VM) or within a scriptable language on a platform. The content services module 434 can be part of a PC platform and therefore exist within an executable or within a browser that is scriptable.

The Content Manager-

There may be various types of entities within a collection and the content manager 470 determines which version to playback based on rules and criteria. The rules or criteria can include: a Rating (e.g., G, PG, PG-13, R), a display device format (e.g., 16:9, 320×240 screen size), bit rates for transferring streaming content, and input devices available (e.g., it does not make sense to show interactive content that requires a mouse when only a TV remote control is available to the user).

As will be described below, the content manager 470 provides graceful degradation of the entities and the playback of the collection. The content manager 470 uses the collection name service module 484 to request new content for playback. The content manager 470 coordinates all of the rules and search criteria used to find new content. In one embodiment, the content manager utilizes rules and search criteria provided by the user through a series of hierarchical rankings of decision criteria to use. In another embodiment, the content manager uses rules such as the acquiring the new content at a lost cost where cost is, e.g., either money spent for the content or based on location that has the highest bandwidth and will take the shortest amount of time to acquire it. Alternatively, the search criteria is defined by the entity or collection meta data. Additionally, the content manager 470 is able to build up collections from various entities that meet the criteria as well. In one embodiment, the content manager 470 applies a fuzzy logic to determine which entities to include in a collection and how they are displayed on the screen as well as the playback order of the entities. The content manager 470 also delivers to the presentation layout manager 462 the information to display the entities on the screen and controls the positioning, layers, overlays, and overall output of the presentation layout manager 462.

The content manager 470 contains algorithms to determine the best-fit user experience based on the rules or user criteria provided to it. Unlike other similar systems the content manager 470 can provide a gracefully degraded user experience and handles errors such as incomplete content, smaller screen dimensions then the content was design for, or handling slower Internet connections for streaming content.

The content manager 470 uses system information and collection information to help determine the best playback options for the collection. For example, a collection may be made for a widescreen TV and the content manager 470 will arbitrate how to display the collection on a regular TV because that is the only TV available on the system. The fact that the system for display included a regular TV is part of the system information.

The content manager 470 has system information as to the capabilities (screen size etc) and also has the preferred presentation information in the collection metadata. Having these two pieces of info, the content manager 470 can make trade-offs and send the presentation layout manager 462 the results to setup a (gracefully) degraded presentation. This is accomplished by internal rules applied to a strongly correlated set of vocabularies for both the system capabilities and the collection metadata. The content manager 470 has internal rules as to how to optimize the content. The content manager 470 for instance can try to prevent errors in the system playback by correlating the system information with the collection metadata and possibly trying to modify the system or the collection to make sure the collection is gracefully degraded. Optionally, it can modify the content before playback. An example of decisions the content manager can make about acquiring a video stream is when the option for two different formats of an entity exist, such as in Windows Media Player format (WMV file) versus in a Quicktime format are found. The content manager may decide between the two streams based on the playback system having only a decoder for one of the formats. If both decoders are supported then the cost to purchase one format may be different from another and therefore the content manager can minimize the cost if there was not a specific format requirement. In this same example if one format is in widescreen (16:9) and another was full screen (4:3) then a decision can be based on if the presentation device is widescreen or full screen. Entities numbers may also be coded to assist in finding similar content to the original entity desired. In this way if there are different entity ID numbers for specific versions such as the directors cut verses the made for TV version of a movie then while the exact entity ID number may be different it may be catalog in such a way that only the last digit of the entity ID number is different to indicate the various of the original feature. This helps in finding similar content as well.

In another embodiment, the maximum cost willing to be paid for an entity can be known by the content manager as designated by the user or the preferences. The content manager can search locations that meet this cost criteria to purchase the entity. In addition the content manager can enter into an auction to bid for the entity without bidding above the maximum designated cost.

The content manager 470 does personalization through the use of agents and customization based on user criteria. It can add content searchability along with smart playback.

A collection is a definition of the presentation. It has both static data that defines unchanging things like title numbers and behavioral data that define the sequence of playback. Hence, this is one level of personalization (“I go out and find a collection that sounds like what I want to see”) and the next level is how the playback presentation is customized or personalized to the system and current settings. Searching for a collection that meets the personal entertainment desire is like using the GOOGLE search engine for the media experience. As GOOGLE provides a multiplicity of hits on a search argument, a request for a media experience (in the form a collection) can be sought and acquired with the distributed content management system.

Content Manager's Content Filter-

The content filter is used to provide both the content that the user desires as well as filter out the content that is undesirable. Along these guidelines when accessing network accessible content the content filter may contain: Lists of websites which will be blocked (known as “block lists”); Lists of websites which will be allowed (known as “allow lists”); and rules to block or allow access to websites. Based on the user's usage of various sites the content filter can “learn” which list new sites fall into to improve the content filtering. At another level with a website a content filter can further narrow down the designed material. In the case of a child user than the consideration of the content within a site such as chat rooms; The language used on the site; The nudity and sexual content of a site; The violence depicted on the site; Other content such as gambling, drugs and alcohol. The Platform for Internet Content Selection (PICS) specification enables labels (metadata) to be associated with Internet content. It was originally designed to help parents and teachers control what children access on the Internet, but it also facilitates other uses for labels, including code signing and privacy. The PICS platform is one on which other rating services and filtering software has been built. One method of implementation of PICS or similar metadata methods is to embed labels in HTML documents using a META tag. With this method, labels can be sent only with HTML documents, not with images, video, or anything else. It may also be cumbersome to insert the labels into every HTML document. Some browsers, notably Microsoft's Internet Explorer versions 3 and 4, will download the root document for your web server and look for a generic label there. For example, if no labels were embedded in the HTML for this web page (they are), Internet Explorer would look for a generic label embedded in the page at http://www.w3.org/ (generic labels can be found there).

The following is an example of a way to embed a PICS label in an HTML document:

```
<head>
  <META http-equiv=“PICS-Label” content=‘
  (PICS-1.1 “http://www.gcf.org/v2.5”
    labels on “1994.11.05T08:15-0500”
      until “1995.12.31T23:59-0000”
      for “http://w3.org/PICS/Overview.html”
    ratings (suds 0.5 density 0 color/hue 1))
  ’>
  </head>
```

The content associated with the above label is part of the HTML document. This is used for web-pages. The heading is one example of metadata for an HTML page. The metadata can be used for filtering out scenes that should not be viewed by children. This is but one example.

Regardless of what actions are taken, mechanisms are needed to label content or identify content of a particular type. For any system of labeling or classifying content, it is important to understand who is performing the classification and what criteria they are using. Classification may be done by content providers, third-party experts, local administrators (usually parents or teachers), survey or vote, or automated tools. Classification schemes may be designed to identify content that is “good for kids”, “bad for kids,” or both. It may also be classified on the basis of age suitability or on the basis of specific characteristics or elements of the content. In addition content that is deemed bad for kids can still be acquired but the actual entity will be cleaned up for presentation. This can be done by filtering out tagged parts of the movie that are above a designation age limit for example. Therefore, a movie seen in the theaters with a higher rating can have designations in it for parts not acceptable for a television viewing audience and the same entity can be used for presentation on both devices but the filtering of the parts is done to make the two versions. This increases the number of entities that can be used and also reduces the need to create two different entities but instead to create one entity that is annotated with markers or in the entities metadata as to the two different viewable formats.

The playback runtime (RT) engine 450 provides the timing and synchronization of the content that is provided by the content manager 470. The content manager 470 determines the overall collection composition and the playback runtime engine 450 controls the playback. The composition of the collection can be in the form of an XML file, a scripting language such as CGI, JVM Code, HTML/Javascript, SMIL, or any other technologies that can be used to control the playback of one or more entities at a time. One example of multiple-entity playback is a DVD-video entity being played back with an alternate audio track and with an alternate subtitle entity. In this manner the synchronization between the various entities is important to maintain the proper lip-sync timing.

The content manager 470 is capable of altering existing collections/entities for use with other entities. For example, DVD-Video has a navigational structure for the DVD. The navigational structure contains menus, various titles, PGCs, chapter, and the content is stitched together with predefined links between the various pieces. The content manager 470 has the ability (Assuming the metadata permits modification of an entity/collection) to do navigation command insertion & replacement to change the stitching (flow) of the content to create a new collection or to add additional entities as well. For example, this can be done by creating traps for the playback at various points of the entity. For example, in the case of DVD collection with entities, the time, title, PGC, or chapter, GPRM value, or a menu number can be used to trap and change the playback engines state machine to an alternate location or to an alternate entity.

In stitching together various entities a structure that uses time codes, such as the traps or DVD chapter breaks (parts of title or PTTS) can be used. The program or script (or behavioral metadata) can look like the following:

Play DVD Title 1 from 0:13:45 to 0:26:00 . . . then

Play local PVR file “XYZ.PVR” from 0:2:30 to 0:4:30 . . . then

Play DVD Title 1 Chapter 3

While playing this, overlay “IMAGE1.GIF” at 100,100 at alpha %25

Additionally, an event handler can be used during a presentation and react to clicks of buttons (say during the display of the image) and take an action, e.g., Pause and play a different video in a window. The set of instructions can reference the collection & entity metadata and will depend on these traps to break apart and re-stitch segments together to create a new presentation.

The set of instructions is behavioral metadata about the collection. The content manager uses it for playback and can modify it depending upon the system information as described above.

Collection Name Service (CNS)

Keywords go into the collection name service (CNS) module 484 and collections and entities are located that have these keywords. The entity name services (ENS) module 478 is able to locate entities for the new content acquisition agent 476.

The entity name services module 478 converts keywords to Entity IDs and then is able to locate the entity IDs by using the content search engine 474.

Distinguish keyword searches from collection ID searches and entity ID searches.

Entity Name Service (ENS)

One of the functions of the entity name services module 478 is mapping entities or collections to the associated metatag descriptions. In one implementation these metatag descriptions may be in XML files. In another implementation this information can be stored in a database. The Entity naming service 478 can use an identifier or an identifier engine to determine an identifier for a given entity. The identifier may vary based on the type of entity.

In one embodiment, the entity identifier is assigned and structured the way the Dewey Decimal System is for books in libraries. The principle of the entity IDs assignments is that entities have defined categories, well-developed hierarchies, and a network of relationships among topics. Basic classes can be organized by disciplines or fields of study. In the Dewey Decimal Classification (DDC) the ten main classes are Computers, information & general reference, Philosophy & psychology, Religion, Social Sciences, Language, Science, Technology, Arts & recreation, Literature, History & geography. Then each class can be divided into 10 divisions and then each of the 10 divisions has 10 sections and so on. Near the bottom of the divisions can include different formats, different variations such as made for TV (Parts removed for viewable by families) versus and original on screen versions versus the directories cut extended version. This will aid the search engines in finding similar content requested by the user. Just as books in a library are arranged under subjects, which means that a book in similar fields is physically close to each other on the shelf, so are the Entity IDs. If a book is found that meets a certain criteria, nearby books can be browsed to find many related subject matter. Since features in an index tree are organized based on their similarity and an index tree has a hierarchical structure, we can use this structure to guide user's browsing by restricting the selection to certain levels. The structure can also be used to eliminate branches from further selection if these branches are not direct descendants of the current selection. Parts of entities can also be grouped together as well. So not just the entity may have an id but a smaller segment of an entity may be indexed further in this system as well. Taxonomy also refers to either a hierarchical classification of things, or the principles underlying the classification. Almost anything—animate objects, inanimate objects, places, and events—may be classified according to some taxonomic scheme. Mathematically, a taxonomy is a tree structure of classifications for a given set of objects. At the top of this structure is a single classification—the root node—that applies to all objects. Nodes below this root are more specific classifications that apply to subsets of the total set of classified objects.

A version control system of entities can also be utilized. If an updated version of an entity is created, for example in a screenplay a spelling correction is made, then the version should be updated and then released. The content manager 1570 may find multiple versions of an entity and then can try and get a newer version or if one is not available go and retrieve a previous version to provide content for the request. The version information is part of the entity or collection metadata.

Media Identifiers

In one embodiment, an entity may be identified through the use of a media identifier (MediaID). The media identifier may be computed based on the contents of the entity to create a unique ID for that entity. The unique ID will be referred to as an entity ID. The unique identifier can be used to match an entity's identifier and then it's associated metadata to the actual entity if they are in separate sources. Various permutations of media IDs or Serialization may be employed including, but not limited to a watermark, hologram, and any other type in substitution or combination with the Burst Cut Area (BCA) information without diverging from the spirit of the claimed invention. Other technologies can be used for entity identification as well such as an RFID. An RFID may be used in replacement of the unique identifier or to correlate with the unique identifier for a database lookup. As RFID technology is beginning to be employed for packaged goods, a packaged media can be considered a Collection and be identified by this RFID. These same technologies can also be used to store all of the entity metadata as well.

In one embodiment, a three step process can be utilized. First, a media ID is computed for the given Entity. Second, to find the corresponding entity ID the Media ID can be submitted to a separate centralized server, entity naming service, local server, database or local location or file, to be looked up and retrieved. The final step is with the Entity ID the corresponding Metadata can be found through a similar operation to a separate centralized server, entity service, local server, database, or local location or file, to be looked up and retrieved. When new entities are created they go though a similar process where the Media ID, Entity, ID and corresponding metadata are submitted to the respective locations for tracking the entities for future use and lookup. This process can be condensed into several variations where the media ID is the same as the entity ID or the two are interchangeable and the lookups can be in a different order. In this case the media ID can be used to lookup the associated metadata as well or both the media ID and entity ID can be used find the metadata. The metadata may also contain references, filepaths, hyperlinks, etc. back to the original entity such that for a given entity ID or media ID the entity can be found through the locator. Again this can be through a separate centralized server, entity service, local server, database, or local location or file.

Watermarking

Digital video data can be copied repeatedly without loss of quality. Therefore, copyright protection of video data is a more important issue in digital video delivery networks than it was with analog TV broadcast. One method of copyright protection is the addition of a “watermark” to the video signal which carries information about sender and receiver of the delivered video. Therefore, watermarking enables identification and tracing of different copies of video data. Applications are video distribution over the World-Wide Web (WWW), pay-per-view video broadcast, or labeling of video discs and video tapes. In the mentioned applications, the video data is usually stored in compressed format. Thus, the watermark is embedded in the compressed domain.

Holograms

MPEG-7 addresses many different applications in many different environments, which means that it needs to provide a flexible and extensible framework for describing audiovisual data. Therefore, MPEG-7 does not define a monolithic system for content description but rather a set of methods and tools for the different viewpoints of the description of audiovisual content. Having this in mind, MPEG-7 is designed to take into account all the viewpoints under consideration by other leading standards such as, among others, TV Anytime, Dublin Core, SMPTE Metadata Dictionary, METS and EBU P/Meta. These standardization activities are focused to more specific applications or application domains, whilst MPEG-7 has been developed as generic as possible. MPEG-7 uses also XML as the language of choice for the textual representation of content description, as XML Schema has been the base for the DDL (Description Definition Language) that is used for the syntactic definition of MPEG-7 Description Tools and for allowing extensibility of Description Tools (either new MPEG-7 ones or application specific). Considering the popularity of XML, usage of it will facilitate interoperability with other metadata standards in the future.

Content Search Engine

The content search engine 474 searches various levels for content, for example, local storage, removable storage, trusted peer network, and general Internet access. Many different types of searching and search engines may be used.

There are at least three elements to search engines that can be important for helping people to find entities and create new collections: information discovery & the database, the user search, and the presentation and ranking of results.

Crawling search engines are those that use automated programs, often referred to as “spiders” or “crawlers”, to gather information from the Internet. Most crawling search engines consist of five main parts:

Crawler: a specialized automated program that follows links found on web pages, and directs the spider by finding new sites for it to visit;

Spider: an automatic browser-like program that downloads documents found on the web by the crawler;

Indexer: a program that “reads” the pages that are downloaded by spiders. This does most of the work deciding what your site is about;

Database (the “index”): simply storage of the pages downloaded and processed; and

Results engine: generates search results out of the database, according to your query.

There can be some minor variations to this. For instance, ASK JEEVES (www.ask.co.uk) uses a “natural language query processor”, which allows you to enter a question in plain language. The query processor then analyses your question, decides what you mean, and “translates” that into a query that the results engine will understand. This happens very quickly, and out of sight of users of ASK JEEVES, so it seems as though the computer is able to understand English.

Spiders and crawlers are often referred to as “robots”, especially in official documents like the robots exclusion standard

Crawler:

When a spider downloads pages, it is on the lookout for links. They are easy for it to spot, because they always look the same. The crawler then decides where the spider should go next, based on the links, and its existing list of URLs. Often, any new links it finds when revisiting a site are added to its list. When a URL is added to a Search Engine, it is the crawler that is being requested to visit the site.

Spider:

A spider is an automated program that downloads the documents that the crawler sends it to. It works very much as a browser does when it connects to a website and downloads pages. Most spiders aren't interested in images though, and don't ask for them to be sent. You can see what the spiders see by going to a web page, clicking the right-hand button on your mouse, then selecting “view source” in the menu that appears.

Indexer:

This is the part of the system that-decides what a page is about. The indexer reads the words in the web site. Some are thrown away, as they are so common (and, it, the etc). The indexer will also examine the HTML code which makes up a site looking for other clues as to which words are considered to be important. Words in bold, italic or headers tags will be given more weight. This is also where the metadata the keywords and description tags) for a site will be analyzed.

Database:

The database is where the information gathered by the indexer is stored. GOOGLE claims the to have the largest database, with over 3 billion documents, even assuming that the average size of each document is only a few tens of kilobytes, this can easily run to many terabytes of data (1 terabyte=1,000 gigabytes=1 million megabytes), which will obviously require vast amounts of storage.

Results engine:

The results engine is in many ways the most important part of any search engine. The results engine is the customer-facing portion of a search engine, and as such is the focus of most optimization efforts. It is the results engine's function to return the pages most relevant to a users query.

When a user types in a keyword or phrase, the results engine decides which pages are most likely to be useful to the user. The method it uses to decide that is called its algorithm. Search engine optimization (SEO) experts discuss “algos” and “breaking the algo” for a particular search engine. This is because if you know what the criteria being used (the algorithm) a web page can be developed to take advantage of the algorithm.

The search engine markets, and the search engines themselves, have undergone huge changes recently, partially due to advances in technology, and partially due to the evolving economic circumstances in the technology sector. However, most are still using a mixture of the following criteria, with different search engines giving more or less weight to the following various criteria:

Title: Is the keyword found in the title tag?;

Domain/URL: Is the keyword found in the address of the document?;

Page text: Is the keyword being emphasized in some way, such as being made bold or italic? How close to the top of the text does it appear?;

Keyword (search term) density: How many times does the keyword occur in the text? The ratio of keywords to the total number of words is called keyword density. Whilst having a high ratio indicates that a word is important, repeating a word or phrase many times, solely to improve your standing with the search engines is frowned on, as it is considered an attempt to fraudulently manipulate the results pages. This often leads to penalties, including a ban in extreme cases;

Meta information: These tags (keywords and description) are hidden in the head of the page, and not visible on the page while browsing. Due to a long history of abuse, meta information is no longer as important as it used to be. Indeed, some search engines completely ignore the keywords tag. However, many search engines do still index this information, and it is usually worth including;

Outbound links: Where do the links from the page go to, and what words are used to describe the linked-to page;

Inbound links: Where do the links from the page come from, and what words are used to describe your page? This is what is meant by “off the page” criteria, because the links are not under the direct control of the page author; and

Intrasite links: How are the pages in your site linked together? A page that is pointed to by many other pages is more likely to be important. These links are not usually as valuable as links from outside your site, as you control them, so more potential for abuse exists.

As stated above, there are some minor variations as each search engine has its own approach, and its own technology, but they have more similarities than differences. Additionally, that this applies only to crawling search engines that use automated programs to gather information. Directories such as Yahoo! or the Open Directory Project work on a completely different principle, as they are human reviewed.

In accordance with the present invention, once the metadata is present or inferred (as described above with reference to FIG. 3) it can be searched and utilized. Keyword or metadata searches can consist of various levels of complexity and have different shortcomings associated with each. In the “no context” method a user enters a keyword or term into a search box, for example “penguin”. The search engine then searches for any entities containing the word “penguin.” The fundamental problem is that the search engine is simply looking for that word, regardless of how it is used or the context in which the user requires the information, i.e., is the user looking for a penguin bird, a publisher or a chocolate-brand? Moreover, this approach requires the relevant word to be present and for the content to have been tagged with the word. Any new subjects, names or events will not be present and the system.

Manual keyword searches do nothing more complex than look for the occurrence of the searched word or term. These processes require a significant amount of hardware resources, which increase systems overheads. In addition keyword search systems require a significant amount of manual intervention so that words and the relationship between similar words can be identified. (Penguin=flightless birds=fish eating birds).

With no dynamic intelligence, keyword search engines cannot learn through use, nor do they have any understanding of queries on specific words. For example when the word “penguin” is entered, keyword search engines cannot learn that the penguin is a flightless black and white bird that eats fish.

Significant user refinement is required to boost accuracy. Keyword search engines rely heavily on the expertise of the end user to create queries in such a way that the results are most accurate. This requires complex and specific Boolean syntaxes, which the ordinary end-user would not be able to complete, e.g., to get an accurate result for penguins, an end user would have to enter the query as follows: “Penguin AND (NOT (Chocolate OR Clothing OR Publishing) AND Bird.

In accordance with one embodiment, a more complex matching technology avoids these problems by matching concepts instead of simple keywords. The search takes into account the context in which the search terms appear, thus excluding many inaccurate hits while including assets that may not necessarily contain the keywords, but do contain their concept. This also allows for new words or phrases to be immediately identified and matched with similar ones, based upon the common ideas they contain as opposed to being constrained by the presence or absence of an individual word; this equally applies to misspelled words. In addition to the concept matching technology, the search criteria may accept standard Boolean text queries or any combination of Boolean or concept queries.

Additionally, a searching algorithm can be used that has a cost associated with where content is received from. This will be described further with reference to FIG. 27.

Transaction and Playback History (Logging)-

The transition and playback module 472 uses the local storage facilities to collect and maintain information about access rights transactions and the acquisition of content (in the form of collections and entities). Additionally, this component tracks the history of playback experiences (presentations of content). In one embodiment the history is built by tracking each individual user (denoted by a secure identifier through a login process) and their playback of content from any and all sources. The transactions performed by the individual user are logged and associated with the user thereby establishing the content rights of that user. In another embodiment the history of playback is associated with the specific collection of content entities that were played back. Additionally, all transactions related to the collection of content entities (acquisition, access rights, usage counters, etc) are logged. These may be logged in the dynamic metadata of the collection, thus preserving a history of use.

New Content Acquisition Agent (NCAA)—the new content acquisition agent 476 acts as a broker on behalf of a specific user to acquire new content collections and the associated access rights for those collections. This can involve an e-commerce transaction. The content acquisition agent 472 uses the content search engine 474 and a content filter to locate and identify the content collection desired and negotiate the access rights through the access rights manager 482. In one embodiment, the content filter is not part of the playback engine 450 but instead part of the content manager 470 and the new content acquisition agent 476. The new content acquisition agent uses the metadata associated with the entities in helping with acquisition.

Access Rights Manager—The access rights manager 482 acts as a file system protection system and protects entities and collections from being accessed by different users or even from being published or distributed. This insures the security of the entities and collections is maintained. The access rights may be different for individual parts of an entity or a collection or for the entire entity or collection. An example of this is a movie that has some adult scenes. The adult scenes may have different access rights then the rest of the movie. In one embodiment, the access rights manager 482 contains digital rights management (DRM) technology for files obtained over a network accessible storage device. In most instances, DRM is a system that encrypts digital media content and limits access to only those people who have acquired a proper license to play the content. That is, DRM is a technology that enables the secure distribution, promotion, and sale of digital media content on the Internet. The rights to a file may be for a given period of time. This right specifies the length of time (in hours) a license is valid after the first time the license is stored on the consumer's device. For example, the owner of content can set a license to expire 72 hours after it is stored. Additionally, the rights to a file may be for a given number of usage counts. For example, each time the file is accessed the allowed usage count is decremented and when a reference count is zero the file is no longer usable. The rights to a file may also limit redistribution or transferring to a portable device. This right specifies whether the user can transfer the content from the device to a portable device for playback. A related right specifies how many times the user can transfer the content to such portable devices. The access rights manager 482 may be required to obtain or validate licenses for entities before allowing playback each time or may internally track the licenses expiration and usage constraints.

In another embodiment by owning a particular set of entities or collections, the ownership can allow access rights to additional entities or collections. An example of this is if a user owns a DVD disc then they can gain access to additional features on-line.

A trusted establishment can charge customers for entities. This allows for a user-billing model for paying for content. This can be, e.g., on a per use basis or a purchase for unlimited usages.

The access rights manager can also register new content. For example, content registration can be used for new discs or newly downloaded content.

The access rights manager 482 may use DRM to play a file or the access rights manager 482 may have to get rights to the file to even read it in the first place like a hard disc rights. For streaming files, the rights to the contents must first be established before downloading the content.

Network Content Publishing Manager—The network content publishing manager 480 provides the publishing service to individual users wishing to publish their own collections or entities. The network content publishing manager 480 negotiates with the new content acquisition agent 482 to acquire the collection, ensuring that all the associated access rights are procured as well. The user can then provide unique dynamic metadata extensions or replacements to publish their unique playback presentation of the specific collection. One embodiment is as simple as a personal home video being published for sharing with family where the individual creates all the metadata. Another embodiment is a very specific scene medley of a recorded TV show where the behavioral metadata defines the specific scenes that the user wishes to publish and share with friends.

In one embodiment the Publishing Manager may consist of a service that listens to a particular network port on the device that is connected to the network. Requests to this network port can retrieve an XML file that contains the published entities and collections and the associated Metadata. This function is similar to the Simple Object Access Protocol (SOAP). SOAP combines the proven Web technology of HTTP with the flexibility and extensibility of XML. SOAP is based on a request/response system and supports interoperation between COM, CORBA, Perl, Tcl, the Java-language, C, Python, or PHP programs running anywhere on the Internet. SOAP is designed more for the interoperability across platforms but using the same principles it can be extended to expose and publish available entity and collection resources. A system of this nature allows peer-to-peer interoperability of exchanging entities. Content Acquisition agents can search a defined set of host machines to search for available entities. In another embodiment the Publishing manager is a service that accepts search requests and returns the search results back as the response. In this system the agents contact the publishing manager which searches its entities and collections and returns the results in a given format (i.e. xml, text, hyperlinks to the given entities found, etc.). In this model the search is distributed among the peer server or client computers and a large centralized location is not required. The search can be further expanded or reduced based on the requesters access rights to content which is something a public search engine (such as YAHOO or GOOGLE) cannot offer today. In another embodiment the Content Directory Service in UPnP Devices can be used by the Publishing Manager. The Content Directory Service additionally provides a lookup/storage service that allows clients (e.g. UI devices) to locate (and possibly store) individual objects (e.g. songs, movies, pictures, etc) that the (server) device is capable of providing. For example, this service can be used to enumerate a list of songs stored on an MP3 player, a list of still-images comprising various slide-shows, a list of movies stored in a DVDJukebox, a list of TV shows currently being broadcast (a.k.a an EPG), a list of songs stored in a CDjukebox, a list of programs stored on a PVR (Personal Video Recorder) device, etc. Nearly any type of content can be enumerated via this Content Directory service. For those devices that contain multiple types of content (e.g. MP3, MPEG2, JPEG, etc), a single instance of the Content Directory Service can be used to enumerate all objects, regardless of their type. In addition the services allow search capabilities. This action allows the caller to search the content directory for objects that match some search criteria. The search criteria are specified as a query string operating on properties with comparison and logical operators.

Media Subsystem

The playback runtime engine 450 is responsible for maintaining the synchronization, timing, ordering and transitions of the various entities. The playback runtime engine 450 will process any scripts (e.g., behavioral metadata) of the collections and has the overall control of the entities. The playback runtime engine 450 accepts user input to provide the various playback functions including but not limited to, play, fast-forward, rewind, pause, stop, slow, skip forward, skip backward, and eject. The synchronization can be done using events and an event manager, such as described herein with reference to FIG. 11. The playback runtime engine can be implemented as a state machine, a virtual machine, or even within a browser. It may be hard coded for specific functions in a system with fixed input devices and functionality or programmable using various object oriented languages to scripting languages. There are numerous markup languages that can be used in this system as well. A web browser may support various markup languages including, but not limited to, HTML, XHTML, MSHTML, MHP, etc. While HTML may be referenced throughout this document it is be replaced by any markup language or alternative meta-language or script language to have the same functionality in different embodiments. In addition the presentation device may be a presentation rendering engine that supports virtual machines, scripts, or executable code, for example, Java, Java Virtual Machine (JVM), MHP, PHP, or some other equivalent engine.

The Presentation Layout Manager

The presentation layout manager 462 determines the effect of the input devices 408. For example, when multiple windows are on the screen the position of the cursor is as important as to which window will receive the input devices action. The system controller 430 provides on-screen menus or simply processes commands from the input devices to control the playback and content processing of the system. As the system controller 430 presents these on-screen menus, it also requests context-sensitive overlaid menus from a menu generator based upon metadata so that these menus provide more personalized information and choices to the user. This feature will be discussed below in greater detail with reference to FIG. 11. In addition the system controller 430 manages other system resources, such as timers, and interfaces to other processors. The presentation layout manager not only controls the positioning of the various input sources but also can control the layering and blending/transparency of the various layers.

DVD Navigation Command Insertion & Replacement

The DVD navigational structure can be controlled by commands that are similar to machine assembler language directives such as: Flow control (GOTO, LINK, JUMP, etc.); Register data operations (LOAD, MOVE, SWAP, etc.); Logical operations (AND, OR, XOR, etc.); Math operations (ADD, SUB, MULT, DIV, MOD, RAND, etc.); and Comparison operations (EQ, NE, GT, GTE, LT, LTE, etc.).

These commands are authored into the DVD-Video as pre, post and cell commands in program chains (PGCs). Each PGC can optionally begin with a set of pre-commands, followed by cells which can each have one optional command, followed by an optional set of post-commands. In total, a PGC cannot have more than 128 commands. The commands are stored in the IFO file at the beginning and can be referenced by number and can be reused. Cell commands are executed after the cell is presented.

Normally in an InterActual title, any Annex J directives like a TitlePlay(8) which tells the navigator to jump to title #8, or AudioStream(3) which tells the navigator to set the audio stream to #3, are sent after these embedded navigation commands have been loaded from the IFO file for the Navigator to reference and executed in addition to the navigation command processing.

In one embodiment the present invention can insert new navigation commands or replace existing navigation commands in the embedded video stream. This is done by altering the IFO file. The commands are at a lower level of functionality than the Annex J commands that are executed via JavaScript. The IFO file has all the navigation information and it is hard coded. For graceful degradation we intercept the IFO file and intelligently modify it.

In one embodiment, the playback runtime engine 1550 executes the replacement or insertion action. One way is for the playback runtime engine 450 to replace the navigation commands in the IFO file before it is loaded and processed by the DVD Navigator by using an interim staging area (DRAM or L2 cache of file system) or intercepting the file system directives upon an IFO load. Alternatively, the playback runtime engine 450 can replace the navigation commands in the system memory of the DVD Navigator after they have been loaded from the IFO file.

The former allows one methodology for many systems/navigators where the management of the file system memory is managed by the media services code. The latter requires new interfaces to the DVD Navigator allowing the table containing the navigation commands (located within the Navigator's working memory) to be patched or replaced/inserted somewhat like a program that patches assembler code in the field in computers (this was a common practice for delivering fixes to code in the field by editing hexadecimal data in the object files of the software and forcing it to be reloaded).

Case I—Browser modifies the Commands individually

This case is one where the specific navigation commands are modified by a JavaScript command. In this case, the command is constructed in the following fashion:

SetNavCmd(title, PGCNumber, newCmdString, locationOffset);

where, for the specified title (e.g. as specified by “t” in VTS_{—}0t_{—}0), the newCmdString is the hexadecimal command string, and the locationOffset is the hexadecimal offset in the PGC command table for PGC referenced in the PGCNumber (e.g. as specified by “n” here: VTS_PGC_n).

Case II—Media Subsystem Modifies the Command Table

This case is where the media subsystem acquires the full set of modifications to the navigation command table and applies it like a software patch. The method of acquiring it can be:

1. By locating it on a specific ROM directory (this enables the DVD-Video to be burned without re-authoring it by simply placing the “patch” on the ROM).

2. By receiving it from the server after a disc identification exchange that occurs during the startup process. This is where the web server provides it to media services upon verifying the DVD-Video disc (title).

3. By receiving it via a JavaScript command, but as an entire command table, such as ApplyNavCmdTable(title, PGCNumber, newCmdTable);

Additionally, for the above Case 1 command in the media subsystem (exposed to JavaScript) can be employed to modify individual navigation commands by the media services.

Referring to FIG. 5 a diagram is shown illustrating a media player according to one embodiment. Shown are a media storage device 500, a media player 502, an output 504, a presentation device 506, a browser 508, an ITX API 510, a media services module 512, and a decoder module 514.

The ITX API 510 is a programming interface allowing a JavaScript/HTML application to control the playback of DVD video creating new interactive applications which are distinctly different from watching the feature movie in a linear fashion. The JavaScript is interpreted line-by-line and each ITX instruction is sent to the media subsystem in pseudo real-time. This can create certain timing issues and system latency that adversely affect the media playback. One example of the programming interface is discussed in greater detail with reference to FIGS. 6 AND 7.

Referring to FIG. 6 a diagram is shown illustrating a media player according to another embodiment. Shown is a media storage device 600, a media player 602, an output 604, a presentation device 606, an on screen display 608, a media services module 610, a content services module 612 a behavioral metadata component 614 and a decoder module 616.

The media player 602 includes the on screen display 608, the media services module 610 and the decoder module 616. The media services module 610 includes the content services module 612 and the behavioral metadata component 614.

The media services module 610 controls the presentation of playback in a declarative fashion that can be fully prepared before playback of an entity or collection. This process involves queuing up files in a playlist for playback on the media player 602 through various entity decoders. Collection metadata is used by the content manager (shown in FIG. 4) to create the playlist and the content manager will also manage the sequencing when multiple entity decoders are required. In one example, the media services module 610 gathers (i.e., locates in a local memory or download from remote content source if not locally stored) the necessary entities for a requested collection and fully prepares the collection for playback based upon, e.g., the system requirements (i.e., capabilities) the properties of the collection (defined by the entity metadata). An example of the media service module 610 fully preparing the collection for playback is described below with reference to the W3C SMIL timing model. The W3C standard can be found at http://www.w3.org/TR/smil20/smil-timing.html, which is incorporated herein by reference in its entirety.

SMIL Timing defines elements and attributes to coordinate and synchronize the presentation of media over time. The term media covers a broad range, including discrete media types such as still images, text, and vector graphics, as well as continuous media types that are intrinsically time-based, such as video, audio and animation.

Three synchronization elements support common timing use-cases:

The <seq> element plays the child elements one after another in a sequence.

The <excl> element plays one child at a time, but does not impose any order.

The <par> element plays child elements as a group (allowing “parallel” playback).

These elements are referred to as time containers. They group their contained children together into coordinated timelines. SMIL Timing also provides attributes that can be used to specify an element's timing behavior. Elements have a begin, and a simple duration. The begin can be specified in various ways—for example, an element can begin at a given time, or based upon when another element begins, or when some event (such as a mouse click) happens. The simple duration defines the basic presentation duration of an element. Elements can be defined to repeat the simple duration, a number of times or for an amount of time. The simple duration and any effects of repeat are combined to define the active duration. When an element's active duration has ended, the element can either be removed from the presentation or frozen (held in its final state), e.g. to fill any gaps in the presentation.

An element becomes active when it begins its active duration, and becomes inactive when it ends its active duration. Within the active duration, the element is active, and outside the active duration, the element is inactive.

In another example, a timeline is constructed from behavioral metadata which is used by the playback engine. The behavioral metadata attaches entities to the timeline and then, using the timeline like a macro of media service commands, executes them to generate the presentation.

A full set of declarations can be given to the media subsystem such that media playback can be setup completely before the start of playback. This allows for a simpler authoring metaphor and also for a more reliable playback experience compared to the system shown in FIG. 5. The actions associated with each declaration can be a subset (with some possible additions) of the ITX commands provided to JavaScript. In JavaScript, Methods are actions applied to particular objects, that is, things that they can do. For example, document.open(index.htm) or document.write(“text here”), where open( ) and write( ) are methods and document is an object. Events associate an object with an action. JavaScript uses commands called event handlers to program events. Event handlers place the string “on” before the event. For example, the onMouseover event handler allows the page user to change an image, and the onSubmit event handler can send a form. Page user actions typically trigger events. For example onClick=“javascript:formHandler( )” calls a JavaScript function when the user clicks a button or other element. Functions are statements that perform tasks. JavaScript has built-in functions and you can write your own. A function is a series of commands that will perform a task or calculate a value. Every function must be named. Functions can specify parameters, the values and commands that run when the function is used. A written function can serve to repeat the same task by calling up the function rather that rewriting the code for each instance of use. A pair of curly brackets {} surrounds all statements in a function. Additionally, the on-screen display, in one example can be a browser such as described with reference to FIG. 5.

Referring to FIG. 7 a diagram is shown illustrating an application programming system in accordance with one embodiment.

Shown are an embedded web browser 700, a command handler (with command API) 702, a properties handler (with properties API) 704, an event generator (with event API) 706, a cookie manager (with cookie API) 708, an identifier engine 710, an initialization module 712, a navigator state module 714, a bookmark manager 716, a system resources 920, a system timer 722, a system monitor 724, a system initialization 726 a DVD/CD navigator 728, a user remote control 730, a front panel display module 732, a CD decoder 734, a DVD decoder 735, an I/O controller 736, a plurality of disks 738, a HTML/JavaScript content 740, and an InterActual API 742.

The embedded web browser 700 is coupled to the command handler (which has an associated command API) 702 as shown by a bi-directional arrow. The embedded web browser 700 is coupled separately to the properties handler (which has an associated properties API) 704, the event generator (which has an associated event API) 706, and the cookie manager (which has an associated cookie API) 708, all three connections shown by an arrow pointing towards the embedded web browser 700.

The command handler 702 is coupled to the bookmark manager 716 shown by a bi-directional arrow. The command handler 702 is coupled to the DVD/CD navigator 728 shown by a bi-directional arrow. The command handler 702 is coupled to the navigator state module 714 shown by a bi-directional arrow. The command handler 702 is coupled to the system resources 720 by an arrow pointing to the system resources 720.

The properties handler 704 is coupled separately to the bookmark manager 716 and the identifier engine 710, both shown by an arrow pointing to the properties handler 704. The properties handler 704 is coupled the event generator 706 by a bi-directional arrow.

The event generator 706 is coupled to the navigator state module 714 shown by a bi-directional arrow. The event generator 76 is coupled to the system timer 722 shown by an arrow pointing to the event generator 706. The event generator 706 is coupled to the cookie manager 708 by an arrow pointing to the cookie manager 708.

The cookie manager 708 is coupled to the identifier engine 710 shown by a bi-directional arrow.

The identifier engine 710 is coupled to the I/O controller 736 by an arrow pointing towards the identifier engine 710 and to the navigator state module 714 by a bi-directional arrow.

The initialization module 712 is coupled to the system initialization 726 by an arrow pointing towards the initialization module 712. The initialization module 712 is coupled to the navigator state module 714 by an arrow pointing to the navigator state module 714.

The navigator state module 714 is also coupled separately to the bookmark manager 716 and the DVD/CD navigator 722 by bi-directional arrows.

The DVD/CD navigator 728 is coupled to the user remote control 730 by an arrow pointing to the DVD/CD navigator 728. The DVD/CD navigator 728 is coupled to the front panel display module 732 by an arrow pointing to the front panel display module 732. The DVD/CD navigator 722 is coupled to the DVD decoder 726 by a bi-directional arrow.

The I/O controller 736 is coupled separately to both the DVD decoder 735 and the CD decoder 734 by arrows pointing away from the I/O controller 736. The I/O controller 736 is coupled to the disk 738 by an arrow pointing to the disk 738.

The disk 738 is coupled to the HTML/JavaScript content 740 by an arrow pointing to the HTML/JavaScript content 740.

The HTML/JavaScript content 740 is coupled to the application programming interface (API) 742 by an arrow pointing to the application programming interface (API) 742.

In operation, the embedded web browser 700 receives HTML/JavaScript content from the disk 738 which is displayed by presentation engine within the embedded web browser 700. The embedded web browser 700 originates commands as a result of user interaction which can be via the remote control (shown in FIG. 30) in set-top systems, the keyboard or mouse in computing systems, the game interface (e.g., joystick, PLAYSTATION controller) in gaming systems, etc., which are sent to the command handler 702 by way of the command API. The embedded web browser 700 also receives commands from the command handler 702 by way of the command API. An example of such a command is InterActual.FullScreen(w). The embedded web browser 700 also receives cookies from the cookie manager 708 via the cookie API, generally in response to the accessing of an Internet website. The embedded web browser 700 also receives events (notifications) each of which is a notification that a respective defined event (generally related to media playback) has occurred. These events are generated by the event generator 706 and sent via the event API. The embedded web browser 700 also queries properties from the properties handler 704 via the properties API. Properties are received in response to inquiries generated by the embedded web browser 700.

The command handler 702 controls the DVD/CD navigator 728 including starting and stopping playback, changing audio streams, and displaying sub-pictures from JavaScript, among many things. The command handler 702 provides live web content for non-Interactive disks when an active Internet connection is present, determined by checking the InternetStatus property, or by initiating a connection through such commands as InterActual.NetConnect( ) and InterActual.NetDisconnect( ). In one example, if a connection is available, the command handler can pass to a content server the content ID, Entity ID, or Collection ID and the server can return additional content to be used during playback. In another embodiment a web-address for the updated content is included on the disc in the form of a URL. Alternatively, the server is specified by the user for which the software should look for updated content. In yet another embodiment, the server and the interface or URL that is queried for the additional content may be predetermined or preconfigured into the player. In still another embodiment, updated content is searched for across the web according to the Entity or Collection Meta Data as described such as described below with reference to FIG. 27.

The command handler 702 commands the bookmark manager 716 through such commands as InterActual.GotoBookmark( ) and InterActual.SaveBookmark( ). The command handler 702 also interacts with the navigator state module 714 generally regarding user interaction. The Navigator state module 714 keeps the current state of the system and receives it directly from the decoder (or maps directly into it). When the bookmark manager 716 saves a bookmark and needs to know the current title, the bookmark manager 716 receives it from the navigator state module 714 and places it in a bookmark and returns it to the command handler to allow it to provide a return value to the InterActual.SaveBookmark command.

The properties handler 704 provides the embedded web browser 700 with the ability to interrogate the navigator state module 714 for the DVD/CD navigator 728 state which includes the properties (also referred to as attributes) of the elapsed time of the current title, the disk type, and the disk region, among others. This is accomplished by providing the browser a handle to the memory offset where the navigator state module stores the current media attributes thereby allowing the browser to directly read it. The properties handler 704 maintains knowledge of system attributes. The Event Generator monitors these attributes and triggers and event when one is changed.

The event generator 706 receives notification from the DVD/CD navigator 728 of events such as a change of title or chapter with web content (based on DVD time codes and the system time from the system timer 722. The event generator 706 notifies the properties handler 704 of event triggers which are of interest to the properties handler 704. The event generator 706 also provides events to the cookie manager 708 such as relate to the accessing of web pages, disk insertion, and disk ejection events. The event mechanism used for the scripting and synchronizing is the event generator 706 of the Media Services system. The event generator 706 generates media events when instructed by a media navigator such as media title change or media PTT (Part of Title, which is also referred to as a Chapter) change. The media events in turn cause a user interface (e.g., a web-browser) to receive an event, such as a Document Object Model (DOM) event (also referred to as a JavaScript event) for the AV object. In one embodiment, the AV object is an Active X control on a web-page, i.e., the component of software that does the work to display the video within a web-page. Thus, the web-browser is able to handle the media events, for example, in the same way the keyboard or mouse generate mouse events in web browsers. By way of example, a JavaScript event handler registers interest in the class of event occurring (such as a PTT event) and the JavaScript code, upon invocation, changes the presentation and/or layout. For example, in one embodiment, HTML text is changed in the presentation when a PTT change occurs as in the case where the HTML text is the screenplay for the actors and changes as scene boundaries which correlate to the PTT boundaries. Another example is when user operations (UOP) change in the media navigator, for instance Fast-Forward is not allowed, and a JavaScript event handler modifies the presentation by making an arrow-shaped button grayed out based upon this change.

The cookie manager 708 interacts with the identifier engine 710 to provide the ability to save information regarding the disk, platform, current user, and the application programming interface (API) version in local storage. This is enabled by the identifier engine maintaining this disc-related information and passing memory pointers to it when the cookie manager requests them.

The identifier engine 710 provides an algorithm to generate a unique identifier for the media which enables the DVD ROM content (HTML and JavaScript from the disk) to carry out platform validation to ensure a certified device is present. The identifier engine 710 provides the ability to serialize each disk by reading and processing the information coded in the burst cut area (BCA) of the disk. The BCA is read by the identifier engine 710 and stored in the navigator state module 714. The BCA is read from the disc by the DVD-ROM Drive firmware and accessed by the controlling program through the drives ATAPI IDE interface. The Multimedia Command Set (MMC) and Mt. Fuji specifications provide the standardized commands used to interface with the DVD-ROM Drives firmware to read out the BCA value similar to how a SCSI drive is controlled. Hence commands such as InterActual.GetBCAField( ) can get the BCA information from the navigator state module 714 after insertion of a disc. This BCA information provides the ability to uniquely identify each disk by serial number. Conditional access to content, usage tracking, and other marketing techniques are implemented thereby. The identifier engine 710 gets the BCA information for the serial identifier (SerialID), hashes the video. IFO file to identify the title (called the MediaID), and then reads the ROM information to establish a data identifier (DataID) for the HTML/JavaScript data on the disc. The identifier engine 710 provides this information to the navigator state module 714 which stores this information and provides it to whichever of the command handler 702, properties handler 704, or event generator 706 needs it. The identifier engine 710 interacts with the navigator state module. The identifier engine 710 receives the BCA information (read differently than files) from the I/O controller 736. The identifier engine 710 interacts with the cookie manager 708 to place disc related information read from the BCA as discussed previously herein into the InterActual System cookie.

The initialization module 712 provides the ability to establish the DVD/CD navigator environment. The initialization module 712 allows the internal states and the State Modules (i.e. the navigator state module 714 to be initialized. This initialization also includes reading the current disc in the drive and initializing a system cookie. It is noted that the embedded web browser 700 interfaces which allow registering a callback for the event handler are established at power-up as well.

The navigator state module 714 provides the ability to coordinate user interaction and DVD behavior with front panel controls and/or a remote control. In one embodiment, arbitration of control happens in the navigator 728 itself between the remote and front panel controls. DVD/CD navigator 722 playback is initiated by the navigator state module 714 in response to input from the initialization module 712. The navigator state module 714 receives locations of book marked points in the video playback from the bookmark manager 716 and controls the DVD/CD navigator 728 accordingly.

The bookmark manager 716 provides the ability for the JavaScript content to mark spots in video playback, and to return later to the same spot along with the saved parameters which include angle, sub-picture, audio language, and so forth. The bookmark manager 716 provides the ability to use video bookmarks in conjunction with web bookmarks. As an example, a video bookmark is set, a web session is launched going to a preset web book marked source to retrieve video-related information, then later a return to the video at the book marked spot occurs. When you “bookmark” a web-page, a Web browser remembers that page's address (URL), so that it can be easily accessed again without having to type in the URL. For example, bookmarks are called “favorites” in Microsoft Internet Explorer. The bookmark keeps place, much like a bookmark in a book does. Most browsers have an easy method of saving the URL to create a bookmark. Microsoft Web editors use the term bookmark to refer to a location within a hyperlink destination within a Web page, referred to elsewhere as an anchor. In one embodiment Web bookmarks have an associated video bookmark. The Video bookmark stores the current location of the video playback, which may be the current time index to a movie or additional information such as the video's state being held in internal video registers that contain the state. In this example, when a new web session is started, a browser is opened and a web bookmark is restored that causes video to resume from a particular video bookmark.

The system timer 722 provides time stamps to the event generator (706) for use in determining events for synchronization or controlled playback.

The system monitor 724 interacts with the properties handler 704. In one embodiment, the system timer 722 generates a 900 millisecond timer tick as an event which the HTML/JavaScript uses in updating the appropriate time displays as is needed. For systems that do not have a DVD Navigator that creates events the system timer 722 is used to poll the property values every 900 milliseconds and compares the poll results with a previous result. If the result changes then an event is generated to the HTML/JavaScript. Some navigators keep the state information of the DVD internally and do not broadcast or send out events to notify other components of the system. These navigators do provide methods or properties to query the current state of the navigator. It is these systems that require polling for the information. Optionally, the process that polls this information detects changes in information and then provides its own event to other components in the system to provide events.

The system initialization 726 provides initialization control whenever the system is turned on or reset. Each component is instantiated and is given execution to setup its internal variables thereby bringing the system to a known initialized state. This enables the state machine for media playback to always start in a known state.

The DVD decoder 735 generally receives the media stream from the I/O controller 736 and decodes the media stream into video and audio signals for output. The DVD decoder 735 receives control from DVD/CD navigator 728.

The CD-DA decoder 734 receives a media stream from I/O controller 736 and decodes it into audio which it provides as output.

The I/O controller 736 interfaces with disk 738 and controls its physical movement, playback, and provides the raw output to the appropriate decoder. The I/O controller 736 also provides disk state information to identifier engine 710.

The disk 738 can be any media disk such as, but not limited to, DVD-ROM, DVD-Audio, DVD-Video, CD-ROM, CD-Audio.

In one embodiment, the application programming interface (API) 742 provides a basic set of guidelines for the production of Internet-connected DVDs and for the playback of these enhanced DVDs on a range of computer, set-top platforms, and players. Based on the industry standard publishing format hypertext markup language (HTML) (found at http://www.w3.org/TR/html) and JavaScript, the application programming interface (API) provides a way to easily combine DVD-Video, DVD-Audio, and CD-Audio with and within HTML pages, whereby HTML pages can control the media playback. The application programming interface (API) provides a foundation for bringing content developers, consumer electronics manufacturers, browser manufacturers, and semiconductor manufacturers together to provide common development and playback platforms for enhanced DVD content.

Referring to FIG. 8, shown is a depiction of one example of the relationship between an entity, a collection, entity metadata, and collection metadata. Shown is a storage area 800 containing multiple entities. Within the storage area is a text entity 802, a video entity 804, an audio entity 806 and a still image entity 808. Also shown are the entity metadata 810, the collection metadata 812 and a final collection 814. The final collection 814 includes the text entity 802, the video entity 804, the audio entity 806, the still image entity 808, the entity metadata 810, and the collection metadata 812.

The collection metadata 812 can be generated at the time of creation of the collection and can be done by the content manager 870 or manually. The content manager 870 can also create a collection from another collection by gracefully degrading it or modifying it. The collection metadata can by static, dynamic or behavioral.

The content services module 824 utilizes a collection of entities for playback. A collection is made up of one or more entities. FIG. 8 shows the hierarchy of a collection to an entity. In one embodiment an entity can be any media, multimedia format, file based formats, streaming media, or anything that can contain information whether graphical, textual, audio, or sensory information. In another embodiment an entity can be disc based media including digital versatile disks (DVDs), audio CDs, videotapes, laserdiscs, CD-ROMs, or video game cartridges. To this end, DVD has widespread support from all major electronics companies, all major computer hardware companies, and all major movie and music studios. In addition, new formats disc formats such as High Definition DVD (HD-DVD), Advanced Optical Discs (AOD), and Blu-Ray Disc (BD, as well as new mediums such as Personal Video Recorders (PVR) and Digital Video Recorders (DVR) are just some of the future mediums that can be used. In another form entities can exist on transferable memory formats from floppy discs, Compact Flash, USB Flash, Sony Memory Sticks, SD_Memory, MMC formats etc. Entities may also exist over a local hard disc, a local network, a peer-to-peer network, or a WAN or even the Internet.

In accordance with one embodiment, each of the entities includes both content and metadata. The entities are gathered by the content search engine 874. The entities are then instantiated into a collection. In object-oriented programming, instantiation produces a particular object from its class template. This involves allocation of a structure with the types specified by the template, and initialization of instance variables with either default values or those provided by the class's constructor function. In accordance with one embodiment, a collection is created that includes the video entity 804, the audio entity 806, the still image entity 808, the text entity 802, the entity metadata 810 for each of the aforementioned entities, and the collection metadata 812.

An entire collection can be stored locally or parts of the entities can be network accessible. In addition entities can be included into multiple collections.

Referring to FIG. 9 shown is a conceptual diagram illustrating one example of metadata fields 900 for one of the various entities 902. Along with each entity is associated metadata 904. The metadata 904 has various categories for which it describes the entity.

In one embodiment the entity metadata may be contained in an XML file format or other file format separate from the entity file. In another embodiment it may be within in the header of the entity file. The entity metadata may be part of the entity itself or in a separate data file from where the entity is stored.

The entity metadata may be stored on a separate medium or location and the present embodiment can identify the disc through an entity identifier or media identifier and then pass the identifier to a separate database that looks up the identifier and returns the entity's metadata, e.g., an XML description file.

The entity metadata is used to describe the entity it is associated with. In accordance with the present invention, the entity metadata can be searched using the search engine described herein. Additionally, the content management system uses the metadata in the creation of collections and uses the metadata to determine how each of the entities within a collection will be displayed on the presentation device.

In one example of the present invention, a system can include a presentation device having a 16:9 aspect ration. The user-may wish to create a collection of Bruce Lee's greatest fight scenes. The content management system will do a search and find different entities that are available, either on an available portable storage medium, the local storage medium, or on any remote storage medium. The content management system will identify the available entities on each storage medium and create a collection based upon the metadata associated with each entity and optionally also the content of each entity. In creating the collection, the system will attempt to find entities that are best displayed on a presentation device with a 16:9 aspect ratio. If an entity exists that has a fight scene, but it is not available in the 16:9 version, the content manager will then substitute this entity with, e.g., the same fight scene that is in a standard television format.

In addition to scenes from a movie, the content management system may also include in the collection still pictures from the greatest fight scenes. In yet another embodiment, the collection can include web-pages discussing Bruce Lee or any other content related to Bruce Lee's greatest fight scenes that is available in an form. The presentation layout manager along with the playback runtime engine will then determine how to display the collection on the presentation device.

In accordance with the present invention there can be different categories of metadata. One example of a category of metadata is static metadata. The static metadata is data about the entity that remains constant and does not change without a complete regeneration of the entity. The static metadata can include all or a portion of the following categories; for example: Format or form of raw entity (encoder info, etc—ex: AC3, MPEG-2); Conditions for use; IP access rights, price—(ex: access key); paid, who can use this based on ID; Ratings and classifications—(ex: parental level; region restrictions); Context data—(ex: when/where recorded; set or volume information); One example of metadata for audio content can include: a=artist, c=album (CD) name, s=song, 1=record label and L=optional record label; Creation and/or production process info—(ex: title, director, etc.); and Rules of usage regarding presentation (unchangeable as per the collection owner) including, for example, layouts, fonts and colors.

Another example of a category of metadata is dynamic metadata. The dynamic metadata is data about the entity that can change with usage and can be optionally extended through additions. The dynamic metadata can include all or a portion of the following categories; for example: Historical and factual info related to usage—(ex: logging for number of times used (royalty related—copyright usage, distribution limitations) or for rental type transaction (e.g. Divx)); Segmentation information—(ex: scene cuts described by static metadata data info (like the G rated version etc) with start/end time codes and textual index info to allow search ability); User preferences and history—(ex: learn uses over time by user to note patterns of use with this collection (versus patterns of use associated with the user ID like TiVo may do)); and Rules of usage regarding presentation (changeable and extendable) including, for example, layout, fonts and colors.

Yet another type of metadata can be behavioral metadata. The behavioral metadata is the set of rules or instructions that specify how the entities are used together in a collection (built upon the static and dynamic metadata information). The behavioral metadata can include all or a portion of the following categories; for example: A script of a presentation of the collection—for example, a G rated version of the collection is constructed using static metadata describing scenes (“Love Scene” starts at time code A and stops at B) and rules which specify layout or copyright requirements (e.g., must be played full screen); A playlist of the collection—(ex: a scene medley of all the New Zealand scenery highlights from “Lord of the Rings”); and A presentation of the collection defined by the title's Director to highlight a cinemagraphic technique.

In one implementation the collection metadata is implemented in an XML file or XML files. In other implementations the collection metadata is in other formats such as part of a playlist. Some examples of Playlist formats for Audio are:(M3U, PLS, ASX, PLT, LST).

The M3U (.m3u) Playlist File Format

M3U is a media queue format, also generally known as a playlist. It is the default playlist save format of WinAMP and most other media programs. It allows multiple files to be queued in a program in a specific format.

The actual format is really simple. A sample M3U list can be:

#EXTM3U

#EXTINF:111,3rd Bass—Al z A-B-Cee z

mp3/3rd Bass/3rd bass—Al z A-B-Cee z.mp3

#EXTINF:462,Apoptygma Berzerk—Kathy's song (VNV Nation rmx)

mp3/Apoptygma Berzerk/Apoptygma Berzerk—Kathy's Song

(Victoria Mix by VNV Nation).mp3

#EXTINF:394,Apoptygma Berzerk—Kathy's Song

mp3/Apoptygma Berzerk/Apoptygma Berzerk—Kathy's Song.mp3

#EXTINF:307,Apoptygma Bezerk—Starsign

mp3/Apoptygma Berzerk/Apoptygma Berzerk—Starsign.mp3

#EXTINF:282,Various_Artists—Butthole Surfers: They Came In

mp3/Butthole_Surfers—They_Came_In.mp3

The First line, “#EXTM3U” is the format descriptor, in this case M3U (or Extended M3U as it can be called). It does not change, it's always this.

The second and third operate in a pair. The second begins “#EXTINF:” which serves as the record marker. The “#EXTINF” is unchanging. After the colon is a number: this number is the length of the track in whole seconds (not minutes:seconds or anything else. Then comes a comma and the name of the tune (not the FILE NAME). A good list generator will suck this data from the ID3 tag if there is one, and if not it will take the file name with the extension chopped off.

The second line of this pair (the third line) is the actual file name of the media in question. In my example they aren't fully qualified because I run this list by typing “noatun foo.m3u” in my home directory and my music is in ˜/mp3, so it just follows the paths as relative from the path of invocation.

For MP3 software Developers:

M3U files can hold MP3 files inside as an album file, called M3A. There is a file format used for Album files, ALBW. This is free to extract files, but not free to create.

Having M3A files do the same makes the format open and free to use by anyone. M3A format does not attempt to re-invent the wheel, it uses existing M3U format known to any mp3 software developers already, with a small addition.

Using the M3U file with file names listed as normal. An additional 2 entries are used:

#EXTBYT:

#EXTBIN:

The size of the file to be inserted is preceded by EXTBYT as follows:

#EXTBYT:511000

filename1.mp3

#EXTBYT:702500

filename2.mp3

All file name entries are preceded by #EXTBYT: values of each file. Following all entries the actual files are inserted after #EXTBIN. To be precise, #EXTBIN: plus CR+LF is the 0 offset for the first file. All mp3 files are joined and inserted as is after that point. To extract file from an M3A you have the file size of each file in #EXTBYT: size value. Each additional file #EXTBYT: is summed to find the end position of the preceding file to the one you wish to extract. Extracted files are created using filenames and #EXTBYT: as file size. This means all files are added to M3A without modification and there is no tag in the M3A itself that can be modified corrupting the Album file. The player can still read m3a part to find the content.

Additional m3u/m3a formatting can add Album descriptions to it.

#EXTINF: seconds, track-artist or

#EXTALB:

#EXTART:

(These are existing m3u values that some mp3 players support already.)

A JukeBox Decoder will currently create M3A files and view and extract mp3 files from M3A.

The JukeBox Decoder will treat the file as M3A playing same filenames of files listed in it, if those files already exist in the same folder as an M3A file just the same as a normal M3U, if there are no external copies it will then allow extraction of those tracks from the M3A.

The m3a file will play as one continuous mp3 if renamed to mp3. There is a separate stand alone program m3aExtract limited to view tracks in an M3A file and extract them in the case you don't have JukeBox Decoder installed. Any programs can use the #EXTBIN: and #EXTBYT: to create Album files, read them and extract contents. Additional optional entries are: #EXTM3U and #EXTM3A. These simply indicate the other EXT entries are present or explicit naming of the content and placed in the first line of the file.

The PLS format is highly proprietary and is only recognized by Winamp and few other players. Specifically, Windows Media Player does not support it, and MusicMatch Jukebox only plays the first song on the list. To ensure that a playlist reaches the widest possible audience, an m3u metafile is the desired format. While the PLS format has extra features like “Title”, these properties can be adjusted in the MP3 file's tag.

In accordance with one embodiment of the present invention, the content search engine can perform a metadata search in order to find entities. The content management system can include the entities in a collection either by downloading them to the local storage medium or simply including them from where the entities are currently stored.

Additionally, the metadata for each collection can be accessed and used across all collections in a library such that a search is made against the entire library much like the UNIX “grep” command. For many uses, a text search will be sufficient; however, pattern or speech recognition technologies can be used against the entities themselves.

In another embodiment, multiple collections can be retrieved and then entities from the multiple collections can be combined to make a new collection. It is the entities from the two previous collections that make up the new collections.

In addition content owners can have control over the content and in what collections it can be used. Content owners may want to control what a collection can be combined with or if the collection is allowed to be broken up into its entities at all. Thus, the metadata associated with the collection can include parameters to control these options.

There can be various types of entities within a collection and the content manager determines which version to playback based on the passed in rules and criteria.

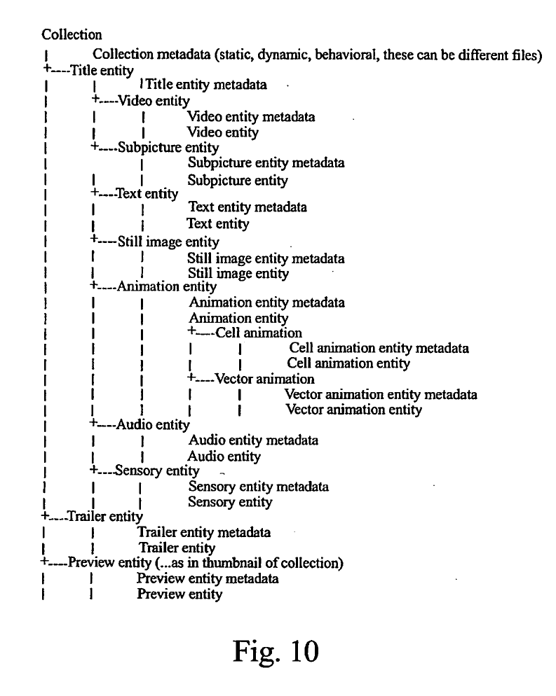

Referring to FIG. 10 a conceptual diagram is shown illustrating one embodiment of a collection. The collection includes the collection metadata (e.g., static, dynamic and behavioral), entities (e.g., title, video, sub-picture, text, still image, animation, audio, sensory, trailer and preview) and entity metadata associated with each of the entities.

In one embodiment, the contents of a DVD can be represented using entities and a collection. For example, video segments will be video entities and have associated metadata. Menus can be still image entities, subtitles can be text entities, and the audio can be audio entities. The collection metadata will describe the behavior of all of the different entities. The playback environment is used to seamlessly playback the represented DVD on the system available.

Referring to FIG. 11 a diagram is shown illustrating an exemplary collection 1150 in relation to a master timeline. Shown is a master timeline 1100, a first video clip 1102 a second video clip 1104, a third video clip 1106, a first audio clip 1108, a second audio clip 1110, a third audio clip 1112, a first picture 1114, a second picture 1116, a third picture 1118, a first text overlay 1120, a second text overlay 1122, a third text overlay 1124, and an event handler 1126.

The exemplary collection 1150 includes the first video clip 1102, the second video clip 1104, the third video clip 1106, the first audio clip 1108, the second audio clip 1110, the third audio clip 1112, the first picture 1114, the second picture 1116, the third picture 1118, the first text overlay 1120, the second text overlay 1122, and the third text overlay 1124, each of which are an entity. Therefore, as shown, the collection 1150 is made up of a plurality of entities.

The collection 1150 also includes collection metadata. The collection metadata can include information about when along the timeline each of the entities will be displayed in relation to the other entities. This is demonstrated by showing each entity being displayed according to the master timeline. Furthermore, the collection metadata can have hard coded metadata or optionally, variable metadata that can be filled in depending upon the system information (requirements and capabilities) for the system the collection will be displayed upon. The system information can be supplied to the content services module by the playback runtime engine. The content services module will then prepare the collection for playback based upon the system information.

One example of an XML file that includes system information and is supplied to the content services module from the presentation engine may be as follows:

```
<?xml version=“1.0” encoding=“UTF-8”?>
<Metadata xmlns:xsi=“http://www.w3.org/2001/XMLSchema-
instance” xsi:noNamespaceSchemaLocation=“CAP.xsd”>
<Module>
  <Capabilities>
    <platforms>
      <platform>01</platform>
      <platform>02</platform>
    </platforms>
    <products>
      <productID>01</productID>
      <productID>02</productID>
    </products>
    <videoDisplays>
      <videoDisplaytype>01</videoDisplaytype>
      <videoDisplaytype>02</videoDisplaytype>
    </videoDisplays>
    <videoResolutions>
      <resolution>
        <videoXResolution>1024 </videoXResolution>
        <videoYResolution>768</videoYResolution>
      </resolution>
      <resolution>
        <videoXResolution>800</videoXResolution>
        <videoYResolution>600</videoYResolution>
      </resolution>
    </videoResolutions>
    <navigationDevices>
      <device>02</device>
      <device>03</device>
    </navigationDevices>
    <textInputDeviceReqd>01</textInputDeviceReqd>
    <viewingDistances>
      <view>01</view>
      <view>02</view>
    </viewingDistances>
  </Capabilities>
</Module>
</Metadata>
```

Alternatively, the XML file that includes the system information can include system requirements that must be met in order for the collection to be displayed. For example, a system that can not decode a HDTV signal will require only entities for a standard NTSC signal. Thus, an available collection may change depending upon the capabilities of the system it will be displayed upon. In this case, the entities within the collection will remain unchanged, however, the collection metadata may change how each of the entities are displayed based upon the system information. The collection metadata that defines how each of the entities are displayed upon a presentation device can be referred to as behavioral metadata.

Behavioral metadata can also include information for when each of the entities will be displayed. The behavioral metadata can map each of the entities into a master timeline, such as is shown in FIG. 11. For example, the first video clip is played from time T0 to time t1.

One example of an XML file that includes behavioral metadata is as follows:

```
<?xml version=“1.0” encoding=“UTF-8”?>
<Metadata xmlns:xsi=“http://www.w3.org/2001/XMLSchema-
instance” xsi:noNamespaceSchemaLocation=“BHM.xsd”>
<Module>
  <moduleName>Sample Script</moduleName>
  <eventHandler>“.. \Sample_ev.xmb”</eventHandler>
  <presentationArray>
    <medley>
      <startHour>0</startHour>
      <startMin>6</startMin>
      <startSec>27</startSec>
      <clipLength>6500</clipLength>
      <clipDescription>Have a face</clipDescription>
      <action type=“PlayTime”></action>
    </medley>
    <medley>
      <startHour>0</startHour>
      <startMin>13</startMin>
      <startSec>45</startSec>
      <clipLength>76500</clipLength>
      <clipDescription>The birthday</clipDescription>
      <action type=“PlayTime”></action>
    </medley>
    <medley>
      <startHour>1</startHour>
      <startMin>34</startMin>
      <startSec>57</startSec>
      <clipLength>3250</clipLength>
      <clipDescription>A goodbye</clipDescription>
      <action type=“PlayTime”>
      <action type=“DisplayImage”>
        <startHour>1</startHour>
        <startMin>36</startMin>
        <startSec>0</startSec>
        <entity>“..\Image.gif”</entity>
      </action>
      </action>
    </medley>
  </presentationArray>
</Module>
</Metadata>
```

In one embodiment, the previous example is used to stitch the varies entities within a collection together using a declarative language model, where each element in the XML file instructs the system what is to be shown at a specific time along a master timeline. Therefore, the collection contains all of the entities, static metadata about the collection, dynamic metadata about the collection, and behavioral metadata about the collection. All of this is used to fully prepare the collection for playback on a presentation device. If the device has the processing power all of this stitching can occur in real-time. In addition, the acquisition of some of the entities that will be used later in time on the presentation can be searched and retrieved in parallel while others are being displayed, to further allow real-time, retrieval, rendering and stitching of entities.

Table 1 is a partial list of the different commands that can be included in the behavioral metadata file.

TABLE 1

Play
PlayTitle
PlayChapter
PlayChapterAutoStop
PlayTime
PlayTimeAutoStop
PlayTitleGroup
PlayTrack
SearchChapter
SearchTime
SearchTrack
NextPG
PrevPG
GoUp
NextTrack
PrevTrack
NextSlide
PrevSlide
Pause
Stop
FastForward
Rewind
Menu
Resume
StillOff
SelectAudio
SelectSubpicture
SelectAngle
SelectParentalLevel
EnableSubpicture
SetGPRM
Mute
FullScreen
GotoBookmark
SaveBookmark
NetConnect
NetDisconnect
SubscribeToEvent

The following is one example of what collection metadata can look like in XML. The example includes both static and dynamic metadata:

```
<?xml version=“1.0” encoding=“UTF-8”?>
<Metadata xmlns:xsi=“http://www.w3.org/2001/XMLSchema-Instance”
xsi:noNamespaceSchemaLocation=“Collection.xsd”>
  <Collection id=“123456789”>
    <title>
      <video>
          <entity id=“A32W”>
            <locator uri=“www.someplace.org/videos/movie”/>
            <metadata uri=“www.someplace.org/meta/movie-
            meta.xml”/>
            <copyright>Buena Vista</copyright>
          </entity>
      </video>
      <audio>
          <entity id=“Z3Q1”>
            <locator uri=“www.someplace.org/tracks/track33.wav”/>
            <metadata uri=“www.someplace.org/meta/audio-
            meta.xml”/>
            <copyright>Buena Vista</copyright>
          </entity>
      </audio>
      <text>
          <entity id=“F4R0”>
            <locator uri=“www.someplace.org/subtitles/t12.xml”/>
            <metadata uri=“www.someplace.org/meta/text-
            meta.xml”/>
            <copyright>NA</copyright>
          </entity>
      </text>
      <subpictures>
          <entity id=“422P”>
            <locator uri=“www.someplace.org/subp/track8”/>
            <metadata uri=“www.someplace.org/meta/subp-
            meta.xml”/>
            <copyright>Buena Vista</copyright>
          </entity>
      </subpictures>
    </title>
    <static>
      <description>
        <format type=“MPEG-2” encoder=“Sigma”/>
        <condition type=“PKI”>free</condition>
        <rating type=“US”>PG</rating>
        <author>Disney</author>
        <director>George Jelson</director>
        <usage uri=“rules/J-rule” type=“mandatory”/>
      </description>
    </static>
    <dynamic>
      <description>
        <usageLog type=“royalty-free” uri=“http://www.free-
        media.com/BV”/>
        <segments uri=“segments/G-version”/>
      </description>
    </dynamic>
  </Collection>
</Metadata>
```

The collection metadata includes a listing of the entities included in the collection and also includes pointers to where the entity and the entities metadata are stored. Additionally included are both static and dynamic metadata. The collection need not include both static and dynamic metadata but will generally include both types of metadata.

The following is an example of entity metadata in an XML file. In the example given, the entity is a piece of video content:

```
<?xml version=“1.0” encoding=“UTF-8”?>
<Metadata xmlns:xsi=“http://www.w3.org/2001/XMLSchema-instance”
xsl:noNamespaceSchemaLocation=“ENT.xsd”>
  <entity id=“3445”type=“video”>
    <locator uri=“www.someplace.org/videos/test-flick”/>
    <static>
      <description>
        <format type=“MPEG-4” encoder=“CC”/>
        <condition type=“PKI”>free</condition>
        <rating type=“US”>PG</rating>
        <author>Disney</author>
        <director>Yoglo</director>
        <copyright>Time Warner</copyright>
        <usage uri=“rules/Y-rule” type=“mandatory”/>
      </description>
    </static>
  </Entity>
</Metadata>
```

As shown, the metadata includes, for example, a location of the entity, the type of content, the copyright owner, the usage rules, the author, the access rules, and the format. The entity metadata is used by the content manager to properly place the entity within a collection and is also used by other components of the system, such as is described herein. The previous examples of files are shown in XML however other types of files, such a SMIL or proprietary files can be used.

In addition, a stream of video can have predefined jump points in the entity metadata to instruct the playback system to intelligently load the stream (start loading at multiple points in the stream to enable quick jumping). Further, some predictive analysis is optionally used by the playback system (using the jump points defined in the metadata) to setup not only the start of playback a t=00:00 but also at a jump point defined at t=05:13. Thus, if a portion of an entity that is being downloaded has inappropriate content for children, the streaming video will begin downloading at the beginning of the video and also directly after the inappropriate content. A jump point can then be defined at the beginning of the inappropriate content such that the player will skip the inappropriate content and continue play with the video directly after the inappropriate content.

Alternative to having a master timeline, the timing of the entities within the collection can be specified by Flextime. Flextime provides temporal grouping (or temporal snapping) and allows a segment of stream to stretch/shrink. Rather than being based on “hard” object times on a timeline, this allows a relative stitching of entities together which helps in delivery systems that have delays like broadcast or streams having congestion. For example, the timing of actions can be specified to CoStart or CoEnd or Meet (reference paper give on “FlexTime” by Michelle Kim IBM TJ Watson Research 16 Jul. 2000, which is fully incorporated herein by reference).

As shown in FIG. 11, the system also includes an event handler. The event handler monitors inputs from a user and takes the appropriate action depending upon the input detected. In one embodiment, the event handler monitors inputs from the remote control shown in FIG. 30.

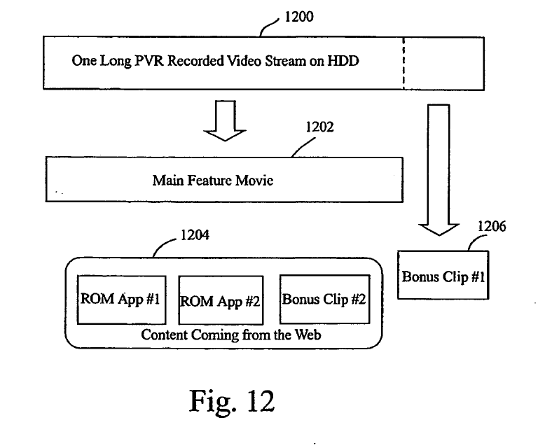

FIG. 12 is a block diagram illustrating a virtual DVD construct in accordance with one embodiment of the present invention. Shown is a PVR recording 1200, a feature movie 1202, a bonus clip 1204, and web-content 1206.

In one embodiment, the bonus clip 1204 can be added to the feature movie 1202. As shown, the bonus clip 1204 can be taken from the PVR recording 1200. The main feature movie 1202 can be a PVR recording or some other set of entities. Additionally, the web-content 1206 (which can be one or more entities) can be added to form a collection including the feature movie 1202, the bonus clip 1204 and the web-content 1206. This can be assembled into a virtual DVD.

In another example, content from a PVR and content from the web are combined to assemble a virtual DVD. The last step of assembling the DVD is not shown, however, this simply shows the virtual DVD. This virtual DVD can be similar to the DVD described with reference to FIG. 10.

To create a virtual DVD, first the content services module 304 assembles the raw materials of the DVD including: Video file or files for the feature presentation; Video files for alternate angles; Audio files which can be multiple for more than one language; Text files for subpictures (use DOM/CSS to do text overlay); XHTML files to replace menus; and GIF/JPEG etc to create same look of menu. In this Virtual DVD, the menu has more capabilities than a standard, fixed DVD menu in that it is capable of presenting on top of the live video using alpha blending techniques. That is, the overlaid menus have transparency and are shown with XHTML text overlaid on top of the playing video. Generally, the DVD menus are fixed and unchangeable when the disc is replicated. The new overlaid menus of the present invention are also optionally context-sensitive based upon where they are requested during video playback. The overlaid menus will change according to the timeline of the video and the text. Similarly, the graphics of the overlaid menu can be fresh and new, e.g., come from an online connection. This is accomplished by providing triggers in the collection metadata that define the content of the overlaid menu based upon the timeline and a menu generator function within the Presentation Layout Manager. The system will read these metadata triggers to construct the menu upon a user request.

Another feature of the overlaid menus is that in one embodiment the menu generator function uses both collection metadata and the stored user preferences to determine how the menus are presented and what information is presented. Alternatively, an online service that uses the predefined information of the media (such as the mountainous location) and the user preferences stored in the playback system (fly fishing interest) combines these two inputs to derive new information for the overlaid menu. In this example, the menu includes a description of where the mountains in the media are located and a description of the local fly fishing resources in the area. In one embodiment, the process of creating the menu is done in a background process upon first inserting the disk where the information for the menu is stored locally, e.g., as additional user preferences related to the inserted disk. In another example, when a user prefers a color scheme, the menus will adhere to the preferred color scheme. When the user has certain interests, such as fly fishing, upon generating the menu during a mountain scene, the menu will, for example, add URL links to fishing locations near that location. A menu generated during the same scene for a second user who enjoys skiing, will add a link to a local ski resort.

For packaged media (i.e. DVD disks, Video-CDs) menus stored on the media are static and do not change after replication and are associated with the content on the disk. The menus have a root or main menu and there can also be individual title menus. Additionally, the video presentation is traditionally halted when the menu is requested by the consumer. One embodiment of the present invention allows the menu of a specific title to be displayed while the video presentation progresses. This is done, in one embodiment, utilizing alpha blending, as will be described herein below. Another embodiment, allows the menu to change according to when it is requested. For example, the menu options are different depending on where in the video playback the menu is requested. Alternatively, there are multiple menus associated with the same scene and they are randomly chosen as to which one is displayed. Optionally, the player will track which menus the user has already seen and rotate through an associated menu set. In one embodiment, the menus are used for advertising purposes such that as the menu is shown it contains a different sponsor or rotates sponsors each time the menu is shown. For these examples the menu can be different menus each with different branding or the menu can incorporate another menu, e.g., a menu for related material, an index, or another menu for a sponsor or advertiser's material. In an alternative embodiment this is achieved utilizing multiple layers or through the use of alpha blending. Alternatively this is achieved by writing to a single frame buffer the two sets of images or material.

For broadcast media, TV is broadcast via cable, terrestrial or satellite and a unique menu called an electronic program guide (EPG) is provided that aggregates the available programs. The EPG is a menu that allows the consumer to alter the video presentation. It originates not with the broadcast stream (i.e., the Disney channel doesn't provide a Disney EPG) but with the service provider. One embodiment allows the menu displayed to be associated with or even derived from the specific broadcast stream (a Disney menu pops up while on the Disney channel). When the menu is displayed it can either be overlaid (using alpha blending) on the content, halt the video presentation, or place the video presentation in only a portion of the display screen. Another embodiment (adding to the above scenario) allows the Disney menu to change depending upon when it is requested, e.g., the menu options differ 5 minutes into the broadcast versus 30 minutes into the broadcast. As in the previous paragraph multiple menus can be associated with the same scene and randomly chosen as to which is displayed. Alternatively, the player tracks which menus the user has already seen and rotates through the associated menu set.

Returning to the creation of a Virtual DVD, once all of the entities have been assembled for the Virtual DVD a metadata file is created (e.g., an XML file, such is described herein which is essentially a collection metadata file) to describe the playback of all of the entities. Table 2 shows an example mapping of entities to the DVD structural construct:

TABLE 2

| Titles & Chapters | | |
|---|---|---|
| (PTT) | | |
| Title 1 | Video file name | HH:MM:SS:FF |
| Chapter 1 | Video file name | HH:MM:SS:FF |
| Chapter 2 | Video file name | HH:MM:SS:FF |
| . | | |
| . | | |
| . | | |
| Chapter 999 | Video file name | HH:MM:SS:FF |
| Title 2 | Video file name | HH:MM:SS:FF |
| Chapter 1 | Video file name | HH:MM:SS:FF |
| Chapter 2 | Video file name | HH:MM:SS:FF |
| . | | |
| . | | |
| . | | |
| Chapter 999 | Video file name | HH:MM:SS:FF |
| . | | |
| . | | |
| . | | |
| Title 99 | Video file name | HH:MM:SS:FF |
| Menus | | |
| Menu 1 | XHTML Page | |
| Menu 2 | XHTML Page | |
| . | | |
| . | | |
| . | | |
| Menu 6 | XHTML Page | |
| Audio | | |
| Stream 0 | Audio file name | |
| Stream 1 | Audio file name | |
| . | | |
| . | | |
| . | | |
| Stream 7 | Audio file name | |
| Subpicture | | |
| Stream 0 | Text file name | |
| Stream 1 | Text file name | |
| . | | |
| . | | |
| . | | |
| Stream 31 | Text file name | |
| Angle | | |
| Angle 1 | Video file name | HH:MM:SS:FF |
| Angle 2 | Video file name | HH:MM:SS:FF |
| . | | |
| . | | |
| . | | |
| Angle 9 | Video file name | HH:MM:SS:FF |

Next the media services can use this metadata file to reinterpret the ITX commands. For example,

In JavaScript-

InterActual.PlayTitle (3);

Is interpreted by the IMS using the mapping in C or C++ ask . . .

If (title == 3)
PlayTime (filename, timecode);

where the mapping says title 3 is equivalent to playing the PVR file from the time offset specified in the mapping to effectively playback the DVD title 3.

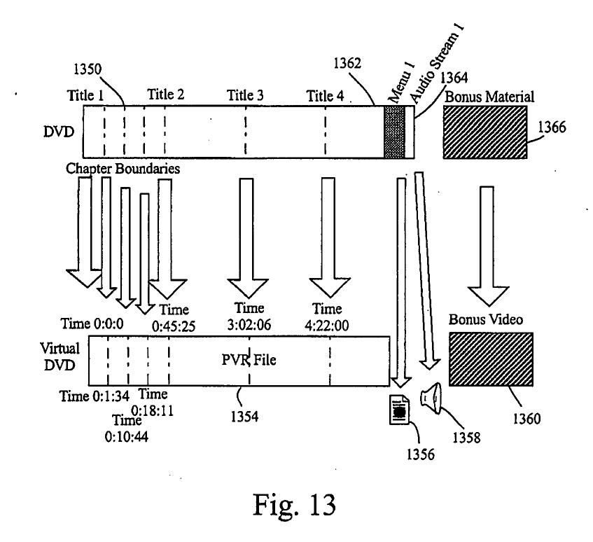

Referring now to FIG. 13, shown is a comparison of a DVD construct 1350 as compared to a virtual DVD construct such as described with reference to FIG. 12. The virtual DVD is constructed from different entities including a PVR file 1354, a XHTML page 1356, a MP3 audio stream 1358, and a bonus video clip 1360. In accordance with the present invention, the content manager gathers the entities and constructs the virtual DVD. The playback of the Virtual DVD will basically appear to the viewer as if they are watching the actual DVD video. The XHTML page can include links that will jump a user to a time period in the PVR file corresponding to a chapter boundary in the actual DVD.

The content manager 470 (shown in FIG. 4) can create a virtual DVD. For example, the content manager 470 can break up one long PVR stream on a DVR and add titles and breaks such as a DVD. Additionally, other entities from the Internet or any other location can be made part of the DVD and inserted as chapters. For example, bonus clips of video from the Web can be inserted into the PVR in the appropriate place. The Creation of Virtual DVD'S can be realized in accordance with the present invention.

Furthermore, over cable or satellite delivery systems, full length, uninterrupted movies are often offered for sale for a one-time use, which is called “pay-per-view.” With the advent of personal video recorders (PVRs), the content owner can offer these movies purchased to be placed temporarily to a local storage medium. For some additional charge or some other agreement, the consumer can be allowed to record the content to an optical medium (such as DVD-R or DVD+R). As such, they are purchasing the movie, yet it is not equivalent in content to the replicated DVD (packaged media) available in a store. This offers the same or updated material or bonus material for download to the client device and the recording process to create a close facsimile to the packaged media. Where there are differences from the packaged media (such as navigation normally done in the DVD navigation commands), included HTML-based ROM content can accommodate for navigational differences. Using the recording system associated with the optical drive, the titles can be laid out much the same as the replicated DVD.

In another example, many applications that record entities have the ability to put in delimiters or what can be called chapter points in the case of DVD. The chapter points can happen automatically by tools or authoring environments in which the start and end of any entity within a collection becomes a chapter point. Additionally, a user can add chapter points into relevant parts of the collection/entity that are desired to be indexed later. These chapter points can also be indexed by a menu system, such as in the case of DVDs. In many tools or authoring packages a user can instantly create a menu button link to any chapter point by simply dragging the chapter point onto a menu editor. The button created uses the video clip from the frame where the chapter point is located.

Another feature is Smart End-Action Defaults in which every video and multimedia entity added automatically establishes appropriate end-action settings. In DVD systems these are pre and post commands. In some cases the end-action may be to return to the menu system it was started from or to continue on to playback the next entity. These transition points between entities can become automatic chapter points as well.

In another virtual DVD system a video stream from a DVD entity can be based on single timeline, with the addition of creating pseudo-DVD chapter points and title points to simulate the DVD. This will entail knowing the detailed structure of the replicated DVD and using that as input to the encoder to know how to break up the one long stream of the main feature and bonus clips into the separate bonus titles and the main feature into chapters.

In addition to meta-tags used for parts of data or textual entities in a PVR system, a smart tag can be implemented at run time or processed before it is displayed. The Smart tag can be used to find key words that match other entities and provide a hyperlink to jump to that associated entities. For example, all words on a page can be linked back to a dictionary using smart tags. In this example, if the user does not understand what a word means in the entity that is displayed, the user is able to click on the word and get a definition for it. Smart tags can also be used for promotional purposes or be used to link back to a content owner. For example, if a multimedia entity is displayed from a particular studio, then a tag is available to link back to the studio's website or for similar content by the same studio or a preferred partner or vendor. In one embodiment, because this is done at run-time the options of the smart tag can be relevant to what is available at that time or based on user preferences as well.

Referring to FIG. 14 a block diagram is shown illustrating a content management system locating a pre-defined collection in accordance with an embodiment of the present invention. Shown is a content manager 1400, a new content acquisition agent 1402, a media identifier 1404 (also referred to as the entity name service), a content search engine 1406, a access rights manager 1408, a playback runtime engine 1410, and a presentation layout manager 1412; and a collection name service 1414.

Shown is a data-flow diagram for finding a pre-defined collection and setting up for a specified playback experience.

The following steps are performed for the embodiment shown:

1. First, a request is made for a pre-defined collection.

2. Next, the Playback run-time engine constructs the request that can include, for example: The desired collection information; The expected output device (display); the expected input device (HID); and other desired experience characteristics.

3. The playback RT engine passes the request to the Content Manager.

4. The content manager passes the request details (such as “all the Jackie Chan fight scenes from the last 3 movies”) to the collection name service which translates the request into a list of candidate collection locators (or IDs). Alternatively, in another embodiment, the request can be translated into a list of entity locators or entity IDs. If a collection can not be located, different entities can be located to create a collection.

5. The content manager then requests a search be executed by the content search engine.

6. The content search engine then searches for the collection and its associated entities. This can involve a secondary process for searching local and across the network which is explained below.

7. Upon locating the collection and caching it in the local storage, the content search engine requests access rights for the collection from the access rights manager. In some cases, the access rights are first acquired to read the entity and make a copy in local storage.

8. The access rights manager procures the access rights and provides the rights information to the Content Search Engine.

9. If certain entities are not available from their primary sources, alternate sources can be found and used. In this case:

a. The content search engine will request individual entities form the new content acquisition agent.

b. The new content acquisition agent then passes the entity request to the Entity Name Service which resolves the various entities down to unique locators (as to where they can be located across the network).

c. The NCAA then will pass the entity location information or alternatively entity IDs to the Content Search Engine.

10. After all necessary entities of the collection are located, the content search engine provides the collection locator to the content manager.

11. The content manager then passes the collection locator to the presentation layout manager along with the collection request.

12. The presentation layout manager then processes the two pieces of information to verify that this collection can satisfy the request.

13. The presentation layout manager then creates rules for presentation and sets up the playback subsystem according to these rules.

14. Then the presentation layout manager provides the collection locator (pointer to local storage) to the playback RT engine.

15. The playback RT engine then commences playback.

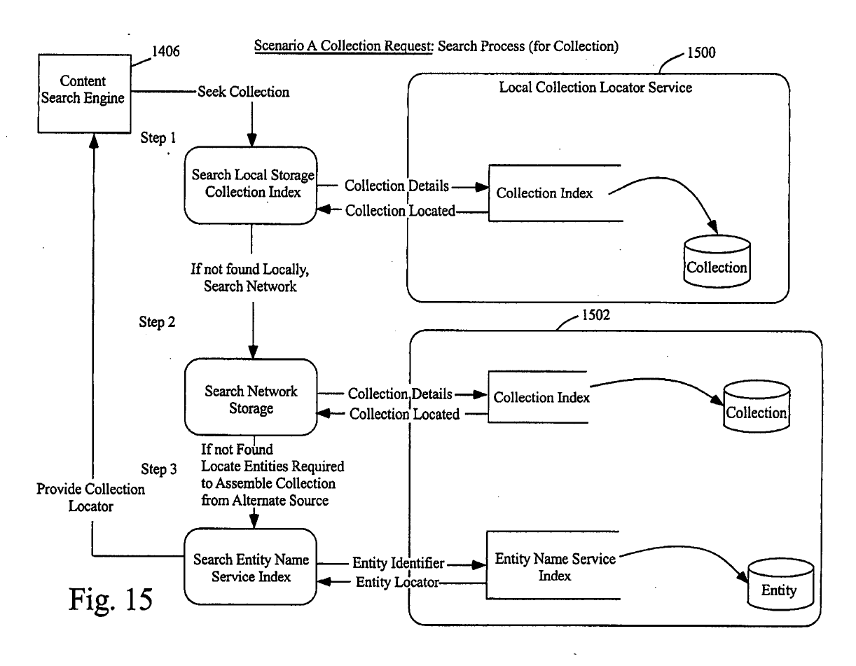

Referring now to FIG. 15 a block diagram is shown illustrating a search process of the content management system of FIG. 14 for locating a pre-defined collection in accordance with one embodiment of the present invention. Shown is the content search engine 1406, a local collection name service 1500, and a network collection name service 1502.

In operation, the following steps are performed in the search process in accordance with one embodiment of the present invention:

1. First, the local collection name service-collection index is searched for the collection requested (in case it has already been acquired).

2. If it isn't found locally, then the network collection name service searches the network collection index. This service maintains an index that is an aggregate of multiple indices distributed across the network in the fashion that Domain Name Servers work for the Internet where they keep updated on a regular basis.

3. If a specific entity cannot be located or acquired, then the entities desired to assemble the collection can be located and acquired from alternate sources and the Content Services Subsystem assembles the collection. This is accomplished using a distributed Entity Name Service that operates underneath the collection name service (again, in a similar fashion to Internet DNS).

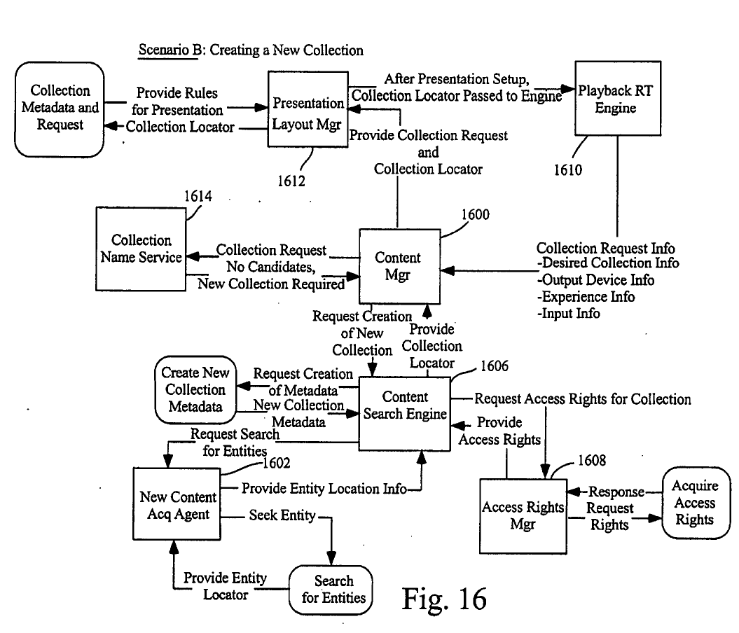

Referring now to FIG. 16 a block diagram is shown illustrating a content management system creating a new collection in accordance with an embodiment of the present invention. Shown is a content manager 1600, a new content acquisition agent 1602, a content search engine 1606, a access rights manager 1608, a playback runtime engine 1610, and a presentation layout manager 1612; and a collection name service 1614.

Shown is a data-flow diagram for creating a new collection based upon a desired set of entities and desired user experience in accordance with one embodiment.

The following steps can be performed in accordance with one embodiment:

1. A request is made for a collection that includes certain entities with details about the desired experience (for example, “the Toy Story II on wide screen (16:9) in the Living Room with interactive click-through points in the video using a remote control with joystick pointers”).

2. The Playback run-time engine constructs the request that includes, for example:

a. The desired collection information including a list of the desired entities (e.g., video, audio, pictures, etc.).

b. The expected output device (display).

c. The expected input device (HID).

d. Other desired experience characteristics.

3. The Playback RT engine passes the request to the Content Manager.

4. The Content Manager passes the request details (such as Toy Story II on wide screen) to the Collection Name Service, which translates the request into a list of candidate collection locators (or IDs). In this case, there is no collection to satisfy this request, so a new collection will be created.

5. The Content Manager then requests a new collection be created by the Content Search Engine.

6. The Content Search Engine requests the individual entities from the New Content Acquisition Agent to assemble the new collection. In one embodiment, the request can be translated into a list of entity locators or entity IDs. If a collection can not be located, different entities can be located to create a collection.

7. The NCAA then searches storage for the entities (in case they are part of some other collection). In one embodiment, the NCAA searches for the entity IDs.

8. The NCAA then passes the entity location information to the Content Search Engine. The NCAA can also pass the entity metadata location to the content search engine.

9. The Content Search Engine then assembles all the entities and initiates the process to create the new metadata for a new collection.

10. Upon locating the entities and caching the desired entities in local storage, the content search engine requests access rights for the collection from the Access Rights Manager. In some cases, the access rights are first acquired in order to read the entity and make a copy in local storage.

11. The Access Rights Manager procures the access rights and provides the rights information to the Content Search Engine.

12. The Content Search Engine creates new collection metadata.

13. The Content Search Engine then provides the collection locator to the Content Manager.

14. The Content Manager then passes the collection locator to the Presentation Layout Manager along with the collection request.

15. The Presentation Layout Manager then processes the two pieces of information to verify that this collection can satisfy the request.

16. The Presentation Layout Manager then creates rules for presentation and sets up the playback subsystem according to these rules.

17. Then the Presentation Layout Manager provides the collection locator (pointer to local storage) to the Playback RT Engine.

18. The Playback RT Engine then commences playback.

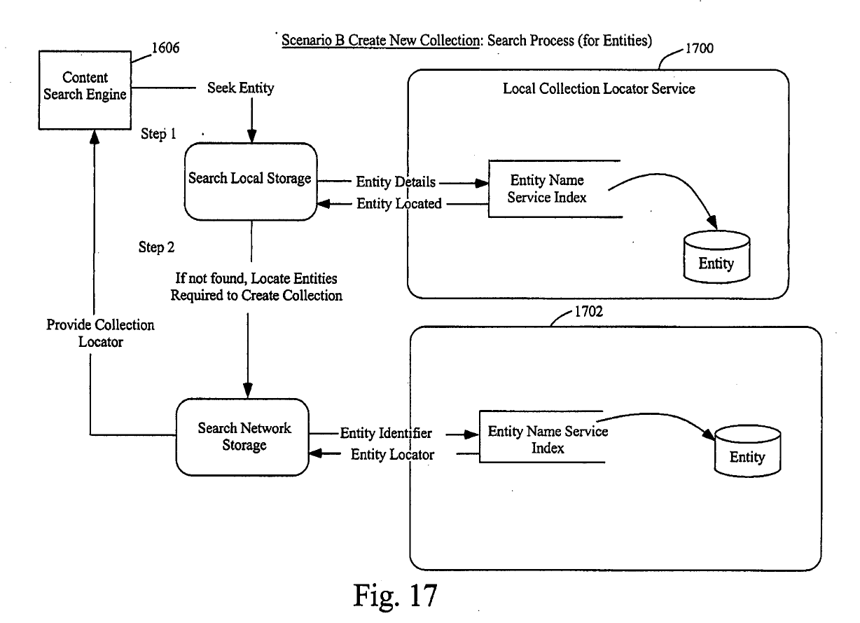

Referring now to FIG. 17, a block diagram is shown illustrating a search process of the content management system of FIG. 16 for locating at least one entity in accordance with one embodiment of the present invention. Shown is the content search engine 1606, a local collection name service 1700, and a network collection name service 1702.

In operation, the following steps are performed in the search process in accordance with one embodiment of the present invention:

1. The local Entity Name Service index is searched for any entities that can be included in the new collection.

2. If the entities are not found locally or additional entities can be added, then the network entity name service searches the network for the entities that were not found and/or for entities that can be included in the collection.

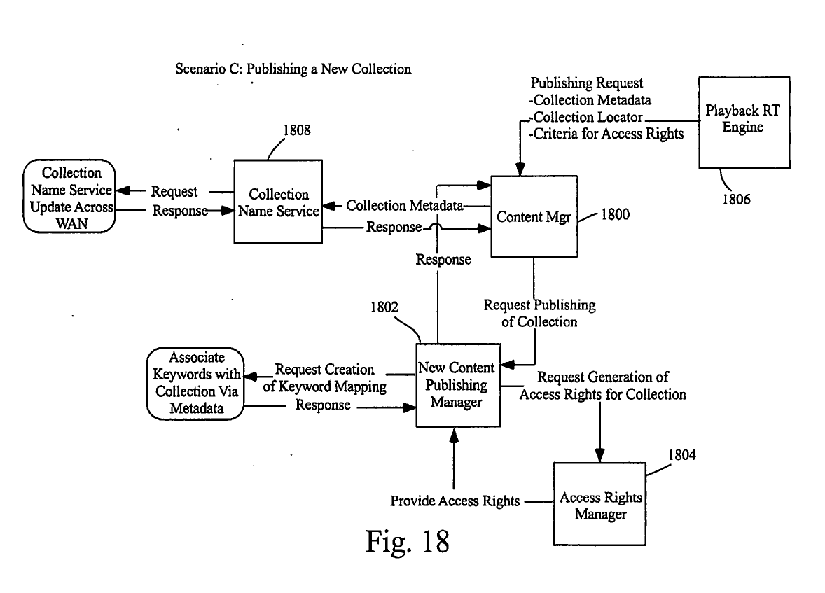

Referring now to FIG. 18, a block diagram is shown illustrating a content management system publishing a new collection in accordance with an embodiment of the present invention. Shown is a content manager 1800, a new content publishing manager 1802, a access rights manager 1804, a playback runtime engine 1806; and a collection name service 1808.

Shown is a data-flow diagram for publishing a new collection in accordance with one embodiment.

The following steps can be performed in accordance with one embodiment:

1. The System Manager requests that a collection (recently acquired or created) be published.

2. The System Manager constructs the request that includes, for example:

e. The published request, including a subset of the collection metadata that contains search strings and keywords that enable mapping the collection to items it contains (for example, clips of John Wayne western fight scenes).

f. The collection locator and all of the metadata and associated entities (or pointers to those entities).

g. Criteria for Access Rights.

3. The System Manager passes the request to the Content Manager.

4. The Content Manager passes the request to the Network Content Publishing Manager.

5. The Network Content Publishing Manager processes the publishing request, which includes the criteria of how the collection is to be made available for access.

6. The Access Rights Manager also processes the request for the generation of the access rights.

7. The publishing request and collection metadata is passed to the Collection Name Service so that search strings and keywords can be associated with this collection.

8. The Collection Name Service makes the collection available across the WAN via its Collection Name Service update structure.

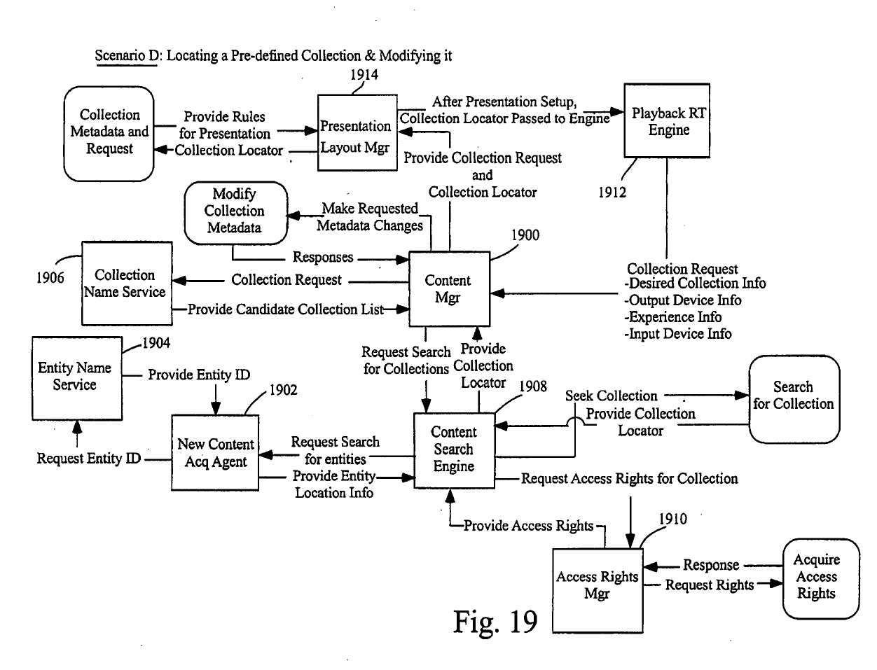

Referring now to FIG. 19 a block diagram is shown illustrating a content management system locating and modifying a pre-define collection in accordance with an embodiment of the present invention. Shown is a content manager 1900, a new content acquisition agent 1902, a media identifier 1904 (also referred to as the entity name service), a collection name service 1906, a content search engine 1908, a access rights manager 1910, a playback runtime engine 1912, and a presentation layout manager 1914.

Shown is a data-flow diagram for finding a pre-defined collection and modifying it for playback experience in accordance with one embodiment.

The-following steps can be performed in accordance with one embodiment:

1. A request is made for a pre-defined collection with certain unique requirements that will likely require modifications to the collection.

2. The Playback run-time engine constructs the request that includes, for example:

h. The desired collection information

i. The expected output device (display)

j. The expected input device (HID)

k. Other desired experience characteristics

3. The Playback RT engine passes the request to the Content Manager.

4. The Content Manager passes the request details (such as “all the Humphrey Bogart love scenes from 1945”) to the Collection Name Service, which translates the request into a list of candidate collection locators (or IDs). (In this case, the collection may need to be a subset of a “Bogart Love Scenes from 1935-1955” collection.).

5. The response from the Collection Name Service informs the Content Manager that there is no one collection that will satisfy this request. The Content Manager notes that for later adjustment of the collection metadata based on a best-fit algorithm.

6. The Content Manager then requests a search be executed by the Content Search Engine.

7. The Content Search Engine then searches for the best-fit collection and its associated entities. This involves a secondary process for searching local and across the network which is explained below.

8. Upon locating the collection and caching it in the local storage, the Content Search Engine requests access rights for the collection from the Access Rights Manager. In some cases, the access rights are first acquired in order to read the entity and make a copy in local storage.

9. The Access Rights Manager procures the access rights and provides the rights information to the Content Search Engine.

10. If certain entities are not available from their primary sources, alternate sources can be found and used. In this case,

l. The Content Search Engine will request individual entities form the New Content Acquisition Agent.

m. The New Content Acquisition Agent will then pass the entity request to the Entity Name Service which resolves the various entities down to unique locators (as to where they can be located across the network).

n. The NCAA then will pass the entity location information to the Content Search Engine.

11. After all necessary entities of the collection are located, the Content Search Engine provides the collection locator to the Content Manager.

12. The Content Manager modifies the collection metadata to fit the request (in this case, subsets the “love scenes for 1945” only). If it is not possible to modify the collection, e.g., because it is disallowed by the collection metadata, then instead of playback setup, the request is denied and the following steps are not executed.

13. The Content Manager then passes the collection locator to the Presentation Layout Manager along with the collection request.

14. The Presentation Layout Manager then processes the two pieces of information to verify that this collection can satisfy the request.

15. The Presentation Layout Manager then creates rules for presentation and sets up the Playback Subsystem according to these rules.

16. Then the Presentation Layout Manager provides the collection locator (pointer to local storage) to the Playback RT Engine.

17. The Playback RT Engine then commences playback.

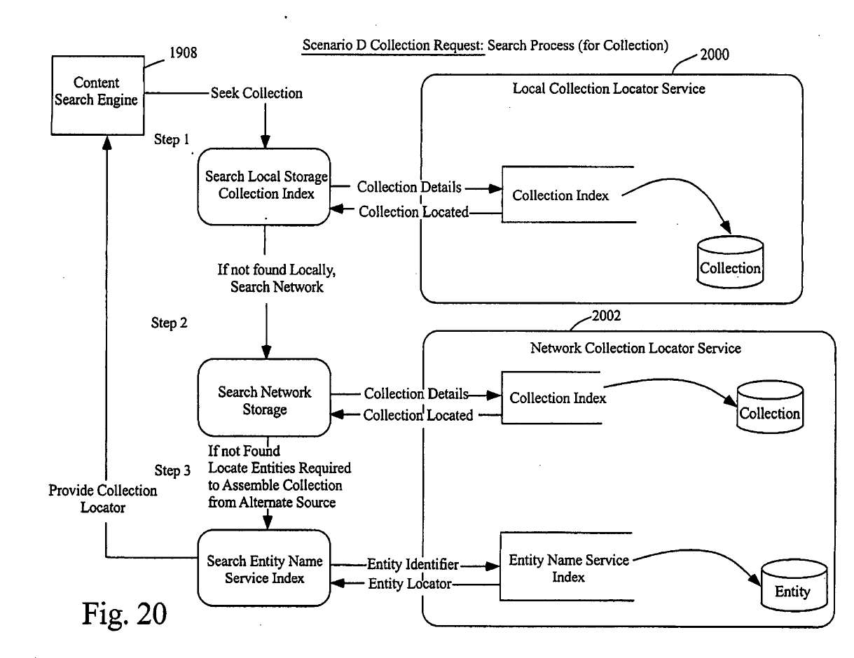

FIG. 20 is a block diagram illustrating a search process of the content management system of FIG. 19 for locating a pre-defined collection in accordance with one embodiment of the present invention. Shown is the content search engine 1908, a local collection name service 2000, and a network collection name service 2002.

In operation, the following steps are performed in the search process in accordance with one embodiment of the present invention:

1. First, the local Collection Name Service collection index is searched for the collection requested (in case it has already been acquired)

2. If the collection isn't found locally, then the network Collection Name Service searches the network collection index. This service maintains an index that can be an aggregate of multiple indices distributed across the network in the same fashion that domain name servers work for the Internet where they keep updated on a regular basis.

3. If a specific entity cannot be located or acquired, then the entities that are used to assemble the collection can be located and acquired from alternate sources and the content services subsystem will assemble the necessary collection. This can be accomplished using a distributed entity name Service that operates “underneath” the collection name service (again, in a similar fashion to Internet DNS).

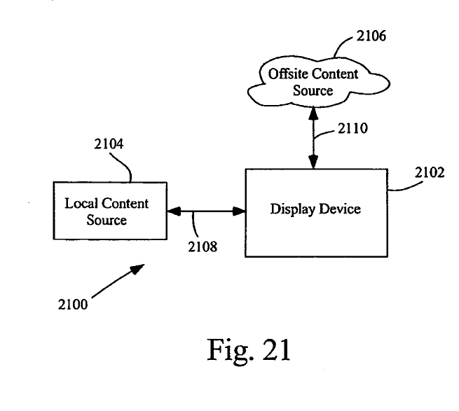

Referring now to FIG. 21, a general example is shown of a display device receiving content from local and offsite sources according to one embodiment. Shown are a display device 2102, a local content source 2104, an offsite content source 2106, a first data channel 2108, and a second data channel 2110.

The display device 2102 is coupled to the local content source 2104 via a first data channel as shown by a first bi-directional arrow. The display device 2102 is coupled to the offsite content source 2106 via a second data channel 2110 as shown by a second bi-directional arrow. The first and second data channels are any type of channel that can be used for the transfer of data, including, for example, a coaxial cable, data bus, light, and air (i.e., wireless communication).

In operation, the display device 2102 displays video, data documents, images, and/or hypertext markup language (HTML) documents to a user. The display device, in some variations, is also capable of displaying many different types of data files stored on many different types of storage media. Alternatively, the display device 2102 can be for audio only, video only, data documents only, or a combination of audio, and/or video, images, and data documents. The display device 2102 can be any device capable of displaying an external video feed or playing an external audio feed such as, but not limited to, a computer (e.g., a IBM compatible computer, a MACINTOSH computer, LINIX computer, a computer running a WINDOWS operating system), a set top box (e.g., a cable television box, a HDTV decoder), gaming platforms (e.g., PLAYSTATION II, X-BOX, NINTENDO GAMECUBE), or an application running on such a device, such as a player (e.g., INTERACTUAL PLAYER 2.0, REALPLAYER, WINDOWS MEDIA PLAYER). The display device 2102 receives content for display from either the local content source 2104 or the offsite content source 2106. The local content source 2104, in one embodiment, can be any device capable of playing any media disk including, but not limited to, digital versatile disks (DVDs), digital versatile disk read only memories (DVD-ROMs), compact discs (CDs), compact disc-digital audios (CD-DAs), optical digital versatile disks (optical DVDs), laser disks, DATAPLAY (TM), streaming media, PVM (Power to Communicate), etc. The offsite content source 2106, in one embodiment, can be any device capable of supplying web content or HTML-encoded content such as, but not limited to, a network-connected server or any source on the Internet. The offsite content source 2106 can also be any device capable of storing content such as video, audio, data, images, or any other types of content files.

In yet another alternative embodiment, the display device 2102 can be any display device capable of displaying different entities within a collection. Entities and collections will be further described herein in greater detail.

Alternatively, the display device is not connected to an offsite content source, but is capable of simultaneously displaying content from different local storage areas. In one embodiment of the present invention the display device is able to display entities from a collection that is stored at the local content source 2104.

Furthermore, the system shown in FIG. 21 is capable of working in accordance with the different embodiments of the content management system shown in FIGS. 1-4.

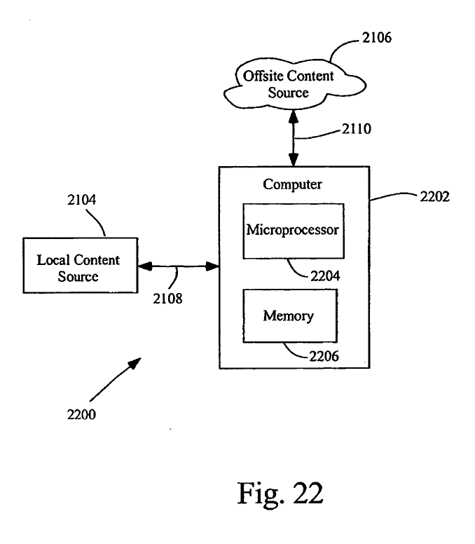

FIG. 22 shows a general example of a computer receiving content from local and offsite sources according to one embodiment. Shown are a local content source 2104, an offsite content source 2106, a computer 2202, a microprocessor 2204, and a memory 2206.

The local content source 2104 is coupled to the computer 2202. The local content source 2104 can contain, e.g., video, audio, pictures, or any other document type that is an available source of information. In a preferred embodiment, the local content source 2104 contains entities and collections. The offsite content source 2106 is coupled to the computer 2202. In one embodiment, the offsite content source 2106 can be another computer on a Local Area Network. In another embodiment, the offsite content source can be accessed through the Internet, e.g., the offsite content source can be a web page. The offsite content source 106 can also include, e.g., video, audio, pictures, or any other document type that is an available source of information. In a preferred embodiment the offsite content source 2106 includes entities and collections. The computer 2202 includes the microprocessor 2204 and the memory 2206.

Alternatively, the computer 2202 is not connected to an offsite content source 2106, but is displays content from different local storage areas (e.g., a DVD and a hard drive). In one embodiment of the present invention the computer 2202 displays entities from a collection that is stored at the local content source 2104. The computer is able to display entities by decoding the entities. Many possible decoders utilized by the computer are described herein at least with reference to FIGS. 3 and 4.

In operation, the computer 2202 is any computer able to play/display video or audio or other content, including entities or collections, provided by the local content source 2104 and/or as provided by the offsite content source 2106. Additionally, in one embodiment, the computer 2202 can display both video and web/HTML content synchronously according to one embodiment of the present invention. The web-HTML content can be provided by either the offsite content source or the local content source. Microprocessor 2204 and memory 2206 are used by the computer 2202 in executing software of the present invention.

Furthermore, the system shown in FIG. 22 is capable of working in accordance with the different embodiments of the content management system shown in FIGS. 1-4.

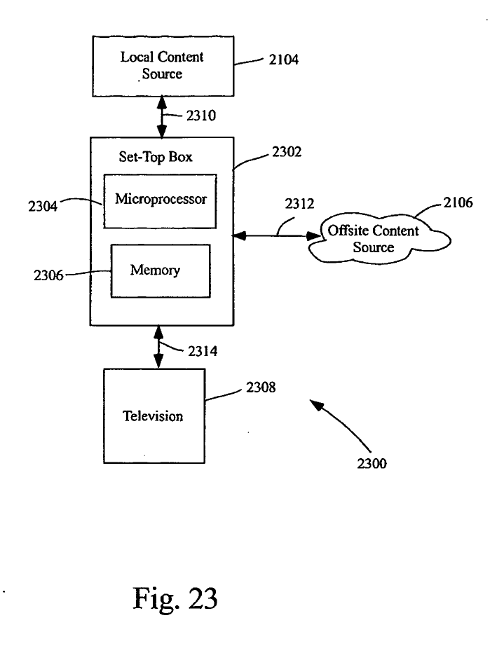

FIG. 23 shows an example of a system 2300 comprising a television set-top box receiving content from local and offsite sources according to one embodiment.

Shown are a local content source 2104, an offsite content source 2106, a set-top box 2302, a microprocessor 2304, a memory 2306, and a television 2308, a first communication channel 2310, a second communication channel 2312, and a third communication channel 2314.

The set-top box 2302 includes the microprocessor 2304 and the memory 2306. The set-top box 2302 is coupled to the local content source 2104 through the first communication channel 2310. The set-top box is coupled to the offsite content source 2106 through the second communication channel 2312. The set-top box is coupled to the television 2308 through the third communication channel 2310.

In operation the set-top box 2302 accesses, for example, video, audio or other data, including entities and collections, from the local content source 2104 through the first communication channel 2310. The set-top box 2302 also accesses HTML content, video, audio, or other content, including entities and collections, from the offsite content source 2106 through the second communication channel 2312. The set-top box 2302 includes decoders (described at least with reference to FIGS. 1-4) that decode the content from either the local content source 2104 or the offsite content source 2106. The set-top box 2302 then sends a video signal that includes the content to the television 2308 for display. The video signal is sent from the set-top box 2302 to the television 2308 through the third communication channel.

Additionally, set-top box 2302 can combine both video, audio, data, images and web/HTML content synchronously according to one embodiment of the present invention and provide the same to the television 2308 for display. The content management system described at least with reference to FIGS. 1-4 is utilized by the set-top box 2302 in accordance with a preferred embodiment in order to combine the different types of content for display on the television 2308. Microprocessor 2304 and memory 2306 are used by the set-top box 2302 in executing software of the present invention.

Furthermore, the system shown in FIG. 23 is capable of working in accordance with the different embodiments of the content management system shown in FIGS. 1-4. That is the set-top box is one embodiment of a hardware platform for the content management system shown in FIGS. 1-4.

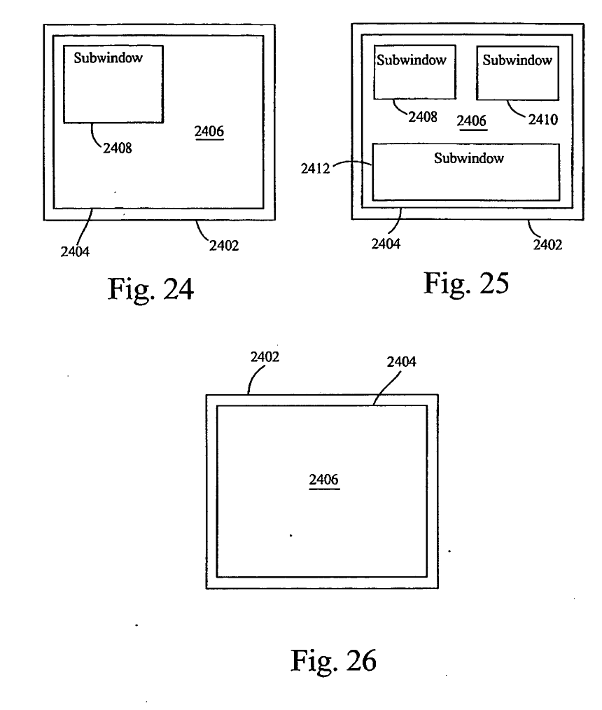

Referring to FIGS. 24-26 shown are examples of media and other content integration according to different embodiments. Shown are a display device 2402, a screen 2404, a content area 2406, a first sub window 2408, a second sub window 2410, and a third sub window 2412.

As is shown in FIG. 24, the display device 2402 (for example, a television, a computer monitor, and projection monitor, such as is well known in the art) contains the screen 2404 that displays at least graphics and text. The display of graphics and text is also well known in the art. The content area 2406 contains the sub window 2408 (also referred to as a video window or alternate frame).

In one embodiment, the sub window is maintained in a separate frame buffer from the content area and its orientation is sent to the compositor (in X, Y coordinates) for the compositor to move and refresh. In another embodiment, there is one frame buffer for the entire content area and the software manager for the sub-window updates the frame buffer using bit level block transfers. These methods and others are well known in the art.

One aspect of this embodiment is that audio and/or video can be integrated with other content such as text and/or graphics described in web compatible format (although the source need not be the Internet, but can be any source, such as, for example, a disk, a local storage area, or a remote storage area, that can store content). Content can be displayed in an overlaid fashion. This is known in the art as Alpha blending. Alpha blending is used in computer graphics to create the effect of transparency. This is useful in scenes that feature glass or liquid objects. Alpha blending ins accomplished by combining a translucent foreground with a background color to create an in-between blend. For animations, alpha blending can also be used to gradually fade one image into another.

In computer graphics, an image uses 4 channels to define its color. Three of these are the primary color channels—red, green and blue. The fourth, known as the alpha channel, conveys information about the image's transparency. It specifies how foreground colors are merged with those in the background when overlaid on top of each other.

The equation used in alpha blending is:

$${[ r , g , b ]}_{blended} = α {[ r , g , b ]}_{foreground} + ( 1 - α ) {[ r , g , b ]}_{background}$$

where [r,g,b] is the red, green, blue color channels and alpha is the weighting factor.

In fact, it is from the weight factor, that alpha blending gets its name. The weighting factor is allowed to take any value from 0 to 1. When set to 0, the foreground is completely transparent. When it is set to 1, it becomes opaque and totally obscures the background. Any intermediate value creates a mixture of the two images.

Such as is shown in FIG. 25, the content area 2406 can be split into multiple sub windows 2408, 2410, and 2412 and different types of content can be in each sub-window. For example, in one embodiment, pictures are displayed in the first sub window 2408, video is simultaneously displayed in the second sub window 2410 and a data document is simultaneously displayed in the third sub window 2412. In an alternative example, entities from a collection are displayed in the different sub windows 2408, 2410, 2412. For example, at the same time a text entity from the collection is displayed in the first sub window 2408 and a video entity from the collection is displayed in the second sub window 2410. Optionally, a picture entity from the collection is also be simultaneously displayed in the third sub window 2412.

In another alternative example, a video entity is displayed in the first sub window 2408 for a first time period. During the first time period (or following the first time period) a picture entity is displayed in the second sub window 2410 for a second time period. After the second time period a second video entity is displayed in the third sub window 2412. The feature of displaying different entities within a collection at different time periods will be described in greater detail herein at least with reference to FIG. 11.

As is shown in FIG. 26, the content area 2406 does not have a sub window 2408. In this embodiment, entities within a collection are displayed at different times within the entire content area 2406. In this embodiment, the content management system can still display multiple entities within a collection simultaneously. This is accomplished by creating a single video signal that is sent to the display device. This can be accomplished through alpha blending of graphics and text on video into one frame buffer (as explained above); specifying audio to be started at a certain time within the video stream (see the above section and references to the SMIL timing model); and similar mechanisms.

Alternatively, the sub window can 2408 be used to display one entity within a collection while the remainder, or a portion, of the content area 2406 is used to display another entity within the collection. The hardware platform 100 shown in FIG. 1 can be utilized to determine how the entities within the collection will be displayed within the content area 2406.

In one example, the sub window 2408 displays movie content, such as the movie Terminator2, and the content area 2406 displays text and/or graphics (provided by HTML coding) which is topically related to the part of the movie playing in the sub window 2408 user/viewer interacts with the content in the content area 2406, such as by clicking on a displayed button, effects can be reflected in the media sub window 2408. As an example, clicking on buttons or hypertext links indicating sections or particular points in the movie results in the video playback jumping to the selected point. Additionally, the media displayed in sub window 2408 can result in changes in the content area 2406. As an example, progression of the movie to a new scene results in a new text display giving information about the scene.

As another example, a group of entities is grouped together to form a collection. When a collection is formed from ten different entities, and all of the entities are different video segments, each of the entities can be displayed in the content area in an ordered fashion. Thus, the first entity will be shown, and then the second entity, the third and so on until the last entity in the collection is shown. Alternatively, the collection can also include additional entities which are related to the video clips and displayed along with the video clips. For example, a first entity within a collection can be displayed in the sub window 508 and a second entity can be displayed somewhere in the content area 2406.

Concurrent browsing and video playback

One feature of the application programming interface (API), described above with reference to FIGS. 5-7, is the ability to view HTML pages while playing video and/or audio content. The concurrent playback of HTML pages and video content places additional requirements on the processing and memory capabilities of the content management system. Thus, the playback device, such as shown in FIGS. 21-23, is designed to perform both of these functions (i.e., display of HTML and display of video) simultaneously.

Another feature of the application programming interface (API) is the ability to display downscaled video within a frame of a web page which is often provided as a hardware feature as it is well known in the art. The hardware feature is indirectly accessed through the presentation system specifying the size and X, Y coordinates desired for the video to the underlying software layers which translate that into instructions to the hardware. Yet another feature that is included, at least in some variations, is an ability to display up-scaled video within a web page using similar features in the hardware. The API also has the ability to display multiple entities within a collection simultaneously. The decoders combine all of the entities into one video signal that is sent to the playback device.

Storyboard with scrolling display

As an example, in accordance with one embodiment, a movie, i.e., audio and video content, is authored with the entire screenplay provided on a DVD in HTML format.

The following exemplary commands can be used to navigate and display content in addition to movie, i.e., the audio and video content:

InterActual.SearchTime can be utilized to jump to a specific location within a title;

InterActual.DisplayImage can be utilized to display an picture (e.g., a picture entity) in addition to the audio and video content of the movie; and

InterActual.SelectAudio(1) can be utilized to select an alternate audio track to be output. In the case of DVD this command tells the DVD Navigator to decoder the DVD's Audio Channel based on the parameter being passed in.

In accordance with the present example, when a viewer clicks on any screen visually represented in HTML, the content management system links the viewer to a corresponding scene (by use of the command InterActual.SearchTime to go to the specific location within a title) within the DVD-Video. Besides being capable of a finer granularity than the normal chapter navigation provided on DVD-Video, the HTML-based script can contain other media such as a picture (by use of the command “InterActual.DisplayImage”) or special audio (by use of the command “InterActual.SelectAudio(1)”) and/or server-based URL if connected to the Internet for other information. Furthermore, in one preferred embodiment, the text of the screenplay in HTML scrolls with the DVD-Video (e.g., in one of the sub windows) to give the appearance of being synchronized with the DVD-Video.

Referring now to FIG. 27, a block diagram is shown illustrating one example of a client content request and the multiple levels of trust for acquiring the content in accordance with an embodiment of the present invention. Shown is a client 2700, a local storage medium 2702, a removable storage medium 2704, a LAN 2706, a VPN 2708, a WAN 2710, a global Internet 2712, and a level of trust scale 2714.

Entities can be acquired from various levels of trusted sources, for example: Local Computer (e.g., Hard Disc); Removable and Portable storage; Local LAN; Local Trusted Peer-to-peer or on Trusted WAN Network or (VPN); WAN; and the Internet.

In one embodiment of the present invention a relative cost factor can be computed for retrieving the content from each trust level. The cost factor can be computed on several criteria including but not limited to: Level of trust of the entity; bandwidth speed or time to download/acquire entity; financial cost or dollars paid to use or acquire the entity; Format for the entity, there can be different formats the entity comes in, such as, for audio a .MP3 vs. a .WMA file format, so a user may prefer the MP3 format; and number of times a source has been used in the past with good results.

In one embodiment, in building a collection the different levels of trust becomes a funnel effect for the amount each source will be used to acquire entities. The closest local sources are used the most while the farther and/or more costly Internet sources are used the least.

Additionally, multiple levels of access rights to content can be integrated with the system. Every entity has access rights and therefore for collections an aggregation of access rights occurs to establish the access rights for the collection. Access rights are is also used when publishing new changes to a collection and users can add additional levels of rights access to those above the individual entity rights. An entity's rights can also disallow being included into various collections or limit distribution rights. Optionally, the entity's rights are tied to a user that has purchased the content and the rights are verified to DRM systems such as verification with a server, trusted entity, local smart card or the “Wallet” or Non-volatile storage of the system. Content can also disallow inclusion into any collection or being included with specific types of other entities. For example, a kids Disney Movie entity may not be allowed to be displayed with adult entities at the same time. In another embodiment the content manager can remove the scenes that contain adult content in a movie to make it acceptable for younger viewers. This can be done through filters of the written script to verbal filters, to the video entities etc.

In one embodiment, access will be granted for an entity if the client is within a certain trust level. For example, access may be granted to any entity stored in the local storage medium. In another example, the client will have access to any entity stored on the LAN and the trusted connections.

Additionally, the level of trust can be used to in a search algorithm, when searching for collections or entities. When a request for a collection is made by the client the content search engine will first search for the content in the higher levels of trust. Next, if the entities or collections are not found the content search engine will proceed to search for the entities or collections at the lower trust levels. Advantageously, this allows for efficient searching and also can prevent getting content from unknown sources or sources that are not trusted.

Referring to FIG. 28, shown is a diagram illustrating multiple display devices displaying content simultaneously. Both of the devices can simultaneously display entities and collections in accordance with one embodiment. The entity or collection can be received from the server or stored at one or both of the display devices. The server or one of the devices can control the simultaneous playback. Simultaneous playback is described in detail in the following patent applications: U.S. patent application Ser. No. 09/488,345, filed Jan. 20, 2000, entitled SYSTEM, METHOD AND ARTICLE OF MANUFACTURE FOR EXECUTING A MULTIMEDIA EVENT ON A PLURALITY OF CLIENT COMPUTERS USING A SYNCHRONIZATION HOST ENGINE; U.S. patent application Ser. No. 09/488,337, filed Jan. 20, 2000, entitled SYSTEM, METHOD AND ARTICLE OF MANUFACTURE FOR STORING SYNCHRONIZATION HISTORY OF THE EXECUTION OF A MULTIMEDIA EVENT ON A PLURALITY OF CLIENT COMPUTERS; U.S. patent application Ser. No. 09/488,613, filed Jan. 20, 2000, entitled SYSTEM, METHOD AND ARTICLE OF MANUFACTURE FOR LATE SYNCHRONIZATION DURING THE EXECUTION OF A MULTIMEDIA EVENT ON A PLURALITY OF CLIENT COMPUTERS; U.S. patent application Ser. No. 09/488,155, filed Jan. 20, 2000, entitled SYSTEM, METHOD AND ARTICLE OF MANUFACTURE FOR JAVA/JAVASCRIPT COMPONENT IN A MULTIMEDIA SYNCHRONIZATION FRAMEWORK; U.S. patent application Ser. No. 09/489,600, filed Jan. 20, 2000, entitled SYSTEM, METHOD AND ARTICLE OF MANUFACTURE FOR A SYNCHRONIZER COMPONENT IN A MULTIMEDIA SYNCHRONIZATION FRAMEWORK; U.S. patent application Ser. No. 09/488,614, filed Jan. 20, 2000, entitled SYSTEM, METHOD AND ARTICLE OF MANUFACTURE FOR A SCHEDULER COMPONENT IN A MULTIMEDIA SYNCHRONIZATION FRAMEWORK; U.S. patent application Ser. No. 09/489,601, filed Jan. 20, 2000, entitled SYSTEM, METHOD AND ARTICLE OF MANUFACTURE FOR A BUSINESS LAYER COMPONENT IN A MULTIMEDIA SYNCHRONIZATION FRAMEWORK; and U.S. patent application Ser. No. 09/489,597, filed Jan. 20, 2000, entitled SYSTEM, METHOD AND ARTICLE OF MANUFACTURE FOR A CONFIGURATION MANAGER COMPONENT IN A MULTIMEDIA SYNCHRONIZATION FRAMEWORK, all of which are incorporated herein in their entirety.

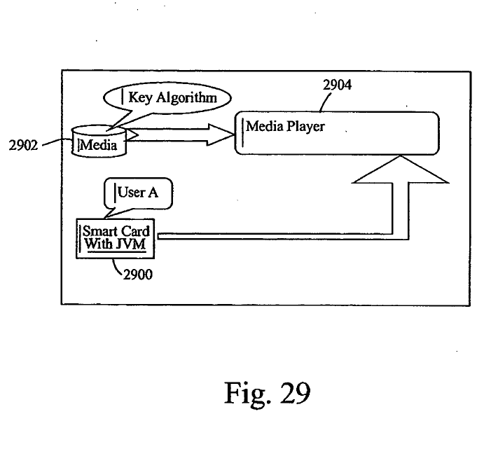

FIG. 29 is a block diagram illustrating a user with a smart card accessing content in accordance with an embodiment of the present invention. Shown are a Smart card 2900, a media player 2904, and media 2902.

In one embodiment, the system requires a user login in the form of a smart card user interface to identify the user or a single profile for all of the usage. A smartcard or smart card is a tiny secure cryptoprocessor embedded within a credit card-sized or smaller (like the GSM SIM) card. A secure cryptoprocessor is a dedicated computer for carrying out cryptographic operations, embedded in a packaging with multiple physical security measures, which give it a degree of tamper resistance. The purpose of a secure cryptoprocessor is to act as the keystone of a security sub-system, eliminating the need to protect the rest of the sub-system with physical security measures.

Smartcards are probably the most widely deployed form of secure cryptoprocessor, although more complex and versatile secure cryptoprocessors are widely deployed in systems such as ATMs.

Using a smart card further customization based on user preferences and not just all users of the content management system can be accomplished. The smart card stores user preferences that can be retrieved from memory and read by the presentation layout engine. The presentation layout engine can then set system parameters that a user prefers. In one embodiment, these preferences may be specific to the system capabilities. That is to say, if the system can use the display in a 1024×768 resolution or a 1920×1280 resolution, the user preferences may specify that the user always prefers the display set to 1920×1280. Likewise, if a QWERTY style keyboard with mouse is available and also a remote control, the user may prefer their user interface to be generated that only requires the remote control to use all the system features. Another preference can be based on the user's login criteria such as age, sex, financial status, time of day, or even the mood of the user can be used to select content. These user preferences can be determined from the user through a series of questions, having the user enter in or select preferences or knowing the situation such as time of day is determined by the current time the user is accessing the content. The preferences that do not change over time such as sex or birthday can be saved in a user profile and saved for later use without having the prompt the user for this information again. The user login can best be utilized for multi-user systems. An administrator or parent may also set additional access rights/restricts to a given user. For example a parent may set a rule that the child is not only allowed to view G or PG rated content and nothing else.

With smart cards today it is possible to store not only the user information, but the rules and profile of a given user, access rights, DRM licenses, saved games, or any information that may be stored in non-volatile storage of the system on the smart card as well.

Utilizing technologies, such as the smart card security industry, provides a unique ID (by way of a smart card) for each user of the next generation media player (System 10.0 player). That is, each smart card can be individually identified through, e.g., a code on the smart card. In addition these technologies provide an even more secure environment for execution of the key-management algorithm via a Java VM on the card itself with the key-management algorithm coming with the media. In one embodiment, the algorithm which resides on the media is a set of Java instructions that are loaded and executed on the Java Virtual Machine of the Smart card. Other virtual machines are used in alternative embodiments. This way the combination of the algorithm (JVM Source Code) being on the media with the user keys on the smart card provide a combined secure environment that can change over time with new media and new user access rights or license keys (where either the card holding the keys changes or the media with the algorithm changes or both). In addition, the same user can use different devices and have the same user experience whether in their house, a neighbor's house, at work, or at a local access point, given the user profile is stored on the user's card. This information can also be stored on an accessible server by the device and the user login to a device enables the system to access the user's information. In another form a cell phone with connectivity to a device may also transmit a users profile or even bio identity information such as a fingerprint or retinal scan can be used to identify a user. The user's device may also contain the actual authentication algorithm for the user, i.e., a virtual machine code. This way the algorithm can change over time.

Referring to FIG. 30, shown is a remote control according to an embodiment of the present invention. Shown is a remote control 3000, having a back button 3002, a view button 3004, a home button 3006, an IA (InterActual) button 3008, a stop button 3010, a next button 3012, a prev button 3014, a play button 3016, an up button 3018, a left button 3020, a right button 3022, and a down button 3024.

The back button 3002 has different uses. In an Internet view, the back button 3002 goes back to the previously-visited web page similar to a back button on a web browser. In a content (from disk) view, the back button 3002 goes back to the last web page or video/web page combination which was viewed. This is unique in that there are two state machines manifested in the content view, one being the web browser markup (text, graphics, etc.) and the other being the audio/video embedded in the page. Hence, using the back button, one returns to the prior web page markup content and the prior audio/video placement. The application can also decide whether to restart the audio/video at some predefined point, or continue playback regardless of the forward and back operations. In one embodiment, this is accomplished by storing the pertinent state information for both state machines and maintaining a stack of history information allowing multiple steps back using the back button. The stack information gets popped off and each state machine restarted with that information.

The view button 3004 switches between a full-screen Internet (or web) view to a full-screen content (from disk) view.

The home button 3006 has different uses. In an Internet view, the home button 3006 goes to the device's home page which, as example, can be the manufacturer's page or a user-specified page if changed by the user. In a content (from disk) view, the home button 3006 goes to the content home page which, as example, can be INDEX.HTM from the disk ROM or CONNECT.HTM from the flash system memory.

The IA button 3008, or “InterActual” button, is a dedicated button which is discussed in greater detail under the subheading “context sensitive application” later herein in reference to FIG. 30.

The playback buttons, stop 3010, next 3012, prev (previous) 3014, and play 3016, control the video whenever there is video being displayed (either in full-screen mode or in a window). When one of the buttons in pressed a signal is sent from the remote control to a receiver at the playback device (such as is shown, e.g., in FIGS. 28-30). The playback device then decodes the signal, and executes a corresponding command to control the playback of the video. When no video is being displayed, pressing of the play button 1316, in one embodiment, loads a special page VIDPLAY.HTM if it is present in the /COMMON directory of an inserted disk ROM. If the VIDPLAY.HTM file is not found, pressing of the play button 1316, in one embodiment, plays the DVD in full-screen video mode.

The navigation buttons, up 3018, left 3020, right 3022, and down 3024, in one embodiment, do not work for DVD navigation unless video is playing in full-screen mode. If video is playing in a window within a web page, these buttons enable navigation of the web page, especially useful for navigating to and selecting HTML hyperlinks. In this embodiment, the windowed video will be a selectable hyperlink as well. Selecting the video window (by an enter button not shown) causes it to change to full-screen video. In another embodiment, a mouse or other pointing device such as a trackball, hand glove, pen, or the like can be integrated with the system.

Context Sensitive application

In one embodiment, use of a unique event and a special button on the remote control 3000, a specific section in the media can trigger a context-sensitive action. Events that are used for this purpose are context sensitive to the media content. As example, an event can trigger during a certain scene, upon which, in response to a user's selection of an object within the scene can display information relating to the selected object.

In one embodiment, when media content subscribes to a particular event for context sensitive interaction, which can be done on a chapter or time basis, the DVD navigator can optionally overlay transparently some place on the display alerting the user that context-sensitive interaction is available. In computer graphics, an image uses 4 channels to define its color. Three of these are the primary color channels—red, green and blue. The fourth, known as the alpha channel, conveys information about the image's transparency. It specifies how foreground colors are merged with those in the background when overlaid on top of each other. A weighting factor is used for the transparency of the colors. The weighting factor is allowed to take any value from 0 to 1. When set to 0, the foreground is completely transparent. When it is set to 1, it becomes opaque and totally obscures the background. Any intermediate value creates a mixture of the two images. Similar to when a network logo is transparently displayed at the bottom of a television screen, in one embodiment, an InterActual logo is displayed to signify there is more info available for the displayed scene, and so forth. This ability is implemented through the media services and the graphical subsystem of the DVD navigator.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A system comprising:
a plurality of devices connected via a network;
a plurality of entities located on at least one of the plurality of devices; and
a content management system located on at least one of the plurality of devices for creating a collection using at least two of the plurality of entities.

2. The system of claim 1 wherein the entities are public domain entities.

3. The system of claim 1 wherein the entities are shared within a LAN, a trusted network, a WAN, or an Internet.

4. The system of claim 1 wherein the entities require access privileges.

5. The system of claim 4 wherein the access privileges include a password.

6. The system of claim 4 wherein the access privileges include a key.

7. The system of claim 1 further comprising a content search engine for locating entities.

8. The system of claim 7 wherein the content search engine searches for entities based upon a cost of retrieving the entities.

9. The system of claim 8 wherein the cost of retrieving the entities includes determining a trust level where the entities are stored.

10. A method of modifying a collection comprising:
analyzing metadata associated with the collection; and
removing at least one entity from the collection based upon a set of presentation rules.

11. The method of claim 10 further comprising adding at least one new entity from to the collection, wherein the added entity takes the place of the removed entity.

12. The method of claim 10 wherein the presentation rules include system information.

13. The method of claim 10 wherein the presentation rules include a user profile.

14. The method of claim 10 wherein the presentation rules are based upon a user request.

15. A method of displaying content comprising:
providing a request to a content manager, the request including a set of criteria;
searching for a collection that at least partially fulfills the request, the collection including a plurality of entities;
determining which of the plurality of entities within the collection do not meet the set of criteria; and
searching for a replacement entity to replace one of the plurality of entities within the collection that do not meet the set of criteria.

16. The method of claim 15 wherein the set of criteria include system information.

17. The method of claim 15 wherein the set of criteria include a user profile.

18. The method of claim 15 further comprising determining if access rights exist for each of the plurality of entities within the collection.

19. The method of claim 18 further comprising replacing one of the plurality of entities for which there are not access rights with a second replacement entity.

20. The method of claim 15 further comprising:
replacing one of the plurality of entities within the collection that do not meet the set of criteria with the replacement entity; and
modifying a set of collection metadata in response to the replacing step.

21. A method of modifying an entity, the entity having entity metadata associated therewith, comprising the steps of:
comparing the entity or the entity metadata with a set of criteria ;
determining a portion of the entity that does not meet the set of criteria; and
removing the portion of the entity that does not meet the set of criteria.

22. The method of claim 21 further comprising modifying the entity metadata.

23. The method of claim 21 further comprising adding a portion of a second entity to replace the portion of the entity that was removed.

24. The method of claim 23 further comprising modifying the entity metadata.

25. The method of claim 21 wherein the set of criteria include a user profile.

26. The method of claim 21 wherein the set of criteria include system information.

27. The method of claim 21 wherein the entity is a video entity.

28. The method of claim 21 wherein the entity is an audio entity.

29. The method of claim 21 wherein the entity is a graphics entity.

30. A collection embodied on a computer readable medium comprising:
a digital video file entity;
an audio entity, for providing an associated audio for the digital video file;
a menu entity, for providing points within the digital video file; and
collection metadata for defining the playback of the digital video file entity, the audio entity, and the menu entity.

31. The collection embodied on a computer readable medium of claim 30 the points correspond to titles or parts of titles within a digital versatile disk.

32. The collection embodied on a computer readable medium of claim 30 further comprising an entity for providing subtitles corresponding to the audio entity.

33. The collection embodied on a computer readable medium of claim 30 wherein the computer readable medium is a portable storage medium.

34. The collection embodied on a computer readable medium of claim 30 wherein the computer readable medium is a plurality of storage devices.

35. The collection embodied on a computer readable medium of claim 34 wherein the plurality of storage devices are local storage devices.

36. The collection embodied on a computer readable medium of claim 34 wherein at least one of the plurality of storage devices is a remote storage device.

37. The collection embodied on a computer readable medium of claim 30 wherein the computer readable medium is a local storage medium.

38. The collection embodied on a computer readable medium of claim 30 wherein the collection metadata includes system information.

39. A method of downloading streaming content comprising:
downloading a first portion of the streaming content;
downloading a second portion of the steaming content while the first portion of the streaming content is also downloading;
outputting the first portion of the steaming content for display on a presentation device; and
outputting the second portion of the steaming content for display on a presentation device after outputting the first portion of the steaming content;
wherein a third portion of the steaming content originally positioned in between the first portion of the steaming content and the second portion of the steaming content is not output for display on a presentation device.

40. The method of claim 39 wherein the third portion of the streaming content does not meet a set of presentation rules.

41. The method of claim 39 wherein the streaming content is an audio file.

42. The method of claim 39 wherein the streaming content is a video file.

43. The method of claim 39 wherein the third portion of the streaming content does not meet a set of user criteria.

44. The method of claim 39 further comprising receiving a request from a user to skip the third portion of the streaming content.

45. A method of displaying a context sensitive menu comprising the steps of:
outputting content to a display device;
receiving a request to display a menu;
deriving the context sensitive menu from the current content being output; and
outputting the context sensitive menu to the display device.

46. The method of claim 45 wherein the context sensitive menu is derived from video content.

47. The method of claim 45 further comprising the step of deriving the context sensitive menu from a user profile.

48. The method of claim 45 further comprising the step of receiving the context sensitive menu from a server.

49. The method of claim 48 wherein the context sensitive menu is an update of video content on a DVD.

50. The method of claim 48 further comprising altering the context sensitive menu received from the server base upon a user profile.

51. The method of claim 45 wherein the context sensitive menu is overlaid on the content.

52. The method of claim 51 wherein the context sensitive menu is overlaid using alpha blending.
